(19) United States
(12) Patent Application Publication
(10) Pub. No.: US 2026/0170179 A1
(43) Pub. Date: Jun. 18, 2026

(54) SYSTEMS AND METHODS FOR SOCIAL SAAS MANAGEMENT

(71) Applicant: OneRaft, Inc., Tulsa, OK (US)

(72) Inventor: Michael RADOVICH, Tulsa, OK (US)

(21) Appl. No.: 19/418,731

(22) Filed: Dec. 12, 2025

Related U.S. Application Data
(60) Provisional application No. 63/733,380, filed on Dec. 12, 2024.
(60) Provisional application No. 63/908,330, filed on Oct. 30, 2025.

(51) Int. Cl. G06F 21/62; H04L 9/08; H04L 9/32

(52) U.S. Cl. CPC G06F 21/629; H04L 9/0825; H04L 9/3213

(57) ABSTRACT

A system managing SAAS subscriptions is described herein. The system may generate a first user profile corresponding to a first user, wherein the first user profile includes user data corresponding to at least one SAAS subscription, permissions data, and a first payment method. A system may obtain a request to share a portion of the user data corresponding to the at least one SAAS subscription with a second user. A system may determine, based on the permissions data, whether the second user is allowed access to the at least one SAAS subscription. A system may upon determining that the second user is permitted access to the at least one SAAS subscription, sending the second user the portion of the user data corresponding to the at least one SAAS subscription.

### CROSS-REFERENCE TO RELATED APPLICATIONS

The present application claims priority to U.S. Provisional Patent Application No. 63/733,380 filed on Dec. 12, 2024, and U.S. Provisional Patent Application No. 63/908,330 filed on Oct. 30, 2025. Each of these applications are incorporated by reference in their entirety herein.

### TECHNICAL FIELD

Aspects of the present disclosure relate to systems and methods for managing and delivering Software as a Service (SAAS) content, and more particularly, to systems and methods that integrate social networking, user-driven security protocols, and non-destructive media overlay technologies within a unified SAAS management framework. This field encompasses various technical aspects that are beneficial for efficient and secure SAAS delivery.

### BACKGROUND

“Software as a Service” (SAAS) refers to a software deployment model in which software applications are hosted on remote servers accessed over the internet via a network connection. Specifically, SAAS entails providing users with access to software applications through a cloud-based infrastructure, wherein users authenticate their identity by submitting established login credentials, thereby enabling secure access to the software services.

The internet today is replete with SAAS applications that operate in isolation and independently of each other. In some instances, all or a portion of SAAS services offer capabilities that lie dormant due to underutilization, resulting in a significant waste of resources. It is with these observations in mind, among others, that various aspects of the present disclosure were conceived and developed.

### SUMMARY

Implementations described and claimed herein address the foregoing problems by providing systems for managing and delivering Software as a Service (SAAS) content, including video-on-demand, music streaming, online storage, cloud computing, digital media distribution, social networking, and related technologies.

In some aspects, the techniques described herein relate to a method including: generating a first user profile corresponding to a first user, wherein the first user profile includes user data corresponding to at least one SAAS subscription, permissions data, and a first payment method; obtaining a request to share a portion of the user data corresponding to the at least one SAAS subscription with a second user; determining, based on the permissions data, whether the second user is allowed access to the at least one SAAS subscription; and upon determining that the second user is permitted access to the at least one SAAS subscription, sending the second user the portion of the user data corresponding to the at least one SAAS subscription.

In some aspects, the techniques described herein relate to a method including: obtaining, from at least one SAAS provider, activity data associated with a user; determine, based on a user profile associated with the user, whether the user has approved sharing of the activity data to a newsfeed; and upon determining the user has approved sharing of the activity data, posting the activity data to the newsfeed, wherein the newsfeed is visible to one or more contacts associated with the user profile.

In some aspects, the techniques described herein relate to a method including: obtaining a rating by a user, the rating including a numerical assignment corresponding to a piece of content; identifying at least one contact of the user that has also rated the piece of content; obtaining a rating by the contact of the user corresponding to the piece of content; comparing the rating by the user and the rating by the contact; determining a degree of similarity based on the comparison; and adjusting a similarity score of the user in relation to the contact based on the degree of similarity.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF DRAWINGS

FIG. 1 is a system diagram for facilitating social SAAS management.

FIG. 2 is a block diagram depicting a social SAAS manager.

FIG. 3 is a flowchart of an example method of posting SAAS activity.

FIG. 4 is a flowchart of an example calculation of a personal enjoyment profile rating.

FIGS. 5A and 5B depict a flowchart of a cost sharing method among users of a SAAS subscription.

FIG. 6 depicts a flowchart of a method of a user engaging with the SAAS provider content by utilizing the social SAAS manager.

FIG. 7 depicts a flowchart of a single-click signup method.

FIG. 8 depicts a method of managing access to SAAS content.

FIG. 9 depicts a method of managing social SAAS activity.

FIG. 10 depicts a method of generating ratings related to SAAS content.

FIG. 11 depicts an example computing system.

FIG. 12 depicts an example user interface for a SAAS Portal.

FIG. 13 depicts an example user interface for a SAAS Calendar Planner.

FIG. 14 depicts an example method for secure data sharing.

FIG. 15 depicts an example method for securely playing Digital Rights Management (DRM) protected content.

FIG. 16 depicts a process diagram illustrating an example method for generating a non-destructive content overlay via differential analysis.

FIG. 17 depicts a flowchart of an example process for contextual interest manager.

FIG. 18 depicts a diagram of an example process for pairing a TV companion application.

FIG. 19 depicts an example of a video call watch party feature.

FIG. 20 depicts a diagram illustrating an example of a real-time compositing process for a companion stream.

FIG. 21 depicts an example user interface for personalized AI casting.

FIG. 22 depicts a diagram illustrating an example of a “medley” stream dual-screen user experience.

FIG. 23A depicts a flowchart of an example method for platform-hosted dynamic subscription tier management.

FIG. 23B depicts a flowchart of an example method for provider-integrated dynamic subscription tier management.

FIG. 24 depicts example user interfaces for creating and managing recommendation lists.

### DETAILED DESCRIPTION

Some existing access control systems for SAAS system use probabilistic, server-side security models that rely on IP-based geolocation and device fingerprinting, which are prone to high rates of false positives and fail to provide users with deterministic control. Furthermore, current content modification technologies require altering the original source material, creating potential copyright and ethical hurdles, while lacking a viable framework for consent and revenue sharing among original creators. Subscription models also remain rigid, typically offering a binary choice between expensive ad-free plans and fully ad-supported experiences, with no flexible, usage-based middle ground for managing consumption.

A need exists to bridge this gap by providing a comprehensive solution that brings together underutilized and isolated SAAS accounts, combining direct access to SAAS providers, financial service providers, social networking, password/data management, SAAS access management, and administrative user control. By addressing the common issues faced by users in these areas, the present disclosure describes significantly improved online experience and interpersonal connection. This platform is designed to be extensible, allowing for the future integration of a wide array of additional features and functionalities that build upon this core concept.

It should be understood that terms such as “streaming” and “SAAS” may be used interchangeably. However, it is intended that the scope of the present disclosure encompasses all SAAS applications, including but not limited to those classified as “streaming services,” which are online services that require a user to log into a protected and personal account. The features described in the present disclosure apply broadly across all types of SAAS services, although many may benefit streaming services more than other types of SAAS services. By way of example, the present disclosure's features may be particularly beneficial for users of online software-as-a-service applications, music subscription services, gaming platforms, and video-on-demand services.

The platform or system described herein is designed to unify and manage a user's disparate programs into a single, interactive ecosystem. The programs may include, without limitation, subscriptions to software (e.g. SAAS subscriptions), applications, platforms, solutions, systems, tools, services, utilities, etc., The system includes many features including but not limited to: secure credential and data sharing between trusted contacts; integrated, automated cost-splitting for shared subscriptions; a user-driven security model (e.g. secure access listed trust) for managing device access; a social network for sharing and discussing content; and a suite of advanced, non-destructive media interaction tools. These tools enable features such as user-generated “Companion Streams”, a consent-based framework for personalized AI casting, and synchronized, shared viewing experiences.

The system is designed to provide the users of SAAS services with centralized access to their subscriptions and is complimented by a social network designed to bring communal experiences back to an ever-isolated digital world. The system streamlines the sharing and management of online subscription services, particularly those categorized as streaming or SAAS applications.

The following detailed description describes a comprehensive, integrated system. However, the various features, systems, and components described herein may be implemented independently or in various sub-combinations. Each concept described can be practiced and provides utility on its own and is not necessarily dependent on the presence of all other features described to function.

### SAAS Portals

SAAS portals, as described herein, can serve many purposes, including password management. SAAS portals provide users with a centralized and streamlined experience for interacting with their subscribed SAAS applications, and those they are considering subscribing to, offering the convenience of managing multiple services through a single system.

Similar to social network platforms utilizing public pages and newsfeeds for business promotion or streaming gateway services offering add-on channels, SAAS portals provide a space for SAAS providers to showcase their offerings across the network of the system and engage with potential users. It functions as a dynamic interface akin to a streaming gateway, but without requiring a master subscription to unlock access to individual services, and without abstracting the user's direct account relationship with the SAAS provider.

In contrast to some existing streaming gateway services, the present system maintains the user's direct and independent relationship with each SAAS provider. The SAAS management system securely stores individual login credentials, such as a username and password or a passkey, for each separate SAAS subscription of a user within an integrated password manager. This architecture ensures that the user retains the ability to authenticate and access their subscription directly through the third-party SAAS provider's own native applications or website, completely independent of the social SAAS manager platform. This is in direct contrast to conventional gateway models, where a user who subscribes to a service (e.g., Netflix) as an add-on to a primary account (e.g., Amazon Prime) does not receive separate credentials for the add-on service and can therefore only access it through the primary gateway. The SAAS management system thus provides the convenience of a centralized portal without creating vendor lock-in or sacrificing user autonomy.

This system facilitates secure authentication directly with the SAAS providers through the password manager. Users may store their credentials-usernames and passwords-within the password manager; the SAAS portal then allows them to link those saved credentials to the corresponding SAAS provider portal and authorize access via established protocols (e.g. OAuth and/or OpenID Connect). The systems and methods described herein can be adapted to use any suitable authentication and authorization protocols.

The system may leverage industry-standard authorization flows, allowing for seamless integration with a wide range of SAAS providers. Within the software application's interface, users can initiate the linking process through a dedicated button, triggering an authorization flow. This process may utilize tokenized security (e.g. OAuth and OpenID Connect), establishing a secure connection between systems by exchanging authentication tokens. As is standard practice, during an OAuth connection, the 3rd party server can open a browser window for user authentication; this system automatically populates the window with the user's saved credentials and programmatically presses the confirmation button on the user's behalf, thus minimizing friction for the user. The subsequent browser endpoint clearly communicates shared information and privacy safeguards.

The SAAS portals utilize templated content displays which may include content posters, carousel layouts, hero images, and descriptive text that would accompany a piece of content hosted by their platform. The portal feature can be dynamically populated via API messages or other secure communication means (such as an AI agent) from the SAAS provider's server. This mirrors the data delivery mechanisms used by streaming services to manage channel content, as well as how streaming gateway services populate the templates for the add on services the user has subscribed to.

The system can leverage this rich metadata to present users with a comprehensive overview of each service, including subscription details, cost tiers, ad-supported status, device limitations, and user ratings. This is information previously scattered across individual SaaS interfaces or locked behind the paid service of a streaming gateway.

SAAS portals maintain direct relationships between users and their subscribed services, providing independent control over each subscription. Unlike bundled services, cancellation does not mean losing access through the aggregator; instead, the user can continue accessing their subscribed services directly. Furthermore, the system enables ‘deep linking’ capabilities in a similar manner as streaming gateway services. Deep links are URLs that take a user to a specific location (like a piece of content) in a specific application and can also begin playing the specified content. Users can initiate playback of a specific piece of content within a SAAS application directly through the SAAS portal in the software of the present disclosure. The standardized interface facilitates integration for various content providers, allowing them to define their carousel layouts, content feeds, and deep-linking schemas. It's a ‘plug-and-play’ approach that simplifies the process for SAAS businesses to showcase their services within our platform. This system ultimately transforms the password manager from solely a credential storage solution into the primary interface for content discovery and secure access across disparate subscriptions.

### Secure Access Listed Trust

The proliferation of streaming services and SAAS has revolutionized the way people use and consume content, offering unparalleled convenience and accessibility. However, this convenience comes with trade-offs, one of which is the limited control users have accessing these services. When using these services, users rely on the terms and conditions imposed by each SAAS provider, which can be opaque and subject to change at any time.

Secure access listed trust provides a user-centric system for managing access to online subscription services. Current SAAS offerings often impose restrictive and inconsistent access rules, such as limiting concurrent connections or charging for additional devices, which can lead to user frustration and underutilized subscriptions. This system offers transparency, flexibility, and control over SAAS accessibility, enabling informed user decisions and optimizing subscription utility. The secure access listed trust system centralizes access control for SAAS subscriptions. Users can add internet-connected devices to their account and associate unique identifying information, such as IP addresses and network data, with each device. This allows users to grant or revoke access to specific SAAS subscriptions for each registered device. Devices can be assigned to available “slots” within SAAS account profiles, either directly within the SAAS portals or through secure communication with SAAS provider servers.

In some instances, the access management system functions as a centralized information manager, partnering with third-party SAAS providers through their business portals on this software platform. The system communicates users' device access choices to SAAS provider servers via API or other secure transmission methods (e.g. JSON format, etc.). While specific protocols and data formats are described, any suitable data interchange format or real-time communication protocol may be used. SAAS providers can agree to ingest this allowed device information into their authentication modules and block access from any other unauthorized device attempting to log in. This offers SAAS providers a direct and efficient method for authentication security, bypassing the need for complex systems to determine device legitimacy or household location.

For example, instead of a streaming service determining if an account is being used legitimately based on IP address patterns or device types, they would simply receive a list of approved devices from the user via secure access listed trust and block anything else. The software can notify a user of the SAAS management system if an unapproved device attempts access and prompt them to add it to their approved list. For instance, a user traveling could want to watch streaming video content at a hotel on a smart TV. If they have maxed out the number of devices allowed for that account, they could disable a device they are not currently using and temporarily replace it with the hotel TV. Upon returning home and starting to use the original device, they can be prompted to disable access to the temporary device and restore the original device to the approved list. Temporary devices could also have their access revoked after a set amount of time. Alternatively, a SAAS provider could integrate into their own software a customizable and dynamic interface for their users to assign access for device IP addresses to their accounts, allowing users supervisory control over the devices using their subscriptions and the ability to block others from access.

This system improves upon current technology by providing users with granular, active control over device access to their SAAS subscriptions, rather than relying on opaque or arbitrary rules set by service providers. Unlike current systems where users might only be able to log out devices, secure access listed trust allows users to explicitly whitelist devices and block all others, offering a higher level of security and resource management. It moves beyond reactive measures to a proactive, user-driven access management model. The direct API communication with SAAS providers for device whitelisting is a key technical improvement, offering a more robust and simpler authentication security protocol for SAAS companies compared to complex internal systems for anomaly detection. Furthermore, the ability to “loan” out unused device slots for cost-sharing within a trusted network maximizes subscription value and alleviating financial burden.

This user-driven whitelisting model represents a paradigm shift from current provider-centric methods, where services use opaque heuristics like IP address monitoring to infer unauthorized sharing, often resulting in false positives. Secure access listed trust replaces this ambiguous, reactive system with a deterministic, proactive security model controlled entirely by the user.

### Device-Specific Multifactor Authentication (MFA)

Device-specific MFA allows users to assign distinct multifactor authentication contact methods for each registered device. This is particularly beneficial for shared accounts where users do not reside in the same household as the primary user. For example, a shared user accessing a subscription, to which they are not the primary user, can register their TV as an accepted device. If they need to reset a password or periodically enter an MFA code to re-authenticate the account on that device, they can add their own email address or telephone number as a contact method for MFA specifically for that device. This eliminates the need to coordinate between the primary user and shared users to obtain authentication codes.

This feature dramatically improves upon current MFA implementations. Typically, MFA is tied to a primary user's account universally, meaning any device attempting to authenticate for that primary user would require a code sent to the single registered MFA contact method (e.g., the primary user's phone). Device-specific MFA streamlines the process for shared users by allowing them to independently manage authentication prompts for their approved devices using their own contact information. This enhances convenience, reduces friction in shared viewing experiences, and improves security by distributing the responsibility of authentication without compromising the primary user's control.

### SAAS Management TV Companion App

In some instances, the system may include a SAAS management TV companion application (“app”) particularly for smart TVs or smart TV adaptors. In one example, a TV version of the SAAS management system can be installed directly on the user's smart TV or smart TV adaptor as a TV companion app. Upon opening the TV companion app, the app initiates a broadcast discovery service (e.g., via mDNS, SSDP, etc.) on the local network while simultaneously presenting the user with an option to log in and, concurrently, displaying a large QR code and/or a unique numeric code on the screen. The full version of the SAAS management system may be installed on a user's mobile device or computer.

Users have options for initiating this pairing. In one example, the user can open the SAAS management system and click a dedicated button to add a new device to their account. On a mobile device, this action may activate a camera of the mobile device, allowing the user to scan a QR code displayed on the TV screen. This QR code securely encodes the TV's relevant local network information, such as its mac and/or IP address and a temporary, time-sensitive authentication token, for example, as a JSON WebToken (JWT) payload. A sample payload might be formatted as: {“ip_address”: “192.168.1.101”, “token”: “aBcDeF123456”, “timestamp”: “1660885800”}. The mobile device utilizes this information to establish a direct, encrypted TCP/IP socket connection with the TV companion app. This connection is further secured via TLS/SSL. Once a secure channel is established and the token validated, the TV's unique device identifier is securely transmitted to the user's centralized SAAS management account, thereby adding the TV as a whitelisted device.

In another example, a user enters a displayed numeric code, for example, a 6-digit code, into a user interface of the SAAS management system of a mobile device or computer. This numeric code serves as a temporary authentication token, which the computer transmits over an encrypted channel (e.g., via a secure API call to the cloud service, or a direct local network connection if discovered via mDNS/SSDP) to authenticate with the TV companion app.

This robust, authenticated pairing process ensures secure access and prevents unauthorized control. Once the device is added, the user is presented with a screen listing their whitelisted devices. This streamlined whitelisting process offers users unparalleled control over their SAAS access points. Alternatively, within the SAAS portal interface for each individual subscription on the user's account, the newly added device would appear as an available option to be included in the approved device list within the secure access listed trust menu.

Once paired, the SAAS management system on the user's secondary device (e.g., a mobile phone) transforms into a powerful second-screen interface, serving as an intelligent remote control and interactive hub while content is being displayed on the primary viewing device (the TV). The user can perform standard playback commands—such as play, pause, and seek—directly from their phone. These commands are sent from the SAAS management system to the backend server's integrated media engine, which then relays the command to the TV companion app to ensure synchronized execution. This decoupled architecture allows the user to simultaneously use the full functionality of the social SAAS manager on their phone without interrupting playback on the TV. For example, while a movie is streaming on the TV, a user can browse their phone to select a companion stream overlay, manage participants in a video call watch party, or adjust their upcoming schedule in the SAAS calendar planner (described in further detail below), with all interactions on the phone seamlessly affecting the experience on the primary screen.

The TV companion app, now controlled by the SAAS management system, uniquely serves as a direct intermediary for initiating content playback from various sources, including SAAS portals and user newsfeeds. In one example, the companion app utilizes an integrated universal media player. This allows for content from partnered SAAS providers to be streamed directly within the software's ecosystem, enabling a more seamless user experience and advanced features.

Alternatively, for SAAS providers that have not agreed to allow access to their decryption systems (e.g. Content Decryption Module (CDM)) for an encrypted license, the companion app can initiate playback by dispatching a command to the SAAS provider's application installed on the user's playback device. When a user encounters a deep link to specific content, the system determines the appropriate playback method. If integrated playback is not available, the TV companion app programmatically parses the deep link's Uniform Resource Identifier (URI) and then dispatches an intent or inter-app communication command to the corresponding third-party SAAS content application installed on the TV.

If the target SAAS provider application is not yet installed on the TV, the TV companion app will intelligently intercept the deep link and automatically prompt the user to install the corresponding application from the TV's native app store. Upon first launching the newly installed application, the user will be guided through a secure, one-time authentication process facilitated by the social SAAS manager ecosystem. Once authenticated, the deep link is re-executed, seamlessly directing the user to the intended content within the application. This dual-capability mechanism ensures that users can access content from all their services, leveraging the native application environment for non-partnered providers to ensure optimal playback quality and remote control integration.

### Cross-Platform Playlists

Cross-platform playlists allow users to curate a seamless automated entertainment experience across their various SAAS subscriptions. This feature directly addresses the common user frustration of navigating fragmented content libraries, significantly enhancing user convenience by enabling the creation of a unified cross-platform playlist of content for the user.

Users can manually populate one or more entertainment queues. In one example, the one or more entertainment queues may include a time-based playlist or a non-scheduled watchlist. A ‘playlist’ entry is a specific type of event object which may be stored within the playlist and calendar database. The playlist contains the standard event metadata along with a specific flag that identifies it as part of an automated, sequential playback queue, which the SAAS calendar planner is configured to recognize and render visually on the user's timeline.

When a user selects an “Add to Playlist” option, the system programmatically adds the content to the next suitable, available timeslot in the user's schedule, signifying a near-term intent to consume the media. Conversely, the watchlist functions as an unscheduled, cross-platform repository of content the user is interested in. Selecting an “Add to Watchlist” option saves the content to this general pool-which can contain media from any linked SAAS provider-which the user can then browse for inspiration when they are looking for something to watch, without actively queuing it for playback at a specific time. In either case, the system leverages its “deep linking” capabilities to store the user-chosen content for eventual, seamless playback.

Alternatively, playlists can be generated automatically by the software on the user's behalf, based on established rules. This includes populating “wildcard” timeslots in the playlist either randomly, according to a user-defined order of entertainment operations, or by the platform using a personal enjoyment profile rating system to suggest content based on analyzed user content ratings and behavior. This demonstrates a smart use of AI and automation to personalize the content experience. Users can also integrate content recommended by influencers they follow on the platform, allowing for hierarchical rules and randomization options for playlist population.

For example, a user can seamlessly transition from a movie streaming via a SAAS subscription (e.g. HBO) to a TV show episode streaming via a different SAAS subscription (e.g. Netflix), followed by music streaming for a dinner party, with all items automatically playing in the user-chosen order. This eliminates the need for users to manually search for content between shows, greatly streamlining their entertainment consumption and reducing decision fatigue.

Notifications can be sent to the user when the software adds content to their playlist, with options for the user to choose recommendation methods such as “Play next from Oprah's watchlist” or “Watch random recommended unwatched movie from ‘Buddy Comedies of the 90s’”. In some instances, the system may select content with the highest personal enjoyment profile rating for automated and efficient selection, further enhancing convenience and content discovery.

The system extends the social aspect by allowing users connected to a particular TV (via a local Wi-Fi check and a master device list in the overall subscription account) to view the same playlist on their TV, leveraging the existing secure access listed trust to manage device permissions. This fosters a collaborative viewing experience and minimizes arguments over content selection. Restrictions can be implemented to prevent users from altering another user's private playlist, especially if it's playing on their personal device. A “private” or “public” flag on devices within the individual user accounts would allow users to designate devices for personal or shared family use, providing flexibility and control.

In some instances, the system facilitates adding a TV as a “guest device.” Guests could view upcoming content on the playlist but would require explicit permission from a permitted user, such as the primary user, to make changes. This thoughtful detail ensures that guests can enjoy content without requiring them to tie into the account, leveraging the primary user's access to streaming services, thereby enhancing the social potential of the system.

In some instances, the methods described herein include: (a) a system for securely storing authentication credentials for a plurality of distinct and independently operated third-party SAAS providers; (b) a system for aggregating content metadata, including unique deep link Uniform Resource Identifiers (URIs), from said plurality of providers into a single, unified data structure, such as a playlist; and (c) a client-side media player configured to programmatically and sequentially execute the stored deep link URIs. This execution may cause the client device to automatically navigate between the native applications or web players of the different SAAS providers, thereby creating a seamless, uninterrupted playback experience for the end-user. This method for the aggregation and sequential execution of deep links from independently authenticated services can be practiced as a standalone technology or integrated into any third-party streaming gateway or content aggregator seeking to provide a unified content consumption experience.

### SAAS Calendar Planner

In some instances, the system includes a SAAS calendar planner functionality, offering a comprehensive daily planning tool that goes beyond content consumption to include personal scheduling. This feature provides users with a versatile tool to manage their time and content consumption, addressing the need for a holistic approach to daily activities. Users can set a schedule for their day, ranging from “rigid” to “casual.” A rigid schedule allows users to input specific times for activities like work, exercise, or chores, and can provide stern yet encouraging warnings to help users stick to their self-created schedule, promoting accountability. A casual schedule would offer more nonchalant notifications or only standard reminders, catering to different user preferences.

In some instances, the calendar planner operates as an AI agent, functioning as both a personal scheduler and a content DJ. This demonstrates a smart use of AI and automation, as the AI can intelligently pace out content consumption, understanding that users may stream more on weekends than during the week. It can schedule content from the user's watchlists across different platforms, recommended lists, or even influencer watchlists, ensuring users don't forget content they've been meaning to watch. This proactive content discovery mechanism enhances the user's enjoyment and ensures they make the most of their subscriptions.

The system actively updates users on when shows or movies they are interested in will become available “for free” as part of their existing SAAS subscriptions. Users can add content to a special watchlist, and the software will notify them when it is added to one of their linked platforms. This is a significant benefit, as it tackles the common problem of users missing out on content becoming available on their existing services, providing a proactive and convenient solution. This requires SAAS providers to send content schedules and updates, including content exiting the platform, to the application via API messages or other secure communication means.

The calendar planner is adjustable, allowing users to view their plans across different timeframes. While a daily plan is the primary view, users can also expand it to see their schedule for the week, month, or even the entire year. This flexibility provides a holistic view of both their personal commitments and their planned content consumption across all their integrated SAAS services, offering comprehensive daily planning capabilities.

The functionality of the SAAS calendar planner is enabled by a computer-implemented method for intelligent and automated time management. In some instances, the method includes: (a) a system for unifying disparate data types—including user-defined personal events and media content items from a plurality of distinct third-party SAAS providers-into a single, interactive timeline interface; (b) an AI agent configured to automatically populate and arrange said timeline by intelligently pacing content consumption based on the user's historical activity patterns and predefined preferences; and (c) a method for dynamically and automatically recalculating and rescheduling all subsequent events on the timeline in real-time in response to a user's deviation from the established schedule, such as initiating playback of an item at an unscheduled time or accepting an impromptu social invitation. This unique combination of unifying personal and cross-platform media events, employing an AI agent for intelligent scheduling, and enabling real-time dynamic rescheduling can be practiced as a standalone technology independent of the broader social SAAS management system.

### Contextual Interest Manager

In some instances, the system includes a contextual interest manager feature designed to bridge the gap between initial discovery, often occurring through advertising and/or social feeds and a user's actionable opportunity to engage with the discovered content. In some advertising technologies, any expression of user interest may be interpreted as a declaration of immediate intent. In other words, there may be a reliance on “conversion” metrics which interpret any expression of user interest as a declaration of immediate intent. In some examples, this expression of interest may trigger retargeting algorithms. The contextual interest manager may enable an asynchronous capture of intent, allowing users to seamlessly track desired items (e.g. SAAS content including movie, music, etc., dining establishments, retail goods, services, etc.) without triggering an immediate external retargeting loop. This feature transforms passive advertisements into interactive, context-aware touchpoints that preserve the user's control over when and how they are reminded of their interests.

When a user encounters an advertisement for an item, the advertisement may be augmented with an interactive interface element, such as a “maybe” button. The “maybe” button may function as a latent interest trigger. The interactive interface element may be a button, toggle, icon, or gesture capable of registering a user's interest. In some instances, the user's interest may be casual and/or conditional. The interactive element may be rendered as an additive and/or non-destructive overlay. In some instances, the interactive ad player may render the interactive element over the advertisement. The system may determine an appropriate rendering method based on the technical requirements of the advertisement. In instances where bandwidth efficiency is prioritized, the interactive ad player may utilize a standard Document Object Model (DOM) overlay, rendering the button as a code-based UI layer superimposed over the video container. In instances where high-fidelity advertisements require cinematic integration, the system may utilize a luma matte compositing technique accompanied by a synchronized and/or transparent interaction layer. The interaction layer may be mapped to the dynamic screen coordinates of the visual overlay to capture user input. The system may facilitate an “upstream” capture of intent, allowing the user to register interest immediately within the system's environment without being forced into a “downstream” redirection to a retailer's website and/or landing page.

In some instances, capturing the user's request via the “maybe” interface is architected as a unilateral interaction model. Upon interaction, the system may extract a metadata package associated with the advertisement containing identifiers such as the Entity ID, the SAAS provider or business portal ID, and/or metadata categories. The system may serialize this data into an interest object. The interest object may then be stored (e.g. in a universal interest database). This interaction may trigger a state change in the platform's ad delivery engine. For example, upon the successful generation of an interest object, the system may create a rule (e.g. a frequency suppression rule), preventing or significantly reducing subsequent impressions of the same advertisement to the user. This functionality shifts the advertising efficiency model from a traditional Cost Per Mile (CPM) basis to a high-value Cost Per Action (CPA) or Cost Per Activation basis. In this model, advertisers may incur costs primarily when the contextual interest manager successfully identifies a relevant opportunity to notify the user, rather than for redundant impressions on an already-intrigued user.

Once an interest object is stored, the contextual interest manager may monitor for the specific conditions under which the user wishes to be reminded of the item. The contextual interest manager may ingest and evaluate real-time data streams to satisfy a contextual trigger definition associated with the interest object. For media content, the trigger may be a temporal marker (e.g., a “Release Date” discovered via polling content catalog APIs, etc.). However, for non-streaming entities, the contextual interest manager may evaluate multi-variate constraints. For example, for a dining establishment, the trigger definition may include geospatial and temporal parameters (e.g., “User is within 1 mile AND Time is between 6:00 PM and 9:00 PM”). For retail goods, the trigger may be financial (e.g., “Current Price drops below Target Price” or “Item Status equals ‘In Stock’”).

When the contextual interest manager determines that a contextual trigger definition has been satisfied, the system may initiate an automated activation workflow. For media content where a release date is identified, the system may cross-reference the hosting SAAS provider with the user's list of linked subscriptions. If the content is set to premiere on a service to which the user is already subscribed, one or more actions may be triggered automatically. The actions may include a notification informing the user of the upcoming availability and/or adding the content to their SAAS calendar planner on the specific release date. For real-world interests (e.g. restaurants), when one or more triggers (e.g. geospatial, temporal, etc.) are met, the system may generate a prompt proposing the item in the user's schedule. This effectively finds meaningful ways to remind the user of their interest by proposing actionable events (e.g. “You are near {restaurant} and have a free evening slot”) rather than merely displaying passive advertisements.

In some instances, the trigger condition may indicate availability on a service or location to which the user does not currently have access (e.g., a movie releasing on a non-subscribed platform, or a retail item exclusive to a specific membership). In response, the system may create a value-added notification. For example, the user may be notified of the availability and presented with a direct option to resolve the access gap (e.g. subscribing via the social SAAS marketplace or initiating a transaction. This allows for a a frictionless journey from the initial, latent “maybe” interest to a realized consumption event, ensuring the user does not miss items they are interested in while maximizing the utility of the platform's integrated marketplace.

In some instances, the utility of the “maybe” interface extends beyond paid advertisements to organic content objects encountered within the platform (e.g. recipes, news articles, and/or catalog entries). In some examples, the contextual interest manager may adapt the trigger definitions to match the utility of the content. For example, if a user marks a recipe with the “maybe” interface, the system may assign an “Ingredient Acquisition” trigger based on the user's geospatial proximity to a grocery vendor, or a “Social Utility” trigger based on the proximity of a calendar event such as a holiday or potluck. Similarly, if a user marks a television show that is currently exclusive to a non-subscribed service, the interest object may serve as a persistent availability monitor. In some instances, if the user has shared their interest list with high-trust contacts, the interest object can function as a decision point for social commerce. For example, a contact viewing the list may elect to “gift” the required subscription to the user via the cost sharing manager, thereby resolving the access gap through a social transaction rather than a personal purchase.

In some instances, the system extends the functionality of the “maybe” interface to physical-world advertisements and offline discovery points (e.g. printed media, billboards, and/or cinema pre-show trailers). The advertisement may include a machine-readable optical code (e.g., a QR code) and/or a near-field communication (NFC) tag. In some instances, the code and/or tag may be encoded with a specific Deep Link URI. When a user scans the code and/or tag using a client device, the device's operating system resolves the URI, which may trigger a specific action within the social SAAS manager application. The URI may be configured to invoke a specific intent capture routine. If the application is already installed, the deep link can automatically execute the “maybe” function, creating an interest object in the universal interest database without further user navigation. If the application is not installed, the URI may trigger an “instant application” or “app clip” experience-a lightweight, transient software module that displays the relevant content metadata and/or the “maybe” interface element without requiring a full software installation. This bridge allows users to capture latent interest from physical environments with the same friction-free, asynchronous logic used for digital advertisements, effectively turning the physical world into an input surface for the contextual interest manager.

The end-to-end and/or automated workflow of the contextual interest manager feature can be integrated into a method that can be practiced independently and/or as part of the larger platform. The exemplary method may include (a) rendering a non-destructive interactive overlay (e.g. “maybe” button) on an advertisement, content object, via a machine-readable code scanned from a physical medium, etc.); (b) capturing a user input indicating potential interest and generating an interest object comprising an entity identifier and/or a contextual trigger definition; (c) storing said interest object (e.g. in a universal interest database) for subsequent evaluation; and/or (d) actively monitoring real-time extrinsic data (e.g. geospatial location, temporal data, external API feeds, etc.) associated with the user's latent interest. This results in a completely automated method for contextual intent preservation, distinct from traditional bookmarking or immediate action e-commerce models.

Networked Data Storage with Shared Cost Burden

In some instances, the systems and methods described herein merge secure data management with integrated peer-to-peer financial transactions, addressing a significant gap in the current digital landscape. While applications like password managers for security and peer-to-peer (P2P) apps for cost-sharing are widely available, existing platforms do not unify these functions into a complete, automated lifecycle. The present disclosure describes a single, comprehensive solution for users to manage valuable digital assets—such as login credentials for SAAS subscriptions—securely share access with trusted contacts and automate the entire financial process, from establishing a cost-splitting agreement to programmatically enforcing its terms in the event of non-payment.

The system's security model is founded on end-to-end, zero-knowledge encryption, ensuring that only the user and their designated contacts can access shared data. In one instance, each user account is associated with a unique public/private key pair. All sensitive data, such as a SAAS password, is encrypted with the primary user's public key before being stored in their personal data storage. When a primary user wishes to share an item with a shared user, the primary user's client application decrypts the data locally using the primary user's private key, immediately re-encrypts it using the intended shared user's public key, and then transmits the newly encrypted data. This architecture ensures that the platform facilitates the secure transfer of data without ever having access to the unencrypted contents.

While a particular cryptographic method is described above, other security methods could be utilized. The present disclosure is not limited to a specific cryptographic algorithm or protocol; any suitable symmetric or asymmetric encryption method that employs secure, zero-knowledge data sharing may be employed. The password management functionality serves as an important and foundational tool that enables the combination of secure sharing, social interaction, and automated financial settlement.

Complementing this secure data sharing is an integrated cost-sharing mechanism that provides for the complete management of a sharing arrangement. The cost-sharing may be facilitated by the exchange of an access mechanism in exchange for the sharing of the login credentials to a particular service. The access mechanism may be a payment method (e.g. credit card or other payment account), credentials to a different service (e.g. being offered in exchange), or any other item which may be exchanged by the involved users. The system provides multiple paths for initiating an arrangement, such as a user proactively seeking a cost-sharing partner for a new subscription, offering unused device “seats” on an existing subscription via a social marketplace, or sending a direct invitation to a trusted contact. Once an agreement is established, the system utilizes a financial data aggregation service API to manage payments. To link a bank account for P2P transfers, a user is presented with a secure portal hosted by the financial data aggregation service. The user authenticates directly on their bank's official login page rendered within this secure portal, meaning the user's banking credentials are never stored or seen by the application's servers. Upon successful authentication, the aggregation service provides the application with a secure access token corresponding to the user's account. This token is then used to authorize and initiate P2P bank transfers between users to satisfy the terms of a cost-sharing agreement.

In some examples, the system provides two distinct financial management modes. In a fully automated mode, the system uses the secure tokens to programmatically initiate P2P transfers. The fully automated mode is a closed-loop enforcement mechanism; upon detection of a payment failure, the system automatically transmits a command to the secure access listed trust manager to revoke the shared user's device access, thereby protecting the primary user from financial loss. In a second “Ledger Mode,” for users who prefer to handle transactions externally, the platform may act as a system of record, sending automated reminders and providing a mechanism for users to manually confirm payments. This mode also includes a fail-safe where a primary user can manually report non-payment, which may initiate a grace period before the same automated enforcement action is triggered. As P2P transaction technology evolves, other current or future methods for initiating secure fund transfers may be integrated. The present disclosure describes systems and methods which integrate peer-to-peer transaction technology as a component to achieve a complete, automated lifecycle for collaborative consumption.

In another example, the systems and methods for shared cost burden described herein may be deployed as a modular software component integrated directly into a third-party SAAS provider's own platform. The functionality could be built into the account signup page or user account management portal of an online subscription service. The SAAS provider could proactively prompt its users to share an account and split costs, sending invitations via email, in-app notifications, or by displaying a QR code within their application's user interface. This allows the SAAS provider to leverage the system's core functionality to attract and retain customers by advertising collaborative pricing models.

Users can share and optionally split costs for any type of user data, including text-based secrets like recipes or activation codes, media files, and sensitive documents. The system also allows businesses or creators, such as social media influencers or other personalities, to share data with their network user base, offering either free or paid access to assets like fitness schedules or digital art. To protect all parties, the application may implement safeguards to govern financial transactions, such as imposing monetary limits on charges for certain data types and employing automated checks to detect and prevent suspected fraudulent activity.

### Social SAAS Activity

SAAS services are integral to modern life, yet current streaming platforms offer limited sharing and discovery between users. This fragmentation results in a lonely and cumbersome user experience, requiring manual and often selective sharing of streaming history. While some streaming services provide basic “share” buttons for social media, these features are limited, requiring active user input and often failing to accurately reflect the viewing experience. Similarly, community media sites attempt to fill this gap by allowing manual logging of streaming activity, but they are often confined to specific media types and lack direct, accurate information from streaming providers regarding current or historical offerings. Consequently, these platforms frequently lack comprehensive and up-to-date user streaming history. Existing social platforms do not enable real-time, integrated, and platform-agnostic interaction with multiple SAAS providers regarding their specific offerings. This absence creates a void where a universal hub for accessing and sharing streaming activity across all SAAS services—including, but not limited to, video, music, gaming and other online services—does not exist

The present disclosure describes systems and methods that address this by establishing a comprehensive and centralized record of a user's engagement across all their services, stored in a personal user SAAS log. In one example, for a SAAS provider that has been linked to the user's profile, a direct API integration through the SAAS provider API gateway enables the provider to transmit the user's activity data to the social SAAS server. This allows the system to maintain a complete and perpetual history of user activity, regardless of whether the user engages with content via the SAAS portals within the system's software or directly through the provider's own application. This method ensures that even if a provider only maintains a short-term activity history, a limitless record is preserved for the user within this system.

In instances where a SAAS provider does not support direct activity sharing, the system will, at a minimum, record all user interactions that occur through the platform's interface. For these providers, the SAAS portal, as integrated into the system, will record each deep link accessed by the user, whether that link was manually selected for one-off streaming or automatically played from a user's playlist. This dual approach ensures that a robust history of user activity is always captured, either comprehensively through a partner API or minimally through deep link tracking within the software itself.

Once activity records are established within each individual SAAS portal linked to the user's account, the system described herein provides a centralized activity overview. This aggregated list combines all user activity across all linked accounts. The central list can reuse many of the SAAS portal templates for metadata display, presenting poster images and descriptions for engaged content in scrollable carousels, similar to the native SAAS portals themselves. Users gain flexibility in how this data is displayed; they can choose to view activity “by subscription,” which would present a chronological list of content engaged with from each individual service. Alternatively, an overall chronological order can be selected, showing a single combined list of all content engaged with across all subscriptions, optionally detailing the exact time and date of engagement and the hosting provider.

This aggregated activity history is complemented by granular privacy controls. Users can selectively make none, portions, or all of this history visible to their trusted contacts. Additionally, users can create newsfeed posts for their contacts by selecting content directly from their activity history or from any of their linked SAAS portals. Such posts will automatically include a deep link to the selected content, enabling the user's contacts (or the user themselves) to easily click on it to engage with the content.

For instance, a user can post about a recently watched movie, expressing their positive or negative opinions, thereby creating an intriguing invitation for their contacts. A contact intrigued by such a post can then click the embedded deep link to access the movie directly or choose to add that movie to a personal playlist for near-term viewing, or even a custom watchlist for future consideration. This eliminates the need for users to manually recall recommendations from friends, ensuring interesting content is easily loggable and discoverable for future engagement. While the newsfeed facilitates immediate, in-the-moment social interaction, its posts are, by nature, temporal. The system provides a separate, more permanent mechanism for curated recommendations and discussions via recommendation lists, ensuring that valuable conversations about content do not get lost over time.

Furthermore, users have the option to display a “currently watching” status, allowing their closest contacts to see what content they are currently engaged with, whether it's a real-time music playlist, a TV series, or a movie. While this feature may not be suitable for an entire contact list, it offers a powerful social connection for specific contacts. For example, an adult user's mother could see what movie or TV show they are currently watching displayed within her social media newsfeed or somewhere on the user's profile, providing an organic topic for conversation or even an opportunity to initiate a watch party, thereby fostering closer relationships.

The present disclosure describes systems and methods for managing digital lives, enabling users to store, share, and engage with their streaming activities within a secure, private, and highly customizable environment. By providing a robust profile management system, direct API integration, and granular control over activity visibility, this system empowers users to own their online presence while fostering meaningful interactions with others who share similar interests.

### Personal Enjoyment Profile

In some instances, the system may utilize a personal enjoyment profile, a comprehensive and interactive log that functions as a universal taste repository or a personal diary of a user's preferences. The personal enjoyment profile is designed to capture ratings for a vast array of entities, from digital SAAS content to real-world products and experiences like restaurants or consumer goods.

For integrated SAAS subscriptions, a history of the user's activity may be populated within the software, either through interaction with the SAAS portals or via a direct API link with the provider that mirrors the user's activity from the provider's native application. The user can then access this activity log at any time to rate content post-consumption, and these ratings are recorded in their personal enjoyment profile.

To facilitate the rating of real-world establishments, a business such as a restaurant can maintain its own dedicated portal on the platform. This portal serves as the primary interface for users to rate the business and its specific offerings, like individual dishes, using dedicated rating functions. For the business, the portal is a promotional tool and a direct feedback channel; for the user, it becomes a personal history of their engagement, allowing them to remember which dishes they have ordered, which they enjoyed, and any modifications they might want in the future.

For other items, such as real-world products and experiences that do not generate an automated activity log, the user can manually add entries to their personal enjoyment profile. This is accomplished by providing a link (e.g. Uniform Resource Identifier (URI) or Uniform Resource Locator (URL)) to a specific product on a retail website, a restaurant's homepage, or a booking page for a travel excursion. Once the link is added, the user can attach their personal rating and notes to it. This allows the personal enjoyment profile to serve as a practical memory aid, helping users remember which brand of toothpaste they prefer, which cereal their children enjoy, or the details of an experience they wish to repeat. Furthermore, each entry in the personal enjoyment profile serves as a potential anchor for conversation. A user can attach a comment to any item in their personal enjoyment profile. This comment can be designated as public, contributing to a network-wide discussion about the item, or it can be used to tag the item for inclusion in a private, shareable recommendation list, as will be described further herein.

The user's personal enjoyment profile is a unified collection of rated items that can be dynamically organized and viewed by applying filters. This filtering is powered by content flags associated with each entry. For items added from a SAAS portal, descriptive flags are automatically carried over from the provider's metadata, such as the genre of a movie, book, or musical artist. For items added manually (e.g. via a URI), the user is presented with tools, such as a checklist, to apply their own flags, from broad categories like “restaurant” or “consumer good” to more granular details like the type of cuisine or product brand. To minimize manual data entry by the user, the system can programmatically generate these flags by parsing data from the provided URI. This can be accomplished by various methods, including the use of an AI agent employing Natural Language Processing (NLP) to analyze the page content, or by extracting structured data from the website's code, such as schema.org microdata, JSON-LD, or Open Graph protocol tags. This robust flagging system allows a user to create highly specific views of their preferences and to perform more meaningful comparisons with contacts on commonly rated items, providing direct insight into shared and divergent tastes within any given category.

Each user can access their personal enjoyment profile through a dedicated overview within the software. Consistent with the platform's emphasis on user control, this overview is governed by granular privacy settings. A user can choose to keep their rating history private, share it with only their trusted contacts (“friends only”), or make it visible to the entire network (“public”). The personal enjoyment profile overview is presented in a rich, interactive interface, allowing the user to sort and filter their ratings by numerous criteria, such as genre, content type (movie, TV show, album), the original SAAS provider, or date rated. A powerful social feature of this overview is the ability for a user to filter the list by a specific contact. This action generates a comparative view, displaying only the content that both the main user and the selected contact have rated, showing their respective ratings side-by-side. This provides a direct and insightful look into their shared and divergent tastes, fostering social interaction and discussion. This overview also functions as the primary user interface for accessing the user's conversation history, providing direct links to both the public, network-wide discussion threads and the private Rec List conversations they have initiated or been invited to.

### Similarity Scores

In some instances, the system utilizes a similarity score. The similarity score may be an underlying analytical scoring system that quantifies taste similarity between users. It may function as a closed-feedback control loop where the target value is a user's unique taste profile. The similarity score can be an evolving metric, for example on a scale of 0 to 100, which represents the degree of taste similarity between a main user (u) and any other user (i) on the network. This score is not global; it is unique to the perspective of user u. Upon joining the platform, every user i is assigned a neutral initial similarity score, simᵤᵢ(0), from the perspective of user u. For example, an initial score of 50.

As user u rates content (via their personal enjoyment profile), the system initiates a recursive adjustment process. Each rating event triggers a comparison between user u's rating and the ratings of all other users who have rated the same piece of content. This comparison continuously refines the Similarity scores.

The adjustment is calculated based on the absolute difference between two users' ratings for the same content. Let R_{uc} be the rating given by user u to content c, and Ric be the rating given by user i to the same content. The difference, Δ_{ic}, is:

$${Δ}_{ic} = \vert {R}_{uc} - {R}_{ic} \vert$$

The system then applies an adjustment value, Adj(Δ_{ic}), based on the rating difference. The specific function for this adjustment can be tuned based on empirical analysis of the system's performance to achieve the most accurate reflection of taste alignment. For instance, a basic implementation of the adjustment function may utilize predefined tolerance thresholds. For example, if the tolerance for high similarity (T₁) is 1.0 and the tolerance for moderate similarity (T₂) is 2.0, the adjustment function may be defined as:

$$Adj ( {Δ}_{ic} ) = \{ \text{} \begin{matrix}+ {k}_{1} & if {Δ}_{ic} \leq {T}_{1} \\ 0 & if {T}_{1} < {Δ}_{ic} \leq {T}_{2} \\ - {k}_{2} & if {Δ}_{ic} > {T}_{2}\end{matrix} \text{}$$

While this illustrates a basic implementation, it may be determined through system analysis that a linear or nonlinear adjustment function is more effective. Such a function would make the adjustment magnitude proportional to the rating difference, Δ_{ic}, allowing for more significant Similarity score adjustments in response to larger variances in user ratings.

Here, k1 and k2 are adjustment magnitudes (e.g., +1 and −3, respectively). The similarity score for user i from user u's perspective is thus updated recursively with each new commonly rated piece of content. The formula for the (n+1)^{th} update is:

$${Sim}_{ui} ( n + 1 ) = max ( 0 , min ( 100 , {Sim}_{ui} ( n ) + Adj ( {Δ}_{ic} ) ) )$$

This ensures the similarity score remains bounded between 0 and 100, constantly evolving as more data is collected and adapting to changes in the user's tastes over time.

A user's calculated similarity score with other users on the platform can be made visible within the user interface, such as on another user's profile page. However, to provide a more intuitive and user-friendly experience, the system is configured to represent this numerical score through an abstract, non-numerical visual indicator. In one example, the similarity score may be represented by a color-coded system, where a spectrum of colors indicates the degree of similarity (e.g., from a cool color for low similarity to a warm color for high similarity). In another example, the score may be displayed as a letter grade, analogous to a school grading system (e.g., A+ through F). Other graphical representations, such as a filled gauge or bar, may also be employed. This method of abstraction is intentionally designed to mitigate potential user anxiety or obsession over precise numerical values. By translating the score into a more qualitative indicator, the system fosters a friendlier social environment, allowing users to understand their taste alignment without the pressure of achieving a “perfect” numerical score.

### Personal Enjoyment Profile Ratings

In some instances, the system utilizes personal enjoyment profile ratings. The personal enjoyment profile rating is the predictive application of the similarity scores, designed to provide users with an estimated rating for content they have not yet experienced. The personal enjoyment profile rating is a personalized, estimated rating generated by a neural network-style weighted average of ratings from other users. The weight assigned to each user's rating is a direct function of their similarity score relative to the main user.

To enhance personalization, the algorithm is capable of distinguishing between multiple user groups and applying different weights to each. For example, in a basic implementation, the system may distinguish between two primary groups of raters: the user's trusted contacts (C) and the general network of other users (N). Ratings from contacts can be given a higher priority by applying a group weight, w_{c} for contacts and wₙ for the network, where typically w_{c}>wₙ. These weights can be tuned based on empirical analysis of the system's performance or user preferences.

However, the weighting system may be extended beyond this basic two-group model based on empirical analysis of the system's performance. More advanced implementations could define additional user cohorts and apply unique weights accordingly. For instance, the system could identify “fan groups” associated with specific content, such as a particular TV series or movie franchise. Ratings from users within that fan group could be assigned a distinct weight when calculating a personal enjoyment profile rating for that specific content. Furthermore, the weighting could be adapted based on the main user's own affiliation; if the user is also a member of that fan group, the ratings from fellow members could be weighted even more heavily. This allows for a dynamic and multi-faceted weighting strategy that can be refined over time to improve predictive accuracy.

An illustrative formula for a two-group system, calculating the estimated rating, PEPRuc, for user u on a new piece of content c is as follows:

$${PEPR}_{uc} = \frac{( {w}_{c} {\sum }_{i ∈ C} ( {Sim}_{ui} \cdot {R}_{ic} ) ) + ( {w}_{n} {\sum }_{j ∈ N} ( {Sim}_{uj} \cdot {R}_{jc} ) )}{( {w}_{c} {\sum }_{i ∈ C} {Sim}_{ui} ) + ( {w}_{n} {\sum }_{j ∈ N} {Sim}_{uj} )}$$

In this formula, the numerator represents the sum of all available ratings, each weighted by the rater's corresponding Similarity score and their group affiliation (contact or network). The denominator is the sum of all the applied weights, which normalizes the final score back to the original 1-10 rating scale. This methodology ensures that users with higher similarity scores (i.e., more similar tastes) have a proportionally greater influence on the final estimated rating. The personal enjoyment profile rating system is inherently adaptive, ensuring that recommendations remain relevant throughout the user's life as their tastes and social connections evolve.

To ensure statistical reliability and predictive accuracy, the generation of a personal enjoyment profile rating may be contingent upon meeting certain data thresholds. For instance, the system may require that the main user has rated a minimum quantity of content items across the platform to establish a stable and meaningful taste profile. Furthermore, a personal enjoyment profile rating for a specific piece of content may only be calculated if that content has received a minimum number of ratings from the wider user network, ensuring a sufficient data pool for the weighted average calculation. If either of these thresholds is not met, the system may indicate that there is insufficient data to provide a reliable estimate.

### Social SAAS Marketplace

In some instances, the platform may include a social SAAS marketplace. The social SAAS marketplace is a centralized and dynamic environment for users to discover, evaluate, and engage with a vast ecosystem of SAAS providers. This marketplace transforms the often-isolated process of finding new services into an integrated, social, and user-driven experience.

The marketplace functions as an interactive catalog where users can browse and filter SAAS providers across numerous categories, such as entertainment, productivity, education, or fitness. This discoverability is enhanced by social and data-driven features. For instance, the marketplace can display statistics on which services are popular among a user's trusted contacts, subject to each contact's privacy settings. A user can configure their subscription profile to be visible to certain friends, creating a network effect where recommendations are organic and trusted. The marketplace can also highlight new and popular service releases, showcase services that are trending or being mentioned frequently on external social networks, and feature targeted advertisements from SAAS providers, creating a rich and informative discovery engine.

The social SAAS marketplace may include the ability for users to offer unused portions of their own subscriptions to their network. Many SAAS subscriptions allow for multiple users or devices (i.e., “seats”) but are often underutilized by the primary account holder. For example, if a user's subscription allows for five concurrent device streams but they only use two, they can list the three available slots on the marketplace. This listing would only be visible to their designated trusted contacts. A close friend in need of that service could then opt-in to share the subscription. The system would facilitate a cost-splitting arrangement through its integrated payment features, allowing both the primary user and the shared user to benefit from the reduced financial burden. This creates a micro-economy within trusted social circles, maximizing the value of every subscription and fostering collaborative consumption.

Furthermore, the marketplace may enable users to proactively seek out partners before purchasing a new subscription. A user can post an offer within the marketplace stating their interest in subscribing to a new service and their willingness to split the cost. The user can define the visibility of this offer, choosing to post it exclusively to their trusted contacts or to their general contacts as well. If a contact who does not have a high-trust status accepts the offer, the system will require that contact to undergo an additional verification process to achieve high-trust status before the cost-sharing arrangement can be finalized. This verification can be completed through in-person methods (e.g. QR code scanning) or remotely (e.g. via multifactor authentication), ensuring that all financial partnerships are established between mutually trusted users. This feature allows users to gauge interest and secure a cost-sharing partner prior to any financial commitment, further reducing financial barriers to accessing new SAAS services.

The social SAAS marketplace is enabled by a computer-implemented business method for the complete and automated lifecycle of secure, collaborative consumption. This method may include: (a) a system for enabling a user to list an available subscription slot or proactively seek a cost-sharing partner; (b) a programmatic requirement to verify a ‘high-trust status’ between the parties before any financial arrangement can be established; (c) an automated fulfillment process wherein, upon agreement, the system programmatically whitelists the new user's device with the third-party SAAS provider via the secure access listed trust manager; and (d) a closed-loop financial enforcement mechanism wherein the system programmatically initiates payments and, upon detecting a payment failure, automatically sends a command to the secure access listed trust manager to revoke the shared user's device access. This full, automated lifecycle—from listing and trust verification to programmatic device whitelisting and automated payment enforcement—provides a secure and frictionless solution for collaborative consumption.

### Single-Click Paid Subscription Registration

In some instances, a single-click paid subscription registration can be integrated into the platform. The single-click paid subscription registration improves efficiency and security of the new user sign-up process. This process leverages the user's securely stored profile data to automate registration according to one or more authentication methods (e.g. similar to OAuth and OpenID Connect (OIDC)), applied to the initial account creation.

When a user decides to subscribe to a new service through the social SAAS marketplace or a SAAS portal, the SAAS provider may present a dedicated registration endpoint, preferably within a secure pop-up browser window hosted on their domain. The platform may interface with this endpoint to autofill the registration form with the user's pre-saved data. This data includes standard personal information such as name, email, and telephone number, but also a user-defined preferred username and a preferred payment method linked from a digital wallet service (e.g., Apple Pay, Google Wallet) stored within the user's profile.

Furthermore, to bolster security, the software's integrated password manager generates a strong, unique password on behalf of the user and autofills it into the password field. The user is then presented with a final confirmation page that displays all the pre-filled personal and payment details, alongside the SAAS provider's terms and conditions. If the user proceeds with confirmation, the generated password is stored in their password manager along with the username.

This confirmation page may include a checkbox to “Simultaneously link this new subscription to your profile.” When selected, this initiates an authorization flow (e.g. OAuth) in concert with the registration submission. Upon the user clicking the final confirmation button, the platform not only sends the registration data to the SAAS provider to create the new account but also completes the authentication handshake. This results in a seamless, single-interaction process where the user is registered, subscribed, and has securely linked the new SAAS portal to their central management profile without any redundant steps.

Upon successful completion of this integrated registration and linking process, the pop-up browser window closes, and the user is returned to the platform where a new prompt appears. This prompt immediately leverages the social and financial features disclosed herein by asking if the user would like to share access to this new subscription with any of their trusted contacts. If the user agrees, they are presented with their contact list, allowing them to select one or more individuals to invite. Contingent on the subscription's terms (e.g., number of allowed users or devices), the user can then initiate a cost-splitting arrangement. The platform guides them through setting up the financial terms, such as dividing the monthly fee, which will then be managed automatically by the integrated payment system. This immediate post-registration workflow transforms a solitary purchase into a collaborative and financially efficient action, seamlessly integrating the new asset into the user's SAAS platform from the moment of its creation.

The single-click registration feature is a multi-stage automated onboarding and social integration workflow that can be practiced standalone or integrated into the system. The method may include: (a) in a single user interaction, not only autofilling personal data and a preferred payment method, but also invoking an integrated password manager to generate a new, cryptographically strong password, autofill it, and simultaneously save it to the user's secure data vault; (b) combining the registration submission with an immediate, concurrent OAuth handshake to securely link the new subscription to the user's management portal in the same step; and (c) upon successful linking, immediately prompting the user to initiate a SAAS Subscription Sharing Flow. This complete, integrated process—from automated secure password generation to concurrent account linking and immediate social sharing—can be implemented by any digital marketplace or service provider.

### Video Call Watch Party

The system of the present disclosure may further include a video call watch party functionality. The video call watch party is designed to transform the traditionally isolated experience of consuming digital content into a synchronized, interactive, and social event. A watch party allows multiple users in different physical locations to view content together in a synchronized, communal event. This feature may leverage and extend the capabilities of the SAAS management TV companion app, allowing users to create and join shared viewing sessions with trusted contacts, family, or a wider community of users. This experience is uniquely facilitated by coordinating two simultaneous activities for each participant: the synchronized playback of content on a primary viewing device, such as a television, and a concurrent video conference hosted on a secondary device, such as a mobile phone utilizing its camera.

In some instances, the watch party incorporates a client-side integrated media player that works in concert with a server-side integrated media engine. This distributed architecture overcomes the inherent challenges of synchronizing playback across disparate devices and third-party applications. This integrated approach provides granular, programmatic control which enables a truly seamless and feature-rich shared viewing event.

### Integrated Universal Media Player and Synchronization

The system of the present disclosure may include an integrated media player for securely accessing and decrypting content from various third-party SAAS providers without compromising their intellectual property or content security. This requires communications and permissions with the third-party SAAS providers. In some instances, this is achievable by implementing an architecture that leverages media extensions (e.g. Encrypted Media Extensions (EME)) and interacts with each provider's existing infrastructure (e.g. Digital Rights Management (DRM)). The architecture includes several key components working in concert, including the social SAAS manager software on a user's device containing the player and DRM logic, a backend system acting as a secure intermediary, and the third-party provider's own services. The process ensures that at no point does the software of the present disclosure have access to unencrypted content keys or the decrypted video stream, maintaining a secure chain of custody for the third-party content.

The process of playing DRM-protected content is orchestrated in a secure, multi-step flow. The process begins with a playback initiation request from the software to the backend system, which in turn performs a secure retrieval of playback metadata, such as a Manifest URL and a License Server URL, from the provider's API. These URLs are securely passed back for player initialization within the software's integrated media player. During manifest parsing, the player detects the DRM and extracts the initData. This leads to license request generation, where the player uses the EME API to pass the initData to the device's native Content Decryption Module (CDM), which generates an encrypted license request. For license acquisition, the software sends this request to the provider's license server with a user authentication token. Finally, during license ingestion and secure playback, the player receives the encrypted license and passes it to the CDM, which then decrypts the content on the fly as it streams from the CDN.

The use of an integrated player allows for a sophisticated synchronization protocol. In some instances, the system employs a host-controlled model for playback commands, where the user who initiates the watch party may be designated as the “host,” granting their player instance primary administrative control. The host can choose to retain this control exclusively or grant permissions to other “participants” in the party. When a user with control permission performs an action like pausing or seeking, an event listener within their player detects the change and sends an event message to the backend system detailing the action and the precise timestamp. The server then broadcasts this command to all other participant clients, whose applications programmatically issue the corresponding function to their local media player for an instantaneous and synchronized action. To counteract desynchronization caused by network latency or buffering, the system employs a periodic sync pulse mechanism. In this mechanism, the host's current playback timestamp is regularly broadcast to all participant clients.

Upon receiving this sync pulse, each participant client compares the host's timestamp to its own local playback time. If a discrepancy exists beyond a predefined tolerance threshold (e.g., 500 milliseconds), the client's media player will automatically perform a corrective action to realign. This correction can be achieved through various non-disruptive techniques, such as subtly accelerating or decelerating the playback speed until synchronization is restored, or by executing a micro-seek to the precise host timestamp, ensuring an imperceptible adjustment for the user and maintaining a seamless, shared experience.

The integrated media player architecture uniquely enables the rendering of dynamic data as a distinct video track overlaid on the primary content. This allows for features such as displaying the video feeds of watch party participants directly on the TV screen, allowing users to see and hear their friends' reactions in real-time. To achieve this effect efficiently for streaming, these overlays are created as video files that utilize an alpha channel for transparency. However, professional video formats with a true alpha channel (e.g. ProRes 4444), are impractical for streaming due to their large file size. To overcome this, the system is optimized to generate and composite overlays using a luma matte technique. This method utilizes two separate, highly compressed video streams: one containing the color information of the overlay against a black background, and a second grayscale matte stream that defines the transparency, with white areas representing opacity and black areas representing transparency. The user's integrated media player decodes and composites these two streams with the primary SAAS content in real-time. These overlays, which could also include avatar animations or interactive polls, can be toggled on or off by the user.

To further enhance the social experience, users may be represented by customizable avatars within a virtual theater environment. Participants can command their avatars to perform context-sensitive actions, such as laughing or throwing virtual popcorn, with these actions being visible to all other participants.

The platform provides comprehensive controls for managing the watch party. A user can create an event by sending invitations to trusted contacts or by posting a public invitation for any user subscribed to the same service to join. The host retains administrative privileges, including the ability to mute or remove participants. Participants also have granular control over their own experience, such as muting the chat or avatar interactions from a specific user without leaving the party. This functionality enables the formation of fan groups that can host regular, recurring watch parties, such as for weekly episode releases of a popular TV series. The system can also leverage the personal enjoyment profile rating to allow users in public parties to filter interactions to participants with similar tastes.

Optionally, the user can select features such as gaze correction to make the watch party feel more natural. Users in a watch party engaging the front-facing cameras of their mobile devices to livestream themselves while in the party may be looking at their TV while their camera records them. To the other users in the watch party it will appear that the user is looking off screen, because they are, and that may feel odd and impersonal, especially if the other users have their face overlays playing on top of the content they're streaming. To make this feel more natural and personal, the users can apply a gaze correction filter that adjusts the pupils of a user's eyes in the recorded video to appear they're looking directly at the camera and engaging with the other participants.

Furthermore, SAAS providers themselves can leverage the watch party functionality as a marketing and community engagement tool. A provider could host large-scale, interactive viewing events for movie premieres or series finales, opening a new avenue for user engagement.

### Companion Streams

In some instances, the platform includes companion streams, a feature designed to pioneer a new genre of user-generated and professional content creation. This system moves beyond simple commentary, empowering creators to produce a vast array of synchronized media overlays that run in concert with primary content from SAAS providers. This transforms passive viewing into a participatory and deeply customizable event, allowing users to select from an array of experiences to layer atop their favorite movies, shows, and other media.

In one instance, the companion streams may include any form of complementary content. A user could watch a historical drama accompanied by a companion stream from a university professor providing real-time context. In another example, a viewer could watch a thriller with a comedic track from a popular influencer, or even follow a cooking-themed companion stream where a chef prepares a meal in their own kitchen, with the steps synchronized to the film's runtime. This functionality provides a platform for creators to engage with audiences in a more intimate and authentic format, while giving users unprecedented control to curate their own unique viewing experience.

Technically, a companion stream is a set of secondary video and audio tracks engineered to be overlaid onto the primary content stream without altering the original source file from the SAAS provider. In one example, these overlays are created as video files that utilize an alpha channel for transparency. This means the overlay file contains pixel information only for the area of interest (e.g., the influencer's reaction video in the corner of the screen), while the rest of the video frame is transparent, allowing the original SAAS content to show through. The audio is a separate, synchronized track. Crucially, the companion stream files contain only this additive overlay data and none of the original, copyrighted content from the SAAS provider. When a user selects a companion stream, the integrated media player renders both the primary stream from the SAAS provider and the secondary overlay stream simultaneously, creating a composite, layered viewing experience for the user.

As used herein, the following terms shall have the following meaning: companion stream-A separate, non-destructive media file containing additive visual and/or auditory data, generated via differential analysis, which is designed to be composited with a primary SAAS content stream in real-time on a client device.

The companion stream file contains zero copyrighted data from the original SAAS content. It is an independent data file containing only a set of time-coded instructions and additive visual/auditory assets. The final composite experience is produced entirely on the end-user's client device in real-time, and only if that user has independently and legitimately licensed the primary SAAS content. The platform, therefore, acts as a publisher for enhancement data, not a distributor of copyrighted material.

The platform may include a reporting mechanism for users to flag companion streams that violate community guidelines. A content moderation team and/or automated content analysis tools may be employed to review flagged content and take appropriate action.

Companion streams provide a broadly applicable framework for the non-infringing modification of a media consumption experience. This framework for the companion streams includes a two-part system and method that can be practiced independently of the social platform. The first part is a method for generation, performed by a server-side editing suite, which includes: performing a differential analysis between a primary, copyrighted media stream and a modified version thereof to generate a separate, non-destructive overlay file, wherein said overlay file contains only the additive visual and/or auditory data corresponding to the modifications and contains zero copyrighted data from the primary media stream. The second part is a method for consumption, performed by a client-side media player, which includes: receiving the unaltered, DRM-protected primary media stream from a third-party provider; simultaneously receiving the separate, non-destructive overlay file; and compositing the two streams in real-time on the client device's display. This process for generating a non-infringing overlay via differential analysis and enabling its real-time, client-side compositing can be implemented by any SAAS provider or content aggregator to enable transformative, user-generated, or professional overlays on their own proprietary content.

### Integrated Media Editing Suite

To facilitate the creation of companion streams and other advanced media modifications, the software platform of this present disclosure includes an integrated media editor. This suite is a powerful component that provides creators with the tools to produce, synchronize, and publish their overlay content. It functions as a comprehensive content creation hub, containing not only standard video and audio editing tools (e.g., trimming, track mixing, etc.) but also a set of functionalities designed specifically for generating interactive and transformative overlays. Beyond static content creation, the suite also deeply integrates with the platform's media player, allowing creators to embed programmatic playback commands directly into their creations. This editor is the engine that empowers both casual users and professional creators to build the next generation of interactive entertainment.

### Programmatic Media Player Control

Another aspect of the integrated media editing suite is its ability to embed timestamped playback commands into a companion stream's data track. These commands are metadata instructions that the integrated media player is configured to interpret and execute in real-time during playback. Such commands include, but are not limited to: play, pause, seek to a specific timestamp, and execute a deep link to different content. This allows for a directed, interactive experience curated by the creator.

For instance, a creator producing a companion stream for a single film can insert a ‘pause’ command at the beginning of an intense scene to provide detailed analysis or a comedic reaction without being interrupted by the film's progression. Following their commentary within the overlay track, a subsequent ‘play’ command would seamlessly resume the primary SAAS content.

In another example, this functionality enables the creation of standalone “medley” or “compilation” companion streams, which are not tethered to a single piece of SAAS content but are available as distinct media on the creator's portal page within the platform. A creator could produce a “Top 10 Funniest Scenes” list, where their companion stream begins with an introduction and then uses a series of timestamped deep link commands to play the various scenes sequentially. The system can execute deep links to content across different SAAS providers. Playback of such a medley stream is contingent on the viewing user having valid, active subscription access to all SAAS providers whose content is referenced. If the user is missing access to some or all of the content, they will see a notification saying as much. The system facilitates programmatic access to content the user is already authorized to view, rather than distributing the content itself.

This medley functionality requires an even more robust method of synchronization. To manage the loading time for each new piece of content—for processes such as manifest parsing and DRM decryption—the system can be configured to pause the companion stream overlay and display a creator-branded transition frame or video. This masks the buffering period from the user. Once the new content begins playback, synchronization is re-established using a programmed timestamp offset defined by the creator in the editing suite. For example, the overlay may resume at a timestamp of 05:32:28 while the second piece of content in the medley starts at 00:00:00. This pre-defined offset ensures the creator's commentary remains perfectly aligned with each distinct piece of content in the compilation.

### Dynamic Metadata Display and Interactive Curation for Medley Streams

In some instances, the platform integrates a dual-screen, enhanced remote control functionality in a dynamic manner. In some instances, when a user initiates playback of a medley stream on a primary device, such as a television, their secondary device (e.g., a mobile phone) serves as an interactive control and information hub.

For example, as the companion stream programmatically transitions between different pieces of SAAS content, the user interface on the secondary device dynamically updates to display relevant metadata. This includes persistent information about the overarching medley stream (e.g., the creator's ‘Top 10’ list) as well as contextual metadata for the specific SAAS content clip currently being played, such as the title, poster image, and description of the movie the clip is from.

This dynamic display enables a powerful and frictionless content curation workflow. If a user is intrigued by a particular clip within the medley, they can interact directly with the metadata displayed on their secondary device. The interface will present options, such as dedicated buttons, to add the full piece of SAAS content to their personal playlist for near-term viewing or to a watchlist for future consideration without interrupting the playback on the primary device. This allows the user to seamlessly capture interest and plan future viewing without ever needing to exit the medley stream or manually search for the content later, thereby turning a curated compilation into an efficient engine for content discovery.

### Content Enhancement and Filter Overlays

In some instances, the platform (e.g. the integrated media editing suite) includes an ability to generate content enhancement and filter overlays. This feature allows a creator to apply visual and auditory effects to existing SAAS content in a non-destructive way. The process involves using the editing suite to render the desired alterations and then isolating only the changes into a standalone overlay file that is designed to be composited with the original content in real-time by the end user's media player. While a creator may work with a short clip of the primary content within the editor to preview an effect, the system is designed to apply the final effect across the entire duration of the work.

The system supports many types of content enhancement. For any piece of content, a user can create general-purpose overlays, such as commentary tracks or simple visual additions. For select, partnered content, the system utilizes pre-supplied metadata editing tracks. These tracks, provided by the studio partner or generated offline by the platform, contain detailed information such as pre-calculated digital masks that identify and track specific actors' faces, or data that isolates individual audio stems (e.g., dialogue, music, effects). The editing suite leverages these tracks to enable highly efficient and accurate actor-specific modifications, such as applying facial filters or performing AI recasting, as the computationally expensive task of identifying and tracking the target has already been performed.

To generate the overlay file itself, the system employs a technique optimized for efficient streaming. For example, to apply a comedic “bug eye” filter to an actor, the editing suite first leverages the metadata mask track to isolate the actor's eyes. After the creator applies the filter, the software performs a differential analysis and generates two separate, highly compressed video streams using a luma matte technique. One stream contains the color information of the “bug eye” effect against a black background. The second stream is a grayscale matte that defines the transparency, with white areas representing the opaque filter and black areas representing the transparent background. Because these two streams can be heavily compressed using standard web codecs (e.g., H.264), the resulting file size is small, making it ideal for streaming. The user's Integrated Media Player then decodes both streams simultaneously and composites them with the primary SAAS content in real-time.

This technology enables limitless creative additions, from simple filters to users inserting video of themselves into a scene—for instance, acting out slipping on a banana peel in the background of the iconic blood elevator scene from The Shining. Because these additions exist as optional, separate overlay files, they constitute a new creative work that enhances rather than illegally modifies the original copyrighted material.

### Personalized AI Casting and Licensed Deep Fakes

In some instances, the system (e.g. via the integrated media editing suite) includes a personalized AI casting feature, a system for creating and applying licensed, high-fidelity deep fake overlays. This feature allows a user to recast roles in movies and shows with AI-generated likenesses of themselves, their family, and their friends, creating a hyper-personalized entertainment experience akin to a “JibJab for the modern streaming era.”

This concept extends beyond visual media into other SAAS formats, such as music streaming. For example, a user's AI vocal profile can be used to replace the lead vocals on a professionally recorded song. The integrated media editing suite would process the user's vocal profile, applying pitch correction and other autotuning effects to match the original melody, and generate a new audio overlay. When played over the instrumental track of the original song, the user can hear a version where they are the lead singer. This functionality could be further enhanced with a karaoke feature, allowing a user to create a duet with their own AI-generated vocal profile, singing both lead and harmony parts.

This functionality requires a collaborative ecosystem built on explicit partnerships and consent between the platform, SAAS providers, content studios, and the actors themselves. A user would first create an AI profile by providing a corpus of source material, such as images or video of their face showing different expressions, and audio recordings of their voice to the system.

The system ingests this material to train a personalized generative model for the user, potentially leveraging architectures such as Generative Adversarial Networks (GANs), diffusion models, or similar neural networks to create a high-fidelity digital likeness and vocal profile. It is contemplated that any suitable current or future generative AI architecture capable of producing a high-fidelity digital likeness may be utilized. To recast a movie, the user would select the content and assign their created AI profiles to specific roles. The system then prepares to generate a comprehensive video and audio overlay by using either pre-identified role data provided by studio partners, or, where such data is unavailable, its own AI-driven actor identification technology.

This technology may employ a computer vision pipeline that processes the video to detect and isolate faces on a frame-by-frame basis, which are then compared against a database of known actors to identify the character in each scene.

To ensure the integrity of the original source media, and similar to the method used for filter overlays, this overlay is generated via a differential analysis. The resulting video track contains only the pixel information corresponding to the user's AI-generated face rendered onto a transparent alpha channel, representing only the data that is different from the original actor's performance. Likewise, the accompanying audio track consists only of the new, synthesized vocal data to replace or mix with the original dialogue. This overlay, containing only the additive facial and vocal information, is a distinct file that is played simultaneously with the original, unaltered SAAS content to produce the final deep fake experience for the user.

The commercial and ethical viability of this feature hinges on a transparent and equitable consent framework. All parties agree to allow for the modification of a specific piece of content. Actors would have granular control, providing consent on a per-movie basis and retaining the right to prohibit their likeness from being used in specific roles or scenes, particularly those of an intimate or sensitive nature. This ensures that the creative rights and personal comfort of the original artists are respected.

This collaborative model is incentivized by a significant new revenue stream. Personalized AI casting may be a premium, paid feature. In one example, users may pay a fee for the unique experience of seeing themselves star in their favorite blockbuster, such as The Avengers. In one example, the revenue from these transactions would be shared among all stakeholders. In another exemplary arrangement, the revenue could be split with the largest portion going to the actors whose likenesses are being modified, with further shares allocated to the content studio, the SAAS provider, and the platform itself, thereby compensating all parties for their contribution to the interactive experience.

### Autocast Ads

The platform of the present disclosure may further include interactive advertising, herein referred to as autocast ads, which leverages the platform's personalized AI casting capabilities to create hyper-personalized marketing experiences. This feature is designed to dramatically increase user engagement by programmatically and securely inserting a user's own likeness into an advertisement.

The process requires a collaborative effort between an advertiser and the platform. An advertiser, such as a movie studio or brand, creates a video advertisement specifically for this feature. The ad creative is produced in such a way that at least one character has their face pre-masked. This mask is not merely a blank space, but a data layer containing specific area markers for facial features (e.g., eyes, nose, mouth) that guide the placement of an AI-generated overlay. This pre-masked video asset is then provided to the social SAAS manager platform.

The functionality is entirely user-permissioned. Within their platform profile, a user can choose to check or uncheck a setting such as “Enable Autocast Ads.” By opting in, the user consents to their personal AI profile being used for this specific purpose. The system is architected with strict privacy controls; a user's AI likeness is only ever used to generate ads that will be displayed to that same user. The user's likeness will not be used in advertisements shown to any other user on the network, unless they have granted explicit permission for a trusted contact (e.g., a family member) to use their AI profile.

In some instances, use of offline processing ensures an instantaneous user experience. When an advertiser uploads a new autocast ad, the system's backend identifies the entire pool of users who have opted-in. For each of these users, the system proactively generates a personalized, non-destructive overlay file. It retrieves the user's AI profile (containing their facial and vocal models) and, using the advertiser's pre-masked video as a guide, renders the small overlay file containing only the additive data of the user's face and/or voice. This process is completed offline, before the ad is ever scheduled to be served to the user.

When the advertisement is delivered to the user, for instance within their newsfeed, the system leverages the pre-generated assets to create a powerful engagement hook. The freeze-frame preview or thumbnail for the video ad is dynamically generated to include a scene that prominently features the user's own AI-generated face. Upon seeing their own likeness in a seemingly standard ad, the user's curiosity is piqued, compelling them to play the video.

Playback of the advertisement occurs within the platform's integrated media player. The player simultaneously composites two video streams in real-time: the original, pre-masked ad creative from the advertiser, and the user's unique, pre-generated overlay file. The result is a seamless video in which the user appears as a character in the advertisement, creating a memorable and highly effective marketing interaction.

The autocast ads may be integrated into the platform using a workflow including: (a) requiring an advertiser to provide a pre-masked video asset, wherein the mask contains specific data markers for guiding the placement of a facial overlay; (b) upon receiving a new ad, proactively and offline generating a unique, personalized, non-destructive overlay file for each opted-in user before the ad is ever served; and (c) delivering the ad by first displaying a dynamically generated thumbnail that features the user's own AI-generated face, followed by the client-side media player compositing the original pre-masked ad creative and the user's unique, pre-generated overlay file in real-time during playback. This workflow, from the pre-masked asset requirement to the offline pre-generation and real-time compositing, constitutes a highly scalable method for creating and delivering hyper-personalized, interactive advertisements.

### Dynamic Subscription Tier Management

The platform may further include a system for dynamic subscription tier management, a framework designed to offer a flexible, usage-based alternative to the rigid, binary subscription models prevalent in the SAAS industry. In one example, this system may be implemented as a premium feature deeply integrated within The Platform's ecosystem, or, in another example, as a standalone, licensable software that a SAAS provider can integrate directly into their own technical infrastructure, allowing it to operate independently.

The system addresses the need for a middle ground between costly, unlimited ad-free plans and entirely ad-supported experiences by introducing a quantifiable usage allowance for each subscription account for a given billing period. This total allowance amount is determined and controlled by the SAAS provider based on the terms of their subscription tier; the system or the integrated software simply acts as the technology to enforce these provider-defined business rules. This allowance can be measured by various metrics, including but not limited to, total viewing time, data egress, or a combination thereof. When a user's allowance is depleted, the system seamlessly transitions their experience from ad-free to ad-supported within a single billing cycle.

In some instances, the system implements a gamified layer to reframe the consumption limit as a manageable resource. The usage allowance is represented as a form of in-app currency, such as “tokens” or “tickets.” This transforms the SAAS portal into a dynamic internal marketplace where the SAAS provider can assign variable consumption costs to different pieces of content. For example, a provider could assign a premium ticket cost for a new movie premiere to pace initial demand, while simultaneously offering promotional discounts, such as half-cost or ticket-free viewing, for a specific genre of content to drive engagement. This provides the SAAS provider with a powerful new lever to manage content consumption and create a sense of abundance or scarcity.

This gamified framework creates opportunities for SAAS providers to increase user engagement, satisfaction, and retention. Through the platform, providers can offer promotional events and rewards. For example, a provider could host a “ticket-free weekend” during a holiday or automatically grant a user bonus tickets on their birthday. Furthermore, providers could implement “random ticket drops,” depositing a small number of free tickets into a user's account as a surprise, fostering goodwill and encouraging continued engagement with the service.

The system provides robust management of shared subscriptions, which shifts the focus from a single user to the entire account. The primary user is provided with tools to subdivide the total monthly allowance among the different users sharing the account. For instance, if a subscription tier comes with an allowance of 40 tickets, the primary user can allocate 10 tickets to themselves and 10 to each of three trusted contacts. This creates individual allowance balances for each user under the umbrella of a single subscription, ensuring that one user's high consumption only depletes their personal ticket allowance without negatively impacting the experience of others on the same account.

In the platform-hosted example, the system solves the technical challenge of user attribution in a shared-credential environment. When consumption occurs on the SAAS provider's native application, where all users appear identical, the system requires the provider's inbound API event to include device-identifying information. The platform then performs a user attribution lookup by cross-referencing this identifier with the device whitelists managed by the secure access listed trust manager. If the device is uniquely assigned to a single user, the consumption cost is deducted from that user's specific balance. In cases where attribution is uncertain (e.g., a shared living room TV), the system defaults to deducting the cost from the primary user's balance. To give the primary user ultimate control, they can enable a subscription-level setting such as “Native App Playback Defaults to Ad-Supported,” which causes any activity from the provider's native app to bypass the allowance deduction process entirely.

In the standalone example, a SAAS provider licenses and integrates this entire logic as a modular component within their own backend servers and databases. This self-contained system allows the provider to offer these advanced, dynamic subscription tiers to their entire customer base, independent of whether those customers are users of the system. This provides the SAAS provider with a powerful new set of tools to manage content consumption, create promotional events, and mitigate costs associated with high-usage subscribers, all within their own ecosystem.

The dynamic subscription tier management system represents a versatile commercial offering. It can be provided either as a premium, integrated feature for partners on the system, or as a licensable software for independent implementation. For SAAS providers, this system introduces a new, highly marketable subscription tier that appeals to cost-conscious consumers and allows providers to mitigate the significant costs associated with high-usage users, such as data egress and Digital Rights Management (DRM) license fees. The functionality may be managed by the dedicated dynamic tier manager, which interfaces with other components to track usage, display balances in the SAAS portal, and present the dynamic tiers as a new subscription option in the social SAAS marketplace.

### Recommendation Lists and Persistent Content Conversations

The platform further includes a system for creating, managing, and sharing recommendation lists (“Rec Lists”), which are user-curated, shareable collections of content items. The purpose of a rec list is to enable a user to share themed recommendations (e.g., “Best Sci-Fi of the 90s”), build a personal library of content to suggest to others, or collaboratively plan a viewing schedule with other users. The system provides multiple methods for a user to populate a rec list, ensuring they can recommend items they may have watched prior to joining the platform or that are more easily found via search. A user may select a content item from within their personal enjoyment profile, directly from a third-party provider's SAAS portal, or from the results of a platform-wide content search.

A content item may be displayed within a rec list is presented using the same standardized user interface element, such as a content card or thumbnail, as seen in other areas of the platform like a SAAS portal or a user's playlist, ensuring a consistent user experience. However, rec list entry may further include a dynamic access status indicator. This visual indicator, visible to both the list's originator and its followers, programmatically cross-references the known hosting SAAS providers for that content item against a specific recipient's list of linked subscriptions. This allows both the user who created the list and the recipient to see at a glance whether the recipient currently has access to the recommended content.

This access information enables a powerful and seamless gifting workflow. For instance, a user compiling a list for another user may observe through the access status indicators that several recommended items are unavailable to the recipient. Using the interface's filtering tools, the list creator can identify if these inaccessible items are concentrated on a single SAAS provider to which the recipient is not subscribed. The list creator can then navigate to the social SAAS marketplace to register for the new service. Upon completion, the list creator becomes the primary user of the new account and can use the data manager to securely share the newly generated login credentials with the recipient. The recipient becomes a shared user of the primary user's newly registered account. Finally, within the cost sharing manager, the primary user can designate the shared subscription as a “gift,” a status which causes the cost sharing manager to bypass any automated cost-splitting payment requests to the shared user. The shared user, after accepting the shared credentials, can then use the secure access listed trust manager to authorize their own devices for the new subscription, completing the integrated gifting process.

Once a rec list has been created, it can be shared using a flexible, multifaceted model. In a passive sharing mode, a list creator can publish a rec list to their own profile with granular audience controls. Visibility can be set to be entirely public, available to all contacts, or restricted to specific, custom-created user lists. In this mode, other users who are within the designated audience can discover the list on the originator's profile and make a conscious choice to “follow” it. Following a list creates a persistent link, allowing the user to receive real-time updates to that list. This mode also supports monetization, providing a valuable tool for users who are influencers, professional critics, or other tastemakers on the platform. The originator of a rec list can set its visibility to a custom group composed of their paying subscribers, thereby offering them exclusive, curated content.

Alternatively, in an active sharing mode, a list creator can send a rec list as a private recommendation to one or more specific users. This action generates a direct notification or share request to the intended recipients, presenting them with an immediate choice to accept and follow the list. To protect users from unsolicited spam, the system includes recipient-side privacy controls. A user can define who is permitted to send them direct rec list share requests, with options such as “everyone,” “contacts only,” or “high-trust contacts only.” A persistent, private conversational thread may be attached to each item within a shared rec list. When the user creating the list adds a comment upon creation, or when a recipient replies, this action creates a threaded conversation visible only to the list's originator and the other users following that specific list.

To provide recipients with granular control over their own content consumption pipeline, the system allows them to manage recommendations on an individual basis. This is particularly important as the cross-platform manager and SAAS calendar planner can be configured to automatically populate a user's schedule. The primary method for managing a recommendation is through the application of a private tag, visible only to the recipient. For instance, a recipient can apply a “Backburner” tag to an item. This private tag programmatically flags the content to be ignored by the automated playlist and schedules, preventing deprioritized suggestions from appearing in the user's queue without creating social friction.

The system provides a dedicated user interface, which in one example may be referred to as a “Rec Room,” that serves as the central hub for users to interact with all the recommendation lists they have created or are following. This interface is equipped with a robust filtering and search system. A user can apply filters based on their own private tags (e.g., “Backburner”), metadata (e.g., “oldest unwatched”), or content-descriptive flags from both SAAS providers and the user's personal enjoyment profile. This transforms the interface from a simple repository into an intelligent engine for finding content a user is most likely to enjoy.

The system is further enhanced by leveraging the platform's layered permission model, particularly the visibility of a user's personal enjoyment profile. If a list creator has permission to view a recipient's personal enjoyment profile, the system automatically displays the recipient's real-time consumption status for each item on the list, using the same visual indicators as the personal enjoyment profile rating system. This provides the list creator with passive feedback and automatically informs them if a recipient had already seen a piece of content.

This intelligent application of features, where displayed information adapts based on the granular privacy settings between users, dictates the relevance of direct feedback mechanisms. In cases where a list's originator does not have permission to view a recipient's personal enjoyment profile, a premade tag like “Already seen” remains a relevant feedback tool. Likewise, a recipient can “Decline” a recommendation with a tag like “Not for me” or a custom message facilitated by the messenger.

This entire system is designed to solve the issue of social ephemerality. Because the rec list conversation is permanently attached to a specific piece of content within a persistent interface, it remains relevant and accessible indefinitely, allowing a user to revive a conversation months or even years later without it being socially unusual.

In a further example, this commenting functionality is bifurcated to serve two distinct social purposes. While comments on a rec list entry remain private to the list's followers, the system also allows for network-wide public conversations. When a user adds a rating to an item in their personal enjoyment profile, they can add a general comment that is aggregated into a global, public discussion thread for that content, allowing users to engage in both intimate, curated discussions and a larger public discourse.

### System Overview

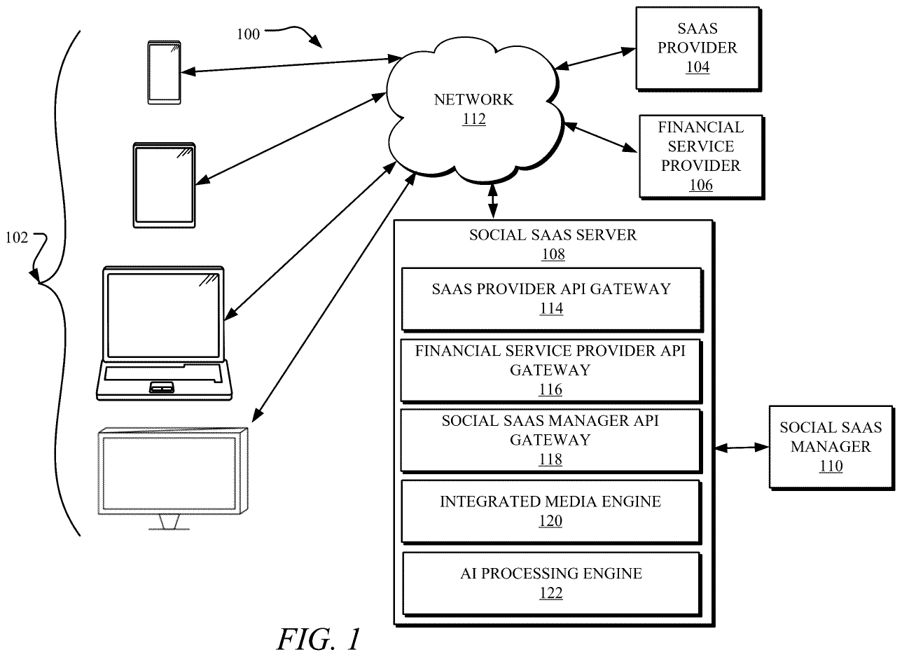

Referring now to FIG. 1, a system 100 is depicted for facilitating social SAAS management. The system 100 includes at least one client device 102, at least one SAAS provider 104, at least one financial service provider 106, a social SAAS server 108, a social SAAS manager 110, and a network 112. In some instances, the social SAAS manager is hosted on the social SAAS server 108. The client device 102 may be a mobile phone, tablet, computer, smart television, or any other computing device associated with a client and/or user. The client device 102 communicates with the SAAS provider 104, the financial service provider 106, and the social SAAS server 108 via the network 112. In some instances, the network 112 is the internet. The network 112 can also utilize dedicated or private communication links (e.g. WAN, MAN, or LAN) that are not necessarily part of the internet. The network 112 uses standard communications technologies and/or protocols.

The client device 102 may be associated with a particular user. Although one client device 102 is depicted, the system 100 may include a plurality of client devices 102. Further, each client device 102 may be associated with one of a plurality of users. A display of the client device 102 allows the user of the client device 102 to access the SAAS provider 104, the financial service provider 106, and the social SAAS manager 110 via the network.

The social SAAS manager 110 manages the core functionality of social SAAS management, data and cost sharing among users, processing client requests and updating user balances while facilitating data communication between connected users. The social SAAS manager 110 ensures that all interactions with the system are secure, efficient, and reliable. The social SAAS server 108 may host an integrated media engine 120 and an AI processing engine 122, which work in conjunction with the social SAAS manager 110 to provide advanced media interaction features.

The social SAAS manager 110 utilizes one or more API gateways including a SAAS provider API gateway 114, a financial service provider API gateway 116, and a social SAAS manager API gateway 118. The API gateways 114, 116, 118 are located on the social SAAS server 108 and can be utilized to authenticate the identity of the user. For example, the social SAAS manager API gateway 118 can be utilized by the client device 102 to interface with the social SAAS manager 110 via the network 112 and the social SAAS server 108. Similarly, the SAAS provider API gateway 114 and the financial service provider API gateway 116 to interface with the SAAS provider 104 and the financial service provider 106, respectively. This provides a seamless user experience for users who access the Social SAAS Manager 110 through a single company's branded website or mobile application.

In some instances, one or more of the API gateways 114, 116, 118 hosted on the social SAAS server 108 can be exposed to third-party sites or software applications, allowing them to integrate the social SAAS manager 110 functionality into their own products. This enables these third-party companies to provide their clients with access to the Social SAAS Manager 110, while allowing decoupled control over the core functionality of the social SAAS manager 110.

The financial service provider API gateway 116 receives authenticated monetary transaction requests from the social SAAS manager 110 when a user initiates and authorizes the transaction from a user interface of the social SAAS manager 110. The social SAAS server 108 forwards these requests to the financial service provider API gateway 116, which then communicates with the financial service provider 106 via the network 112. This communication enables seamless processing of financial payments related to cost-sharing agreements between users.

SAAS provider API gateway 114 enables seamless communication between the social SAAS manager 110 and the one or more SAAS providers 104. The SAAS provider API gateway 114 facilitates the exchange of data between the social SAAS manager 110 and SAAS providers 104, including but not limited to user streaming history, content metadata, content ratings, subscription cost, number of allowable concurrently connected devices, number of households allowed to access the account, etc. This data exchange is important for the system's advanced features; the integrated media engine 120 uses this data to manage synchronized playback and render content overlays, while the AI processing engine 122 uses the data to identify content for applying transformative effects, such as personalized filters or AI-generated casting.

The social SAAS server 108 hosts an integrated media engine 120, a backend component responsible for managing sessions and synchronizing playback commands, which works in concert with the client-side Integrated media player 234 that handles the final rendering and compositing on the user's device.

The data transmitted from the social SAAS manager 110 to the SAAS provider API gateway 114 and subsequently to the SAAS providers 104 includes but is not limited to which devices the user has selected to access their account and user content ratings if rated through the social SAAS manager 110 application. Additionally, when a new user signs up for service, the system sends personal information about the user, including their preferred payment method, their preferred username, and a strong generated password.

The SAAS provider API gateway 114 communicates with external SAAS providers 104 via the network 112, facilitating the integration of various third-party SAAS services into the social SAAS manager 110. This integration enables users to not only share their streaming history, preferences, and access control settings, but also to utilize the system's advanced media features (e.g. watch parties, companion streams) across a multitude of otherwise disparate services, creating a unique social experience.

To ensure robust, long-term operation in a dynamic third-party environment, the system may incorporate a modular API adapter layer for each provider, allowing for updates to be made to a specific provider's adapter without affecting the core logic of the social SAAS manager 110. Furthermore, a monitoring service could periodically validate API endpoints to proactively detect changes, deprecations, or failures, thereby enhancing the system's reliability.

The present disclosure focuses on using this infrastructure to enhance the user experience through social sharing and access control features.

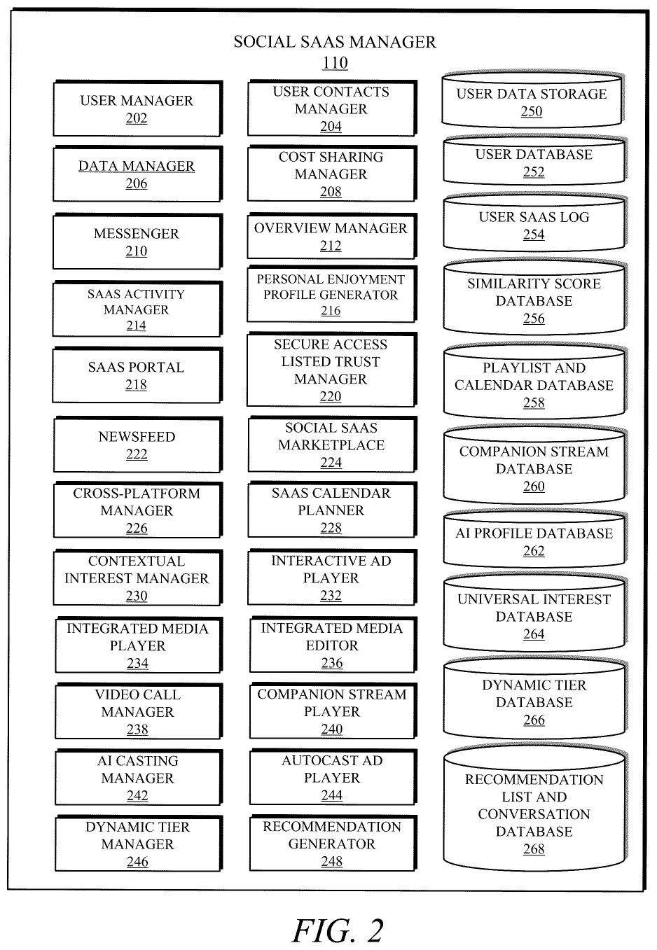

FIG. 2 depicts a block diagram of the social SAAS manager 110. The social SAAS manager 110 may include a plurality of interconnected components that work in concert to provide a comprehensive platform for user and data management, secure financial transactions, content discovery and planning, social interaction, and advanced interactive media processing. The social SAAS manager 110 depicted in FIG. 2 includes a user manager 202, a user contacts manager 204, a data manager 206, a cost sharing manager 208, a messenger 210, an overview manager 212, a SAAS activity manager 214, a personal enjoyment profile generator 216, a SAAS portal 218, a secure access listed trust manager 220, a newsfeed 222, a social SAAS marketplace 224, a cross-platform manager 226, a SAAS calendar planner 228, a contextual interest manager 230, an interactive ad player 232, an integrated media player 234, an integrated media editor 236, a video call manager 238 238, a companion stream player 240, an AI casting manager 242, an autocast ad player 244, a dynamic tier manager 246, and a recommendation generator 248. The social SAAS manager 110 further includes a plurality of databases including, but not limited to a user data storage 250, a user database 252, a user SAAS log 254, a Similarity scores database 256, a playlist and calendar database 258, a companion stream database 260, an AI profile database 262, a universal interest database 264, a dynamic tier database 266, and a recommendation list and conversation database 268. The manager 110 may provide persistent storage for all user-generated data, system configurations, and activity logs, ensuring the integrity and availability of information across the platform's features.

In some instances, one or more of these components may be combined into a single component. The components may be interchangeable and different components may be included which allow the social SAAS manager 110 to function as described herein.

The user manager 202 enables controlled access to shared resources while promoting a unique social experience for users. The user manager 202 may facilitate the entire user lifecycle, beginning with user registration, where new users create an account by providing requisite information, including their preferred username and password manager preferences. User-specific data, including personal information, security settings, and profile configurations, may be stored and managed within the user database 252. The user manager 202 also manages user profiles, allowing users to update their personal information and to control granular access settings related to data sharing and modification.

The user manager 202 facilitates authentication of the user, which is designed to be flexible and accommodate both current and future industry standards. In one example, a user may secure their account with a traditional password, which is stored as a secure access listed trusted hash in the user database 252. In a more modern example, the system utilizes passkey-based authentication (e.g. standards such as FIDO2 and WebAuthn). The systems and methods described herein can be adapted to use any suitable authentication and authorization protocols.

During registration, the user's client device 102 may generate a unique public/private cryptographic key pair. The public key is transmitted to and stored by the user manager 202 in the user database 252, associated with the user's account. The private key remains securely stored on the user's client device 102, protected by the device's own security measures, such as a biometric sensor (e.g., fingerprint or facial recognition).

This architecture may facilitate a process of mutual authentication during login. When a user attempts to log in, the user manager 202 sends a challenge to the client device 102. The user authenticates to their device using a biometric gesture, which unlocks the private key to sign the challenge. The signed challenge is returned to the server, where the user manager 202 uses the stored public key to verify the signature's authenticity. This single action simultaneously verifies the user's identity and the integrity of the device itself.

Upon every successful authentication, regardless of the method used, the user manager 202 captures one or more unique identifiers from the client device 102 and registers it as a recognized device for the user's account in the user database 252. This master list of registered devices serves a dual purpose.

First, it is used for platform-level security; if a login attempt originates from a device not on this list, the user manager 202 can trigger a step-up authentication challenge, such as a multifactor authentication (MFA) prompt, before granting access.

Second, this master device list serves as the available inventory for the secure access listed trust manager 220. When a user wishes to grant a device access to a specific SAAS subscription, the secure access listed trust manager 220 presents the user with this exact list of registered and authenticated devices to choose from. This creates a seamless and secure link between platform-level device trust and subscription-level access control. To provide clarity to the user, the user manager 202 presents this comprehensive list of registered devices within the user's security settings panel. For each device displayed, the user manager 202 communicates with the secure access listed trust manager 220 to retrieve and display which specific SAAS subscriptions that device is currently whitelisted to access, thereby giving the user a single, unified view of their entire device access landscape.

The user contacts manager 204 may enable users to build and manage their social network by establishing connections with other users whose profiles are stored in the user database 252. The user contacts manager 204 provides multiple methods for initiating a connection, each corresponding to a different initial level of trust. For example, a user may perform a search within the user database 252 using various criteria such as a name, address, phone number, or a username from another peer-to-peer application. In another example, the user contacts manager 204 may automatically retrieve contact information from the user's client device 102 to search for existing users in the user database 252. In another example, a user may establish a connection through in-person methods by utilizing a camera on their client device 102 to scan a profile-identifying code (e.g. a barcode or a QR code) displayed on another user's client device 102.

Once a contact is established, the user contacts manager 204 assigns a level of trust and corresponding permissions. The system is architected around the idea that users share valuable digital assets (e.g. SAAS login credentials), with a similar discretion they would use for physical assets (e.g. the keys to their home). The intent is to facilitate sharing among a user's real-world trusted circle, such as family and close friends, to help them collectively get the most value out of their subscriptions. This real-world dynamic is mirrored in the platform's tiered trust model.

Contacts established through a database search function may be online acquaintances or friends-of-friends and may be assigned a low-trust status by default. This designation may permit access to basic features (e.g. viewing shared posts in the newsfeed 222), but may restrict access to sensitive functions. For example, a low-trust contact can be prevented from engaging in financial transactions facilitated by the cost sharing manager 208, or receiving sensitive data (e.g. SAAS login credentials) from the data manager 206.

To engage in sensitive operations, a contact can be elevated to a high-trust status. In some instances, the high-trust status can be defined as a level reserved for those individuals the user knows and trusts in real life. Because the system is designed to formalize these existing relationships verification, methods that prove this real-world connection (e.g. in-person QR code scanning) do not represent an inconvenience. The upgrade to high-trust status may involve an explicit verification process, which can be completed either through the aforementioned in-person methods or by completing a remote multifactor authentication protocol for known individuals who are not physically present. This tiered trust model ensures that while a broad social network can exist on the platform, only verifiably trusted individuals can ever be granted access to a user's most valuable data and financial arrangements. This ensures that only trusted individuals have access to shared resources and sensitive information, safeguarding against potential security risks from unverified or fraudulent user accounts.

Regardless of the initiation method, after the user contacts manager 204 locates and processes a request to connect two users, it facilitates a final, mutual confirmation. The user contacts manager 204 causes an approval window to appear on the client devices 102 of both users, displaying the other user's profile information and requiring each user to grant explicit approval before the connection is finalized and recorded in the user database 252.

The user contacts manager 204 also functions as an integrated component initiated by other components. For example, if a user is operating within the data manager 206 and attempts to share a piece of data with an individual who is not yet an established contact, the data manager 206 will invoke the user contacts manager 204. The user contacts manager 204 will then guide the user through the process of sending a contact request to the intended recipient, ensuring that a formal, permission-based connection is established before any data sharing can proceed.

Furthermore, the user contacts manager 204 acts as a final gateway for consent before data is exchanged between established contacts. When a primary user initiates a data sharing request from the data manager 206 to a high-trust contact, the User contacts manager 204 is responsible for delivering the request notification to the shared user's client device 102. This notification prompts the shared user to review and agree to a mandatory set of terms and conditions presented by the social SAAS manager platform itself.

This window outlines the legal terms and user responsibilities governing the use of the platform as a facilitator for data and cost sharing. The terms are not user-defined but are the platform's own terms of service for this specific function. These terms include a pass-through acknowledgment regarding the terms of the third-party SAAS provider whose subscription is being shared. By accepting, the users affirm that they have independently read, understood, and agree to abide by the terms and conditions of the specific SAAS provider in question. The agreement explicitly states that the social SAAS manager platform is solely an enabling technology for the data and cost sharing, and that any violation of the third-party SAAS provider's terms of service is the sole responsibility of the users involved in the share.

Only after the shared user affirmatively agrees to these platform-specific terms does the user contacts manager 204 signal back to the data manager 206 that the connection is fully authorized, allowing the secure transfer of the selected data to be completed. This ensures that all data exchanges are predicated on explicit, informed consent, and establishes a clear understanding of liability and responsibility among all parties involved.

The data manager 206 provides users with a secure and controlled way to share data with their trusted contacts within the network, while also offering robust password management capabilities. The data manager 206 is architected on a foundation of zero-knowledge, end-to-end encryption, ensuring that only the primary user and any users designated by the primary user can access the unencrypted contents of the data. In one example, each user account is managed by the user manager 202 and is associated with a unique public/private key pair. All sensitive data, (e.g. login credentials) is encrypted with the primary user's public key before being stored in their personal user data storage 250. When a primary user wishes to share an item, their client device 102 retrieves the encrypted data, decrypts is locally using the primary user's private key, re-encrypts it using the intended shared user's public key (which may be retrieved from the user database 252), and only then transmits the newly encrypted data. This ensures the platform servers never have access to unencrypted data, serving only as a secure conduit for encrypted information.

The data manager 206 may function as a password manager. In some instances, the data manager 206 may include tools to aid users in generating strong, unique passwords, and may further manage a user's existing credentials for a plurality of online services. The data manager 206 is data agnostic. In other words, it is capable of securely storing and sharing a wide variety of user data, including but not limited to: text-based secrets (e.g. recipes, software activation codes), media files, and sensitive documents (e.g. legal documents, medical health records).

In one example, a primary user may be presented with an interface to select one or more contacts with whom to share a stored item. In some examples, the primary user may only be able to share the stored item if the one or more contacts are high-trust contacts. For each selected shared user, the primary user can selectively assign permissions, including but not limited to read-only access or full editing rights. The level of permissible rights may depend on the type of data being shared and/or the trust level of the contact. For instance, if login credentials for a SAAS subscription are being shared, granting editing rights may allow a trusted shared user to update the password for that service directly, with the change being securely synchronized back to the primary user's data vault, thus eliminating the need for manual coordination.

In some instances, the data manager 206 may maintain a comprehensive audit trail for every shared data item. For example, the data manager 206 may include a history log, wherein a user can retrieve detailed records of interactions related to that data, which may be stored in the user data storage 250. This history may include a list of previous user contacts who had access to the data, when access was granted and/or revoked, a log of modifications made to the data (e.g. password changes), and/or a detailed history of transactions processed by the cost sharing manager 208 including payment amounts and/or payment dates. This feature provides users with valuable insight into the management of their shared data, aiding in troubleshooting and providing a clear record of activity.

The data manager 206 may also enable a passive discovery and trading post feature. For example, a user can control the visibility of the data items they own, choosing to display certain information (e.g. metadata) about specific items to their contacts. For example, a user can make the existence of their “Streamflix” subscription visible to their contacts without revealing the password. In another example, a user can set a status indicting that they are actively interested in sharing a subscription or trading access for another service. This creates a passive advertisement within their social circle, allowing contacts to initiate a sharing request. This transforms the data sharing model from being solely primary user-initiated to a dynamic marketplace where requests can originate from potential shared users, fostering more efficient use of underutilized subscriptions.

The cost sharing manager 206 may facilitate monetary exchanges between users who have agreed to share the financial burden of a SAAS subscription or other data set. The cost sharing manager 206 can be architected to handle peer-to-peer (P2P) transactions, which typically rely on direct bank-to-bank transfers, and recognizes that these payment methods may be distinct from the credit card-based financial products a user might employ for initial SAAS subscription sign-ups.

To enable these P2P transactions, the system may integrate with one or more third-party financial data aggregation service providers via the financial service provider API gateway 116. The platform is designed with a strict security protocol that ensures it never stores or has access to a user's sensitive financial login credentials or full account numbers. In one example, when a user wishes to link a financial account for cost-sharing, the cost sharing manager 208 initiates a secure, tokenized authentication exchange. A secure portal may be presented to the user via a display of a user device 102, hosted by the financial data aggregation service, where the user can authenticate directly with their own financial institution. Upon successful authentication, the aggregation service provides the social SAAS manager platform with a secure access token corresponding to the user's account, along with only non-sensitive identifiers, such as the institution's name and the last four digits of the account number. This allows the user to see and select the correct account within the platform's user interface, while the platform itself only stores the secure token to authorize future transactions.

When executing a transaction between a primary user and a shared user, the cost sharing manager 208 retrieves the list of linked payment methods, represented by these secure tokens, from each user's profile in the user database 252. It may first identify the primary user's preferred payment services in their designated hierarchy and then searches the shared user's linked services for a matching provider. If a common financial service is found, the cost sharing manager 208 uses the respective user tokens to construct and send a secure, authenticated peer-to-peer money exchange request to the corresponding financial service provider 106. If no common provider is found, the cost sharing manager 208 invokes the messenger 210 to notify both users of the incompatibility, prompting them to link a new, compatible payment method to facilitate the transaction.

The messenger 210 may serve as the central communication hub for the platform. It enables direct, secure user-to-user communication for negotiating sharing terms and also handles all system-generated notifications. These include alerts for financial transaction status from the cost sharing manager 208, updates from the software authors, and social notifications, such as when a contact posts to the newsfeed 222 or lists an available subscription seat on the social SAAS marketplace 224.

The overview manager 212 provides a comprehensive and dynamically adapting summary display of various forms of user data, including personal account data, contact data, and public network data. One function of the overview manager 212 includes acting as a context-aware information hub, querying other components and databases to construct and present a view that is specifically tailored to the user's current task or focus within the application.

For instance, when a user navigates to a screen focused on their financial arrangements, the overview manager 212 may query the data manager 206 and the cost sharing manager 208. It then constructs and displays a summary of the user's shared data, active access grants, and associated users. This view may include details such as which SAAS credentials are being shared, the identities and trust levels of the shared users, and the established payment terms for each shared item.

However, when the user's context shifts, the overview manager's 212 output adapts accordingly. If the user accesses a screen to view a contact's profile, the overview manager 212 might query the similarity scores database 256 to generate a side-by-side comparison of content ratings between the user and that specific contact. Alternatively, if the user navigates to a SAAS portal for a specific provider, the overview manager 212 could query the user SAAS log 254 and the similarity scores database 256 to display an overview of what the user's contacts have recently watched and highly rated on that particular service, providing immediate, socially-vetted recommendations.

In addition to these examples, the overview manager 212 can compile and present a wide range of other useful overviews by retrieving and processing data from across the system. In one example, the overview manager 212 may query the personal enjoyment profile generator 216 to present a summary of content the user has not yet seen but which has a high predicted personal enjoyment profile rating score for them. In another example, the overview manager 212 may query the user manager 202 to identify SAAS platforms the user is not subscribed to, and then cross-reference that with data from the similarity scores database 256 to highlight highly-rated content on those services from the user's high-trust contacts. Other possible overviews include, but are not limited to, lists of recommended services (e.g. services found in the marketplace 224) based on user preferences, displays of trending topics, popular content across the network, and more.

By dynamically adapting its presentation based on the current screen being accessed and the data available from the system, the overview manager 212 enables users to efficiently navigate and manage their digital lives. This flexibility ensures that users can quickly access the most relevant information and make informed decisions about sharing, purchasing, and consuming content, significantly enhancing the usability and intelligence of the platform.

The SASS activity manager 214 may facilitate the creation of a comprehensive, centralized record of a user's engagement across all their linked SAAS subscriptions. The SASS activity manager 214 may function as a central aggregator, collecting activity data and populating the single, unified user SAAS log 254 for the user. The system employed a multi-faceted approach to capture activity, ensuring a complete and accurate history for each user.

The primary and foundational method of activity capture occurs directly within the social SAAS manager platform. For any SAAS subscription that a user has linked to their account, the system logs all user interactions that take place within the corresponding SAAS portal 218. This includes, but is not limited to, recording every instance a user initiates playback by clicking on a deep link. This platform-side tracking ensures that, at a minimum, all user engagement that originates from within the social SAAS manager is captured in real-time.

As a secondary and complementary method, for these same linked accounts, the system can synchronize activity that occurs on the SAAS provider's native applications. This is achieved via the SAAS provider API gateway 114. This synchronization can be implemented in one of two ways: the social SAAS server 108 can periodically poll the provider's server to retrieve a list of recent user activity, or the provider's server can be configured to push activity data to the social SAAS server 108 after each relevant event occurs. In either case, when new activity data is received from a provider, the SAAS activity manager 214 performs a reconciliation process. It compares the incoming activity records against the events already present in the user SAAS log 254 to identify and append only the new, unique activity, thereby preventing duplicate entries and ensuring the user's log on the platform accurately mirrors their complete history.

A useful function of the SAAS activity manager 214 is to correctly attribute activity to the appropriate user, especially within a shared subscription that may have multiple users. When an activity event is received from a provider's server, the SAAS activity manager 214 employs a hierarchical logic to assign it. First, it checks if the incoming data includes a SAAS-level profile name (e.g., “Jane's Profile”). If so, the SAAS activity manager 214 queries the user database 252 to identify which user on the social SAAS manager platform has associated that specific profile name with their account for that subscription, and the activity is added to that user's log.

If a profile name is not available, the SAAS activity manager 214 uses the device identifier included in the activity data as the basis for attribution. It queries the records managed by the secure access listed trust manager 220 to identify all users on the platform who have whitelisted that specific device for that specific SAAS subscription. The activity item is then added to the user SAAS log 254 for each of those users. For example, if a movie is watched on a living room TV that both a husband and wife have whitelisted for a given service, the movie will appear in the activity log for both of their individual software accounts.

This architecture provides users with granular control over their own activity log. In the case where an activity appears in multiple users' logs from a shared device, each user has independent control over that entry in their own view. A user may choose to delete an activity entry from their personal log—for instance, to remove a show that someone else using a shared device has streamed, but not the user—and this action will not affect the log of any other user who also has access to that device. This ensures the user SAAS log 254 functions as a personalized history for each individual, not merely a raw feed of device activity.

The SAAS activity manager 214 then periodically or in real-time collects this activity data from all individual SAAS portals 218 and consolidates it into the single, unified user SAAS log 254. This log provides an independent and perpetual record of the user's interactions, ensuring a complete history is preserved even if a provider only maintains a short-term activity log.

This aggregated activity log is where the SAAS activity manager 214 works in tandem with the personal enjoyment profile generator 216 to create a seamless content consumption and rating lifecycle. Before a user engages with a piece of content, it may be displayed with a predicted personal enjoyment profile rating, calculated by the personal enjoyment profile generator 216, assuming the minimum data thresholds have been met. Once the user engages with the content (e.g., watches the movie), the SAAS activity manager 214 records this event in the user SAAS log 254.

At this post-consumption, pre-rating stage, the content item appears in the user's activity log. The user interface, managed by the overview manager 212, will still display the original personal enjoyment profile rating for that item, but now with a distinct visual indicator signifying that the content has been consumed but is awaiting the user's personal rating. This serves as a prompt for the user to provide their feedback.

Once the user submits their own rating for the content, this new data point triggers several actions. The user's rating replaces the personal enjoyment profile rating for that item in their personal activity view, and the item is now considered part of their personal enjoyment profile. This user-provided rating is then passed to the personal enjoyment profile generator 216, which uses it as a new input to adjust the Similarity scores of other users in the similarity scores database 256 and to refine future personal enjoyment profile rating calculations for other content across the platform.

The activity logged by the SAAS activity manager 214 can be displayed to the user in various ways, such as a unified, chronological feed of all their online activities. Furthermore, users retain complete control over the privacy of this aggregated log. Through their security settings, they can customize what information, if any, is shared with their contacts via the newsfeed 222, allowing them to maintain control over their personal online activity while still benefiting from the platform's social and personalization features.

The personal enjoyment profile generator 216 is the analytical engine responsible for quantifying taste similarity between users and generating personalized content recommendations. It operates in direct concert with the similarity scores database 256, which stores two primary types of data: all user-provided ratings for any content or item, and the calculated similarity scores. A user's collection of ratings forms their personal enjoyment profile, a universal taste repository. A similarity score is the calculated, evolving metric that quantifies how closely one user's personal enjoyment profile aligns with another's.

The process is triggered when a user provides a new rating for a piece of content, often prompted after the SAAS activity manager 214 logs that the content has been consumed. This new rating is stored in the similarity scores database 256 and initiates a recursive adjustment of the similarity scores. The personal enjoyment profile generator 216 retrieves the new rating and identifies all other users on the network who have also rated that same content. For each of these other users, the personal enjoyment profile generator 216 calculates the absolute difference between their rating and the main user's rating.

The calculation of similarity scores may involve an exemplary methodology for adjusting the scores based on this difference. In one example, the personal enjoyment profile generator 216 applies a tiered adjustment function. For example, if another user has rated the same content item similarly (e.g., within one point on a ten-point scale), they receive a positive increment to their similarity score relative to the main user. If their rating differs moderately (e.g., by two points), no adjustment is made. If their rating is significantly different (e.g., by three or more points), their similarity score is decreased. This scoring system is intended to provide a meaningful and continuously refined measure of taste alignment. While a specific tiered function is described, it is contemplated that alternate techniques, such as a linear or nonlinear adjustment function where the adjustment magnitude is proportional to the rating difference, may be employed to achieve the same objective. The updated similarity scores for all affected users are then written back to the similarity scores database 256.

One output of the personal enjoyment profile generator 216 may be the personal enjoyment profile rating itself-a predictive rating for content the user has not yet experienced. To calculate a personal enjoyment profile rating for a given user and a specific piece of content, the personal enjoyment profile generator 216 retrieves all available ratings for that content from the similarity scores database 256. It also retrieves the corresponding Similarity score for each of those raters relative to the main user. The personal enjoyment profile generator 216 then calculates a weighted average of these ratings, where the weight applied to each rating is a direct function of the rater's similarity score. This ensures that users with high similarity scores (i.e., more similar tastes) have a proportionally greater influence on the final estimated rating.

In a more advanced example, the algorithm can apply different group weights to distinguish between different cohorts of raters, such as giving a higher weight to ratings from a user's high-trust contacts or user-selected professional critics in the platform compared to the general network. This allows for even finer-grained personalization. To ensure statistical reliability, the personal enjoyment profile generator 216 may also enforce data thresholds, requiring a user to have rated a minimum quantity of items before personal enjoyment profile ratings are generated for them, and for content to have a minimum number of public ratings before a personal enjoyment profile rating is calculated.

In a further example, the personal enjoyment profile rating score displayed in the user interface is an interactive element. When a user clicks or taps on a personal enjoyment profile rating score associated with a piece of content, the personal enjoyment profile generator 216 generates a detailed statistical breakdown view. This view provides transparency into the factors that contributed to the calculated rating. It queries the similarity scores database 256 to display a list of the user's specific contacts who have rated the content, showing each contact's name and their individual rating. The view also presents an aggregated average rating from the network at large. In some examples, the personal enjoyment profile generator 216 may also query an external third-party API to retrieve and display ratings from professional critics (e.g., from services like Rotten Tomatoes or Metacritic). This view can provide a transparent look into the personal enjoyment profile rating calculation itself, displaying a list of the individual user ratings and the corresponding Similarity scores that were given the most weight in the weighted average, allowing the user to understand precisely whose opinions most heavily influenced their personalized recommendation.

This methodology is illustrated by considering two users looking at the same new movie. One user, whose tastes align closely with a group of friends who loved the movie, might see a personal enjoyment profile rating of 8.5. Another user, whose trusted contacts disliked the movie, might see a personal enjoyment profile rating of 4.2 for the exact same film. This discrepancy demonstrates the power of the personal enjoyment profile generator 216 to move beyond generic average ratings and provide a truly personalized prediction based on the collective, weighted opinions of those with whom the user shares a similar taste profile.

The present disclosure describes the specific, multi-layered computational method for generating these predictive ratings that is independent of the platform on which it is implemented. The method provides a unique combination of two algorithmic components. The first is a method for continuously and recursively adjusting the Similarity Score between two users each time a new, commonly-rated piece of content is logged, creating a closed-loop feedback system that dynamically adapts to a user's evolving tastes. The second is the subsequent method for calculating the personal enjoyment profile rating score by applying a differentiated, multi-group weighting system that assigns a higher weight to ratings from a user's trusted contacts compared to the general network. This specific algorithmic process-combining a recursive Similarity score adjustment with a socially-tiered weighting system—is a non-obvious method for generating highly personalized and accurate content recommendations that can be practiced as a standalone recommendation engine.

The SAAS portal 218 provides a dedicated, multifaceted interface for each SAAS provider on the platform, functioning as both a public-facing promotional space and a private, personalized hub for subscribers. In its public capacity, accessible to all users on the network regardless of their subscription status, the portal serves as a dynamic business page. Here, a SAAS provider 104 can showcase its brand, communicate with the network at large, and display promotional content—such as trailers, free episodes, or other teaser material—designed to attract potential customers and whet their appetite for the service.

The portal's functionality transforms once a user links their subscription to their social SAAS manager account. This linking process, which leverages the platform's password management capabilities and industry-standard authorization protocols, unlocks a personalized, subscriber-only view. In this view, the portal becomes the primary interface through which the user interacts with their full library of content from that specific SAAS provider. The system maintains the user's direct and independent relationship with each provider, avoiding the vendor lock-in typical of conventional streaming gateway services.

The linking process is initiated when a user, from within the social SAAS manager 110 interface, selects a provider and clicks a dedicated “Link Account” button. In one example, this action triggers the SAAS portal 218 to initiate an OAuth 2.0 Authorization Code Grant flow. The SAAS portal 218 redirects the user to the SAAS provider's authorization endpoint, opening a secure browser window hosted on the provider's domain. To minimize user friction, the system leverages the credentials stored in the data manager 206 to automatically populate the username and password fields on the provider's login page. In some examples, the data manager 206 may even programmatically trigger the confirmation button on the user's behalf.

Once the user authenticates and grants consent on the provider's site, the provider's server may redirect the user back to a pre-registered endpoint on the social SAAS manager platform, providing a single-use authorization code. The platform's backend server then exchanges this authorization code, along with its own client credentials, for an access token and a refresh token from the provider's token endpoint. In examples also using OpenID Connect (OIDC), an ID Token is returned as well, which the platform uses to cryptographically verify the user's identity and securely map their SAAS account to their platform profile in the user database 252. The retrieved access token, which grants permission to access the user's data, is then securely stored and associated with that user's profile, enabling all future API communications.

With an active access token, the SAAS portal 218 can make authenticated API calls to the SAAS provider's resource server via the SAAS provider API gateway 114. The portal's user interface is constructed from pre-defined templates containing placeholders for elements like content posters, carousel layouts, hero images, and descriptive text. The SAAS portal 218 populates these templates by parsing the structured data, typically in JSON or XML format, returned from the provider's API. This allows for a standardized “plug-and-play” approach, where the platform can display a rich, interactive interface for any partnered provider by simply mapping the fields from the API response (e.g., content title, poster_image_url, deep_link_uri) to the corresponding placeholders in the UI template. This mirrors the data delivery mechanisms used by existing streaming services to manage channel content.

The SAAS portal 218 serves as the central point of action for a user's engagement with a service. When a user clicks a “Play” button associated with a piece of content, the SAAS portal 218 first sends a verification request to the secure access listed trust manager 220 to confirm the current device is on the approved whitelist for that subscription. Upon successful verification, the SAAS portal 218 executes the deep link to initiate playback and simultaneously notifies the SAAS activity manager 214 to log the event. If the user clicks “Add to Playlist,” the SAAS portal 218 sends the content's metadata and deep link to the cross-platform manager 226. If they click “Start Watch Party,” it invokes the video call manager 238, passing the content identifiers. The portal also enhances discovery by displaying the user's personalized personal enjoyment profile rating score for content, a value that is calculated by and retrieved from the personal enjoyment profile generator 216, thus integrating social recommendations directly into the browsing experience.

The secure access listed trust manager 220 provides a user-centric system for managing access to SAAS subscriptions, moving beyond the conventional, often opaque and restrictive, device management rules imposed by service providers. The secure access listed trust manager 220 empowers the user to explicitly define and enforce a security perimeter for each of their subscriptions, rather than passively accepting the provider's terms. The secure access listed trust manager 220 may include functionality predicated on the master list of a user's authenticated devices, which is established and maintained by the user manager 202 and stored in the user database 252.

When a user wishes to manage access for a specific SAAS subscription, the secure access listed trust manager 220 presents them with an interface displaying two key pieces of information. First, it retrieves the terms of the subscription—specifically, the number of devices allowed or concurrent device streams allowed—from the SAAS provider 104 via the SAAS provider API gateway 114. Second, it presents the user with their personal master list of all devices they have previously authenticated to the platform (e.g., “Living Room TV,” “Jane's iPhone,” “Office Laptop”). The user can then assign specific devices from this list to the available slots for that subscription, creating a curated whitelist.

This user-defined whitelist is transmitted via the SAAS provider API gateway 114 back to the partnered SAAS provider 104. The provider, as part of their integration with the platform, agrees to ingest this list and configure their own authentication systems to enforce it as the single source of truth for device access. This means any login attempt from a device not on the user's explicit whitelist will be blocked by the provider's servers. This represents a fundamental shift from a provider-centric model (where they attempt to guess a user's legitimate devices based on IP addresses or other heuristics) to a user-driven, deterministic security model.

Furthermore, the secure access listed trust manager 220 may enable Device-Specific Multifactor Authentication (MFA). In a scenario where a primary user shares a subscription with a high-trust contact, that contact first adds their own device (e.g., their personal tablet) to the platform's ecosystem via the standard user manager 202 authentication process. The primary user can then use the secure access listed trust manager 220 to assign the contact's newly registered tablet to an available slot for the shared subscription. The key innovation is that the shared user can then, within their own security settings, associate their own secondary contact information (e.g., their personal phone number) specifically with that tablet for that single subscription. Consequently, when a periodic MFA challenge is initiated for that tablet, the authentication code is sent directly to the shared user, not the primary user. This elegant solution removes a significant point of social and logistical friction, as it eliminates the need for the shared user to constantly contact the primary user to obtain login codes.

The secure access listed trust manager 220 may be integrated with the platform's other components. Before the SAAS portal 218 initiates playback of any content, it first sends a verification request to the secure access listed trust manager 220 to confirm that the user's current device is on the approved whitelist for that specific subscription. If it is not, playback is prevented. Similarly, when a user offers an “available seat” on the social SAAS marketplace 224, the acceptance workflow requires the primary user to use the secure access listed trust manager 220 to formally whitelist the shared user's device as a final step before the cost-sharing arrangement managed by the cost sharing manager 208 can be activated.

The newsfeed 222 functions as the primary social hub of the platform, presenting a user with a dynamic, aggregated feed of relevant activities and updates from their network of contacts. The newsfeed 222 does not merely a feed of user-generated posts; rather, it is a sophisticated presentation layer that automatically compiles and displays actionable information generated by other core components of the system, all subject to the granular privacy settings established by each user.

The primary mechanism for sharing an opinion about a specific piece of content is user-initiated. After a user consumes content, which is logged by the SAAS activity manager 214 and appears in their personal enjoyment profile, the user can choose to create a newsfeed post about it. From their personal enjoyment profile interface, they can select a “Post to Newsfeed” option associated with the content. This action opens a composition window where the user can add their personal comments and attach their rating, which is managed by the personal enjoyment profile generator 216. This ensures that personal reviews and opinions are shared explicitly, not automatically. While a user's full activity log may be privately viewable by their contacts (subject to their privacy settings), the newsfeed is reserved for these more intentional posts.

To further stimulate discussion, the newsfeed 222 can generate system-level “conversation starter” posts. By analyzing the aggregated, anonymized data in the user SAAS log 254, the newsfeed 222 can identify content that is trending within a user's social circle and create a post such as, “7 of your friends have recently watched ‘Galaxy Voyagers IV’. Want to check it out too?” This encourages engagement without revealing any single user's private activity. In one example of prioritized content delivery, when a user does create a post about ‘Galaxy Voyagers IV’, the Newsfeed 222 can intelligently boost the visibility of that post in the feeds of those specific friends who the system knows have also watched it, making the conversation more timely and relevant.

The newsfeed 222 also serves as a launchpad for social events. A user can create a post to initiate a watch party, managed by the Video call manager 238. This can be an impromptu invitation, such as “I'm watching ‘Galaxy Voyagers IV’ right now, join me!”, which would contain an interactive element to immediately join the in-progress session. Alternatively, it can be a scheduled event, like “Planning to watch ‘Galaxy Voyagers IV’ at 7:30 PM tonight.” When a contact interacts with this scheduled post, it can invoke the SAAS calendar planner, which would then offer to add the event to the contact's schedule and intelligently shuffle their planned evening entertainment to accommodate the shared event.

The newsfeed 222 may be integrated with the Social SAAS marketplace 224. When a user creates a listing in the marketplace—for instance, to offer unused device slots on their SAAS subscription as identified by the secure access listed trust manager 220—they are presented with a choice. They can select “Post to Marketplace only,” which may trigger a generalized, anonymized notification in their contacts' newsfeeds (e.g., “A friend has a subscription offer available in the Marketplace”). Alternatively, they can select “Post to Marketplace and Newsfeed,” which creates a direct, attributed post (“Jane Doe is looking to share her Disney+ subscription”). This gives users granular control over the privacy and visibility of their collaborative consumption offers, seamlessly integrating the platform's financial and social ecosystems.

The interactivity of the newsfeed posts is a useful aspect of the present disclosure. Each item in the feed is not a static piece of text but an interactive object containing rich metadata and deep links. When a user sees a post about a movie their contact watched, that post will contain a deep link to the content, provided by the SAAS portal 218. The user can click a “Play” button directly on the newsfeed post to initiate immediate playback, an action that would trigger the secure access listed trust manager 220 to verify the user's device is whitelisted for that service.

Alternatively, the user can choose to act on the information for future consumption. The newsfeed post can contain an “Add to Watchlist” and/or “Add to Playlist” button, which, when clicked, sends a command and the relevant content metadata directly to the cross-platform manager 226, adding the item to the user's unified playlist. This transforms a passive social update into a direct, frictionless action for content curation.

The entire operation of the newsfeed 222 may be governed by the user's privacy settings, which can configured within the user manager 202. A user has complete control over what types of events, if any, are shared with their network. Furthermore, they can define the audience for these posts, for example, restricting the visibility of all their activity to only their high-trust contacts, ensuring that their personal data is shared only with their intended audience.

The social SAAS marketplace 224 functions as a centralized and dynamic environment for users to discover, evaluate, subscribe to, and collaboratively share SAAS provider services. It serves as an interactive catalog that is deeply integrated with the platform's social, security, and financial components, creating a comprehensive ecosystem for the entire subscription lifecycle.

One function of the social SAAS marketplace 224 is discovery. It presents users with a browsable and filterable catalog of SAAS providers, each represented by their respective SAAS portal 218. This discovery process is enhanced by data-driven, social recommendations. For instance, the marketplace can query the personal enjoyment profile generator 216 to highlight services that are highly rated by users with similar taste profiles, or it can query the user SAAS log 254 to display services that are currently trending among a user's high-trust contacts. This transforms the discovery process from a simple directory into a socially-vetted recommendation engine.

Another function of the social SAAS marketplace 224 is to facilitate a “single-click” registration process for new subscriptions, which prioritizes user security and minimizes friction. When a user decides to subscribe to a new service from the marketplace, the social SAAS marketplace 224 initiates an automated registration workflow. Upon the user clicking the “Subscribe” button, the social SAAS marketplace 224 opens a secure browser window or an in-app webview directed to the SAAS provider's specific registration endpoint URL.

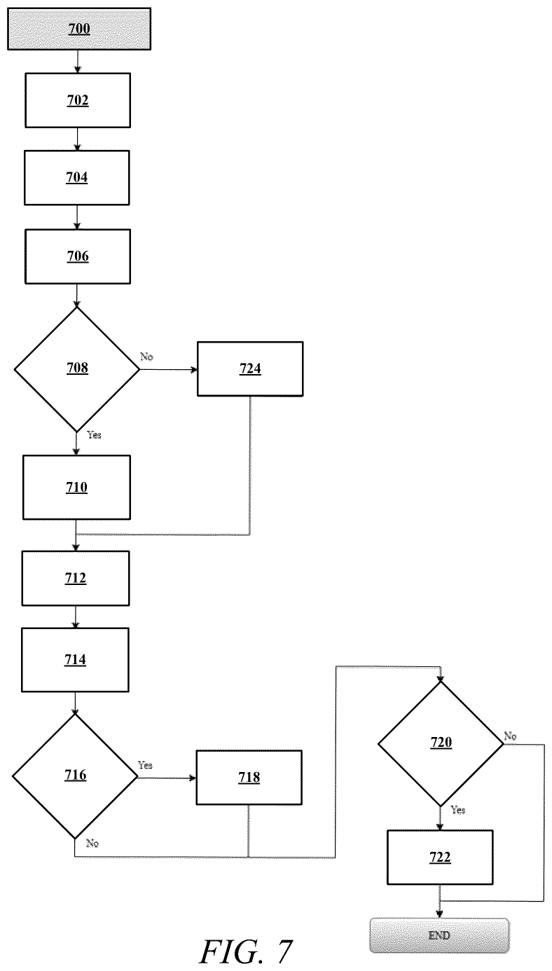

Within this secure window, the social SAAS marketplace 224 programmatically autofills the registration form fields with the user's verified personal information (e.g., name, email address) from the user database 252. It invokes the data manager 206 to generate a cryptographically strong and unique password, which is then injected into the password field. For payment, the platform does not store or transmit raw credit card information. Instead, it retrieves the user's preference for a linked digital wallet service (e.g., Apple Pay, Google Wallet) and selects that payment method within the provider's form. As outlined in the process of FIG. 7, if the data manager 206 determines that any information is missing from the user's profile, it will prompt the user to add it before proceeding. The user is then presented with the fully populated form within the secure window for a final review. Upon the user's final confirmation click, the form is submitted directly to the SAAS provider's server, completing the registration. The newly generated credentials are then automatically saved by the data manager 206, and a corresponding SAAS portal 218 is instantiated and, optionally, linked to the user's account.

Another function of the marketplace is its enablement of collaborative consumption. The social SAAS marketplace 224 provides a user-to-user marketplace for sharing underutilized subscription assets. A user can identify that their subscription has unused capacity (e.g., by viewing their device slot usage in the secure access listed trust manager 220) and create a listing in the marketplace to offer these “available seats” to their contacts. When a contact accepts such an offer, the marketplace 224 initiates a multi-step fulfillment workflow. First, it prompts the primary user to use the secure access listed trust manager 220 to formally whitelist the shared user's device for that subscription. Second, it invokes the cost sharing manager 208 to guide both users through setting up a recurring, automated payment arrangement.

In another example, a user can proactively seek partners before purchasing a new subscription. They can post an offer within the marketplace stating their interest in a new service and their willingness to split the cost. If another user accepts this offer, the marketplace 224 first guides them through the process of establishing a high-trust relationship via the User contacts manager 204 if one does not already exist. Once trust is established, the marketplace 224 proceeds with the single-click registration process, but immediately invokes the cost sharing manager 208 to configure the cost-splitting arrangement from the moment of subscription. This transforms a solitary purchase into a collaborative, financially efficient action from its inception.

The cross-platform manager 226 provides a solution that addresses both the technical challenge of content fragmentation across disparate SAAS subscriptions and the common user experience problem of “decision fatigue.” It is designed to eliminate the disruptive, often lengthy search for what to watch next that occurs when a program ends, a problem that is compounded when a user searches through multiple, siloed applications to find suitable content. One function of the cross-platform manager 226 is to enable users to curate a single, unified, and automated entertainment experience by creating playlists that seamlessly combine content from multiple, distinct SAAS providers.

A user can manually build a playlist by navigating through the various SAAS portals 218 linked to their account. When they find a desired piece of content—be it a movie, a TV show episode, or a music album—they can select an “Add to Playlist” option. This action invokes the Cross-platform manager 226, which then stores the essential metadata for that content item, including its title, description, poster image, and, most importantly, its unique deep link URI. This sequence of content items is persistently stored in the user's account within the playlist and calendar database 258.

The cross-platform manager 2266 abstracts the underlying source of the content, allowing for automated, sequential playback managed by the Integrated media player 234. When a playlist is active, upon the conclusion of one piece of content, the Integrated media player 234 communicates with the cross-platform manager 226 to retrieve the deep link for the next item in the sequence. It then programmatically executes this deep link to initiate playback of the next item, even if it originates from a different SAAS provider than the previous one. This eliminates the need for users to manually search for and switch between different applications, thereby reducing decision fatigue and creating a continuous, lean-back viewing experience.

In another example, the playlist can be populated automatically. A user can define rules, such as “add the next episode from my watchlist” or “add a random recommended movie.” The cross-platform manager 226 can also interface with the personal enjoyment profile generator 216 to automatically add content with a high predicted personal enjoyment profile rating score to fill empty time slots, further enhancing personalized content discovery.

Furthermore, the cross-platform manager 226 interacts with the contextual interest manager 230. When the contextual interest manager 230 identifies that a piece of content a user is tracking is set to be released, it sends a notification to the SAAS calendar planner 228. The SAAS calendar planner 228 then automatically populates the user's calendar with that content on the specific release date, ensuring the user never misses a premiere. The cross-platform manager 226 may also actively monitor for content availability. It may notify a user when a movie or show on their “maybe” list and/or watchlist becomes available on one of their existing, linked subscriptions, thereby maximizing the value of their current services. It also can notify the user when the content becomes available for rent or as part of a SAAS service to which the user is not subscribed. In such instances, it notifies the user of these new availability options, creating a potential sales or new subscription opportunity for the respective SAAS provider.

The SAAS calendar planner 228 is an intelligent organizational tool that integrates the playlists managed by the cross-platform manager 226 into a comprehensive daily, weekly, or monthly schedule, providing users with a holistic view of their time. It retrieves playlist and event data from the playlist and calendar database 258 and presents it in an interactive timeline interface.

The SAAS calendar planner 228 can operate with varying levels of autonomy, from a simple manual scheduler to a proactive AI agent. A user can manually arrange their content consumption around personal events like “Work” or “Dinner.” Alternatively, they can enable an AI agent function within the SAAS calendar planner 228, which intelligently paces out content consumption based on the user's historical activity patterns retrieved from the user SAAS log 254. For example, it may learn that a user streams more on weekends and automatically schedule more content accordingly.

A key aspect of this SAAS calendar planner 228 is its integration into the platform's decoupled, second-screen viewing experience. While a user is watching content on a primary device, such as a TV running the companion application, they can simultaneously use the primary management application on a secondary device, like their mobile phone. From their phone, they can interact directly with the SAAS calendar planner 228 to adjust their schedule for the rest of the evening without interrupting playback on the TV. For instance, if a user accepts a spontaneous watch party invitation received via the newsfeed 222, the SAAS calendar planner 228 on their phone will automatically offer to reschedule the rest of their planned playlist for that evening, providing a seamless and intelligent planning experience that adapts in real-time to social opportunities.

The interactive ad player 232 and the contextual interest manager 230 work in concert to bridge the gap between initial content discovery, often through advertising, and a user's long-term consumption planning. The Interactive ad player 232 is designed to augment standard ad creatives with a non-destructive, interactive overlay, bridging the gap between passive advertising and direct user action. The interactive ad player 232 allows advertisers to use their existing, standard ad assets (e.g., image files, video files) without modification, as the interactivity is managed and rendered by the platform itself. This is a significant advantage for advertisers and/or SAAS providers, who can opt-in to this feature without incurring additional creative production costs.

The technical example of the overlay adapts to the ad's format and placement within the platform. For advertisements that appear in a card-like format within a user's scrollable newsfeed, the interactive ad player 232 renders the standard image or video creative provided by the advertiser. It then renders a separate, interactive user interface (UI) element, such as a “maybe” button, as an overlay positioned on top of the ad creative. This UI element is composed of a visual representation (the button itself) and an associated event listener that detects user interaction, such as a click or a tap. Upon detecting the interaction, the event listener triggers a pre-defined function or script responsible for retrieving the ad's associated metadata and passing it to the contextual interest manager 230. The advertiser does not embed this button into their asset; they simply provide the standard creative and, separately, a metadata package to the platform's ad server. This package may contain an entity type (e.g. media, physical location, commercial good) and/or the content identifiers (e.g., title, unique content ID, SAAS provider name).

In some instances, video advertisements may be played before, during, or after content via the integrated media player 234. The system may leverage the player's 234 inherent multi-layer rendering capabilities in these scenarios. For example, the original creative ad asset (the video) may be played on a primary video track. Simultaneously, the interactive ad player 232 may instruct the media player to render a secondary, transparent video track as an overlay. This overlay track may include the animated and/or static “maybe” button. The overlay track may be synchronized to appear at a specific time during the ad's playback, as defined by the advertiser.

Regardless of the format, when a user clicks or taps this interactive button, the interactive ad player 232 may capture the user action. It then retrieves the full metadata package associated with that specific ad creative from the platform's ad server. This complete package of information may contain unique content identifiers and/or contextual trigger definitions. The package may be passed to the contextual interest manager 230. The contextual interest manager 230 may use this data to create a new, interest object which may be stored in the universal interest database 264, associating the user's latent interest with the entity. This interaction may trigger a feedback loop to the platform's ad delivery engine. Upon the creation of the interest object, the system may create a frequency suppression rule for that specific advertisement. This may prevent and/or reduce subsequent impressions of the same ad to the user, shifting the advertising utility from a repeated impression model such as Cost Per Mille (CPM) to a Cost Per Action (CPA) model where the ad has successfully completed its job of registering interest. Consequently, this CPA model may function as a complimentary targeted advertising method that fosters more meaningful interaction with potential customers by synchronizing outreach with confirmed user intent, thereby establishing a separate, quantifiable revenue stream based on successful context-aware activations.

In some instances, the contextual interest manager 230 monitors for the entity's contextual relevance using the stored interest objects. In one example, the contextual interest manager 230 may ingest and/or evaluate real-time extrinsic data streams. For media content, the backend component running on the social SAAS server 108, may periodically poll public-facing content catalog APIs to check for release dates. For non-media entities, the contextual interest manager 230 may monitor diverse data sources. For example, the context interest manager 230 may track the user's geolocation relative to physical venues, monitor pricing and inventory APIs for retail goods, and/or evaluate social graph events. In some examples, when the extrinsic data satisfies the contextual trigger definition, (e.g. a movie release data, a user entering a geofence of a tracked restaurant during operating hours, etc.) the contextual interest manager 230 may initiate an activation workflow. The activation workflow may include sending a context-aware notification to the user via the messenger 210, interacting with the SAAS calendar planner 228, which may slot the content into the user's personal schedule. These features may ensure a seamless transition from latent interest to active planning.

In some instances, the contextual interest manager 230 may integrate ads into the platform's social discovery fabric. For example, a user may encounter content they are interested in outside the system (e.g. a post on their newsfeed 222, or while browsing a contact's publicly shared personal enjoyment profile, by viewing organic content objects including recipes, product reviews, etc., etc.). When the user interacts with such a content item, the system may present a contextual pop-up menu with a set of available actions. The system may utilize the “maybe” interface as a bridge between social discovery and future action.

In some instances, the contextual interest manager 230 may function as an attribution engine. The contextual interest manager 230 may track the provenance of every “maybe” interaction to generate feedback metrics for businesses and/or users. For business entities, such as streaming services, the system may compile data to identify high-performing discovery channels. The contextual interest manager may distinguish between “maybes” generated via paid advertisements, organic business portal visits, and/or social tags. For individual users who generate content, such as posting a recipe or a media review, the “maybe” button may serve as a tangible metric of social influence. The system may visualize how a user's post has propagated through their network by quantifying the number of contacts who registered interest based on that specific endorsement. Consequently, this attribution data may allow the platform and/or third-party providers to implement algorithmic reward structures. A SAAS provider can configure the system to automatically issue performance-based bonuses (e.g. exclusive content access, monetary discounts, “tickets”, etc.) via the dynamic tier manager 246, to users whose posts successfully drive “maybe” engagement. These features may effectively incentivize organic promotion and user-driven traffic generation.

Before rendering the buttons in the contextual menu, the system may perform an intelligent filtering process. The system may identify an availability status of the entity (e.g. SAAS provider hosting the content, restaurant open status, product stock, etc.). The system may query the user's profile to determine if the item is actional (e.g. does the user have a linked subscription?, is the restaurant open?, etc.). The available actions may then be dynamically tailored based on the status. If the user has access and/or the item is actionable, the primary action presented may be “Add to Playlist,” or “Book Now.” This may be invoked by the cross-platform manager 226. The “maybe” option may be suppressed as irrelevant. If the user is not subscribed to the hosting service, or the entity is not currently actionable (e.g. closed, out of stock, etc.), the system may determine the content is currently inaccessible. In this case, the immediate action buttons may be hidden or disabled. Instead, the primary action presented is the “maybe” button. This allows the user to log their interest in the universal interest database 264. The contextual interest manager 230 may then monitor for that content's future availability, notifying the user if it is ever added to a service they subscribe to or if the real-world context changes make it actionable. This may create a pathway to eventual consumption.

Furthermore, the contextual interest manager 230 may be state-aware, reacting intelligently to changes in a user's subscription status and/or context. In the event a user loses access to a SAAS service (e.g., by canceling their subscription, being removed from a shared account, etc.), the system may initiate an automated migration process. The system may query the cross-platform manager 226 to identify all content items in the user's playlists that are hosted by the now-inaccessible service. For each of these items, the system may automatically remove them from the user's active playlist and create a new interest object for them in the universal interest database 264. This may ensure the user's curated interest in the content is not lost but is instead seamlessly converted into a long-term tracking task. The contextual interest manager 230 may then continue to monitor for this content's future availability on any of the user's remaining active subscriptions, completing the intelligent lifecycle of a user's content interests.

The system's personalization capabilities may extend beyond the timing of notifications to the visual content of the advertisements themselves. In a further example, the interactive ad player 232 may communicate with the autocast ad player 244 to determine if a pre-generated personalized overlay is available for a user, facilitating the delivery of hyper-personalized advertisements. By leveraging the same non-destructive compositing architecture used for the “maybe” interface, the system can seamlessly overlay the user's AI-generated likeness (where explicitly permissioned) into the ad creative, maximizing engagement through visual relevance alongside the functional relevance provided by the contextual interest manager 230.

The integrated media player 234 may be a client-side software component that runs within the social SAAS manager 110 on a user's end device 102, such as a smart TV, mobile phone, or computer. It serves as the versatile playback and rendering engine for all advanced media experiences on the platform. Its primary functions include secure playback of third-party SAAS content, real-time compositing of multiple video layers, and the execution of synchronized commands received from the backend Integrated media engine 120.

The integrated media player 234 may allow for secure playback of DRM-protected content from partnered SAAS providers 104. This process is executed within a web browser engine—either a standard browser on a computer or an embedded browser component, commonly known as a WebView, within the native application on a phone or TV. This architecture allows the integrated media player 234 to leverage the industry-standard Encrypted Media Extensions (EME), a browser-level API for communicating with a device's underlying Content Decryption Module (CDM). The CDM is a secure, hardware-or-software-based component responsible for handling encrypted content and licenses.

When a user initiates playback, the integrated media player 234 receives a media manifest (e.g., an MPEG-DASH.mpd file) from the provider. This manifest contains initialization data specifying the encryption method (e.g., Widevine, PlayReady, FairPlay) and the key IDs. The player passes this initialization data to the EME API. The browser engine then uses the EME to communicate with the device's native CDM, which in turn generates a license request. In a key security measure, this license request is not sent directly to the SAAS provider. Instead, it is transmitted to the platform's backend integrated media engine 120, which acts as a secure broker. The engine forwards the request to the provider's license server and relays the encrypted license back to the integrated media player 234. The player passes this license to the CDM, which can then decrypt the media frames just before they are rendered to the screen. This brokered handshake ensures that the platform can facilitate secure playback without ever having access to the unencrypted content keys, maintaining a robust security posture.

The integrated media player 234 provides real-time, multi-layer video compositing. The player is architected to handle and render multiple, synchronized video and audio streams simultaneously. In a primary use case, it renders the main content stream from a SAAS provider on a base layer. Concurrently, it can render a secondary overlay stream—such as a companion stream or an AI casting overlay—on a layer above the primary content. These overlay streams are specifically encoded with an alpha channel, which defines transparency, allowing the player to seamlessly blend the two video sources. Furthermore, because these video overlays, regardless of their form, often occupy only a fraction of the full video frame, the files produced by the Integrated media editor 236 can be encoded to contain only the pixel data for the specific areas of interest that have changed. This results in a significantly smaller file size compared to encoding the entire frame, making the overlays highly efficient to store and stream. This same compositing capability is leveraged by the Interactive ad player 232 to render interactive UI elements on top of standard video advertisements.

Furthermore, the player may receive and execute commands to enable synchronized social experiences, such as those managed by the video call manager 238. During a watch party, each participant's instance of the Integrated media player 234 maintains a persistent connection with the backend integrated media engine 120. When a host user performs an action, such as pausing the video, their local player sends a “pause” command to the engine. The engine then immediately broadcasts this command to all other participants in the session. Each participant's player receives the command and executes the pause action locally, ensuring frame-perfect synchronization across all devices.

To clarify the technical example, the system utilizes the luma matte technique previously described. For the purposes of this patent, references to an “overlay” or a “secondary overlay stream” should be understood to mean the composite effect created by two distinct, synchronized files: a color video file containing the overlay's visual information, and a corresponding grayscale matte video file that defines its transparency. Therefore, any mention of a secondary concurrent streaming overlay is referring to this combination of a second and third file being decoded concurrently with the primary video stream by the integrated media player 234 to produce the final layered effect.

The luma matte technique works efficiently within the constraints of current, widely adopted video codecs (e.g. H.264), which do not support a 4-channel video stream that includes an alpha (transparency) channel. This two-file approach (one for color, one for the grayscale matte) allows the system to isolate and encode only the small portion of the screen involved in the overlay, making it highly efficient for streaming. It is contemplated, however, that as video codec technology evolves, future standards may natively support single-file streaming with an integrated alpha channel; should that occur, the overlay techniques utilized by present disclosure may also be adapted to take advantage of such advancements without departing from the core concept.

This command-and-control architecture also enables the platform's sophisticated second-screen experience. When a user's TV companion app and mobile phone app are paired, two instances of the integrated media player 234 are active. The instance on the mobile phone functions primarily as a controller, sending user commands (play, pause, select overlay) to the integrated media engine 120. The engine, in turn, relays these commands to the instance of the player running on the TV, which then executes the action on the primary viewing screen. This allows for seamless remote control and interaction with advanced features without interrupting the main viewing experience.

The integrated media editor 236 is a comprehensive software component that functions as the central content creation hub for the platform. It may provide both casual users and professional creators with the tools to produce, synchronize, and publish a wide array of advanced media modifications, which are rendered as non-destructive overlays. The suite contains not only standard video and audio editing tools (e.g., trimming, track mixing, color correction) but also a set of functionalities designed specifically for generating interactive and transformative overlays that work in concert with primary content from SAAS providers. This integrated media editor 236 is the engine that empowers the creation of companion streams, content enhancement filters, and personalized AI casting.

The integrated media editor 236 may include an ability to embed timestamped playback commands directly into an overlay's data track. These commands are metadata instructions that the integrated media player 234 is configured to interpret and execute in real-time. Such commands include, but are not limited to: play, pause, seek to a specific timestamp, and execute a deep link to different content. This allows a creator to produce a “medley” or “compilation” stream that is not tethered to a single piece of SAAS content but can programmatically navigate between multiple pieces of content, even across different SAAS providers, to create a curated, directed experience. To further enhance creative control, the suite allows users to import their own media files. For instance, a user could import a custom sound effect or audio clip and use the suite's timeline editor to trigger its playback at a specific keyframe of the primary content.

To facilitate the precise timing and synchronization of these overlays, the editing suite may provide the user with a view of the original, copyrighted SAAS content to serve as a reference timeline or “north star.” In some examples, this reference stream is provided by leveraging standard adaptive bitrate streaming protocols. The suite actively downloads short segments or chunks of the content corresponding to the section the user is currently editing. For the purpose of editing, a low-resolution version of the content may be streamed, which is sufficient for lining up visual and auditory events while conserving bandwidth. In another example, the user may be given the option to download the entire piece of reference content to a secure, temporary cache on their client device. This method can provide a smoother, buffer-free editing experience, though it will result in the transmission of more data than needed if only a small portion of the content is to be modified.

In some instances, the suite may generate content enhancement and filter overlays. This feature allows a user to apply visual and auditory effects to existing SAAS content in a non-destructive manner. The process involves using the editing suite to render the desired alterations and then isolating only the changes into a standalone overlay file. Users can import their own media, such as a video clip of themselves performing an action, and use the suite's tools to prepare it for compositing into a scene. To generate the final overlay file efficiently for streaming, the suite employs a differential analysis using the luma matte technique. Instead of exporting a large, full-frame video with a true alpha channel, it generates two separate, highly compressed video streams: one containing the color information of the effect, and a second grayscale matte stream defining its transparency. This method drastically reduces the resulting file size, making it ideal for storage and real-time compositing by the end user's media player.

Such features and the editing suite itself do not infringe on the copyright of the original material. The original, DRM-protected content from the SAAS provider remains unaltered at all times. The editing suite and the media player simply provide users with the ability to optionally enhance their viewing experience by compositing separate, complimentary video and audio files on top of the primary content. These overlays are distinct assets that the user can enable or disable at will, functioning as an additive layer rather than a modification of the source material.

In addition to controlling the primary playback, a creator can use the suite's timeline editor to embed a distinct set of commands intended specifically for a user's secondary device, such as a mobile phone or tablet. These timestamped triggers are designed to create a synchronized, dual-screen interactive experience that complements the primary content without obscuring it. For example, in one example, a creator making a commentary track for a film can place a trigger that, at the moment a new character appears on screen, instructs the secondary device to display an interactive metadata card with that character's biography and the actor's filmography. In another example, for a historical drama, a creator could place a trigger that corresponds to a specific event in the film, which then presents the user with a hyperlink on their secondary device to an external news article or academic paper for further reading. A further example could enable a “meme mode,” where a creator places a trigger that renders a short countdown on the primary screen, culminating in a “screenshot” flash effect, while simultaneously commanding the secondary device to display a gallery of internet memes derived from that specific frame. When the primary content reaches this timestamp, the secondary device is commanded to display a gallery of popular internet memes derived from that specific moment, which the user can then browse or share. This functionality allows for limitless contextual enhancement, from e-commerce links for products seen on screen to interactive polls and quizzes related to the plot, all managed through the editing suite's timeline.

In one example, the most advanced capabilities of the integrated media editor 236 are unlocked when it is used in conjunction with select, partnered content that is accompanied by a pre-supplied metadata editing track. This specialized data track can be generated by the content creation studio during its post-production process and may contain a timeline of pre-calculated digital masks identifying specific actors, the correlation of those masks to a character, and the corresponding isolated vocal components. One benefit of this pre-processing workflow is that it enables a seamless and immediate user experience while providing the copyright owner and actors with granular control. By handling the complex technical analysis and securing the contractual agreements upfront, the content owner can make the personalized AI casting feature available for revenue generation concurrently with the content's public release.

This pre-processed track enables a simple, user-facing workflow for the personalized AI casting feature. A user can be presented with a curated, licensed list of characters available for modification within a piece of content. The user may then select one or more characters to replace and assign the corresponding AI profiles of themselves or their contacts to those roles, creating a uniquely personalized version of the content. In examples where a content owner or SAAS provider does not perform this pre-processing, they may contract the platform of the present disclosure to perform these services on their behalf, which may involve additional costs and processing time.

After a user has assigned their desired AI profiles, the generation of the final overlay can be handled in various ways, depending on the available processing power and the complexity of the request. In some examples, particularly with then-current technology, the generation may be an asynchronous process. In this example, the system would initiate a background task to process the recasting overlay, which could take a significant period of time to complete. However, it is contemplated that with future advancements in processing capabilities, this generation could occur in near real-time, allowing for on-the-fly filtering.

To ensure user satisfaction in any implementation, the system may present a preview of the final product before the user commits to a purchase or the system dedicates full resources to the task. This preview could take the form of still frames or a short, protected video clip, providing a representative sample of the recasting quality. Upon reviewing this sample, the user can either approve the result, which finalizes the purchase and triggers the full generation of the overlay, or cancel the request, thereby conserving user time and system resources.

The video call manager 238 is designed to transform the traditionally isolated experience of consuming digital content into a synchronized, interactive, and social event. It allows multiple users in different physical locations to view SAAS content together by coordinating two simultaneous activities for each participant: the synchronized playback of the primary media on a main viewing device (e.g., a television) and a concurrent video conference hosted on a secondary device (e.g., a mobile phone or tablet). The video call manager 238 leverages a distributed architecture, working in concert with the server-side integrated media engine 120 and the client-side Integrated media player 234 to manage sessions, synchronize playback, and facilitate real-time communication.

A watch party session is initiated by a “host” user. The host can select a piece of content from any of their linked SAAS subscriptions and choose to start an immediate session or schedule one for a future time via the SAAS calendar planner. The video call manager 238 then generates invitations, which can be sent directly to their contacts through the messenger 210 or posted to the host's social feed via the newsfeed 222. When an invitation is sent, the integrated media engine 120 creates a unique session identifier and begins managing a list of participants. An important prerequisite for joining is that each participant has valid, independent access to the selected SAAS content. Upon a user accepting an invitation, the video call manager 238 verifies their subscription status and confirms that their current device is whitelisted for that service via the secure access listed trust manager 220.

The video call manager 238 can maintain frame-perfect playback synchronization across all participant devices. The system employs a host-controlled model where the host's instance of the Integrated media player 234 serves as the primary source of truth for playback state. When the host performs an action (e.g., play, pause, seek), an event listener within their player captures the command and its precise timestamp. This command is sent to the integrated media engine 120, which acts as a central broadcaster. The engine immediately relays the command over a persistent, low-latency connection, such as a WebSocket, to all other participant clients in the session. While specific protocols and data formats are described, it is contemplated that any suitable data interchange format or real-time communication protocol, whether now known or later developed, may be used to achieve the same function. Each participant's local instance of the Integrated media player 234 receives and executes the command, ensuring a synchronized experience. To counteract any potential drift caused by network latency or buffering, the engine also broadcasts a periodic “sync pulse” containing the host's current playback timestamp, allowing participant players to make minor, imperceptible adjustments to remain in lockstep.

Simultaneously, the video call manager 238 manages the real-time video conferencing component. Each participant's secondary device uses its camera and microphone to capture their audio and video feed. These streams are sent to the integrated media engine 120, which then distributes them to all other participants in the session. The video call manager 238 provides users with multiple viewing options for this video conference. They can view the other participants on their secondary device, or, in one example, the video feeds can be rendered as an overlay directly on the primary viewing screen. This is achieved by the integrated media player 234, which uses its multi-layer compositing capability to render the video chat streams on top of the main SAAS content, allowing users to see their friends' reactions in real-time without looking away from the main screen.

The video call manager 238 also provides comprehensive moderation and control features. The host retains administrative privileges, including the ability to mute or remove participants from the session. Individual participants have granular control over their own experience, such as the ability to mute a specific person's audio feed or toggle the visibility of the video chat overlay on their screen. For public watch parties, the video call manager 238 can integrate with the personal enjoyment profile generator 216, allowing users to filter interactions or prioritize the visibility of participants who have similar taste profiles, thereby enhancing the social experience.

The companion stream player 240 may be responsible for the management, storage, discovery, and playback of all forms of user-generated and professional content enhancements, with the notable exception of the personalized AI casting feature. For the purposes of this disclosure, a “Companion Stream” is defined not merely as a visual overlay, but as a comprehensive package of synchronized assets that can enhance the viewing experience on both a primary viewing device (e.g., a television) and a secondary device (e.g., a mobile phone). This includes visual/auditory overlays for the primary screen, a synchronized data stream of interactive events for a secondary screen, or a combination of both.

The companion stream player 240 operates in direct conjunction with the companion stream database 260, which serves as the persistent storage repository. An entry in this database for a single companion stream is a collection of assets, which can include: the luma matte video files for a visual overlay, synchronized audio tracks, and a comprehensive metadata package. This package can also contain a dedicated data track with timestamped commands intended for a secondary device, which is the key to enabling the dual-screen experience.

The lifecycle of a companion stream is managed by this companion stream player 240. When a creator publishes their work from the integrated media editor 236, the editing suite passes the complete asset package to the companion stream player 240 for storage in the database. When a viewing user chooses to activate a companion stream, the companion stream player 240 intelligently distributes the assets. The visual and auditory overlay files are delivered to the Integrated media player 234 on the primary device for compositing. Simultaneously, the data track containing the secondary screen commands is sent to the primary management application running on the user's phone or tablet, which then listens for and executes the timestamped triggers.

This dual-screen architecture enables a wide range of interactive experiences. For example, during a medley stream, as a clip plays on the primary device, a command from the secondary data track can instruct the user's phone to display a full metadata card for that content, allowing the user to add the full movie to a playlist or rate it without interrupting playback. In another example, a creator can design a “meme mode” where a trigger on the primary screen initiates a visual “screenshot” flash effect, while a synchronized command instructs the secondary device to display a gallery of internet memes derived from that specific frame. This functionality allows for limitless contextual enhancement, from providing hyperlinks to external articles to displaying interactive polls and quizzes, all perfectly timed to the main content.

One function of the companion stream player 240 is the management of medley streams. For these specific overlays, the most useful component of the asset package is the data track containing timestamped playback commands, such as deep links to various pieces of SAAS content. The companion stream player 240 is responsible for parsing this command track and coordinating with the Integrated media player 234 to execute the programmatic navigation between different content sources, thereby enabling a seamless, curated compilation experience for the viewer.

While functionally similar to other overlays, the personalized AI casting feature is explicitly managed by the dedicated AI casting manager 242. This separation is due to the unique implementation of AI casting, its reliance on pre-processed metadata tracks from content studios, and the distinct business, legal, and contractual frameworks to manage the modification of an actor's likeness. The companion stream player 240, therefore, handles the vast ecosystem of all other creative, interactive, and multi-screen enhancements on the platform.

The AI casting manager 242 manages the platform's most transformative feature: personalized AI casting. While functionally a highly advanced and unique subcategory of a companion stream, AI casting is governed by the AI casting manager 242 due to its distinct technical requirements, its reliance on pre-processed data from content partners, and the business and legal frameworks to manage the modification of an actor's likeness and performance. The AI casting manager 242 is responsible for the entire lifecycle of the AI casting process, from the creation of a user's AI profile to the generation and delivery of the final, personalized overlay.

The process begins with the creation of a user's AI profile. A user provides the system with a set of source materials, which may include images, video clips showing various facial expressions, and audio recordings of their voice. The AI casting manager 242 ingests this source material and uses it to train and generate a personalized AI model of the user's face and voice. This completed AI profile data is then securely stored using at-rest encryption in the dedicated, isolated AI profile database 262. Users have granular control over their own profiles and can grant or revoke access for their trusted contacts to use their AI likeness in their own recasting projects. Users also retain the right to permanently delete their AI Profile and all associated trained models from the system at any time through their account settings. The user's AI Profile is never used for any purpose without their explicit, granular consent for a specific action (e.g., enabling autocast ads, sharing with a specific contact).

In one example, the user-facing workflow is designed for simplicity. A user selects a piece of partnered content that has been enabled for AI casting. They are then presented with a curated, licensed list of the characters available for recasting-a list that is populated directly from the pre-supplied metadata editing track provided by the content studio. The user selects a character from this list and then assigns a desired AI profile to that role, which can be their own or one from a contact who has granted them permission.

Upon receiving the user's selections, the AI casting manager 242 initiates the overlay generation process. It retrieves the user's chosen AI profile from the database and the corresponding pre-processed metadata track for the content. This metadata track, containing a timeline of pre-calculated facial masks and isolated audio stems for the selected character, is fundamental to the process. The AI casting manager 242 uses these high-fidelity masks as a precise guide to render the user's AI-generated face over the original actor's performance. Concurrently, it uses the isolated audio stem to mute or adjust the original dialogue and add the user's AI-synthesized voice.

The generation of this high-fidelity overlay is a computationally intensive task. In some examples, particularly with then-current technology, this may be an asynchronous process that takes a significant period of time to complete. To ensure user satisfaction and conserve system resources, the AI casting manager 242 may first generate a preview. This preview, which may consist of several still frames or a short, protected video clip, provides the user with a representative sample of the final product's quality. After reviewing the sample, the user can approve the result, which finalizes the purchase and triggers the full generation of the overlay for the entire duration of the content. If the user is unsatisfied, they can cancel the request, aborting the process.

Once generation is complete, the final output is a non-destructive, luma matte overlay file containing only the new, additive facial and vocal data. This file is then delivered by the AI casting manager 242 to the integrated media player 234, which composites it in real-time with the original, unaltered SAAS content to create a hyper-personalized viewing experience for the user.

In addition to user-initiated recasting, the AI casting manager 242 also serves requests from the autocast ad player 244 to provide user AI profiles for the offline generation of personalized ad overlays.

The autocast ad player 244 manages a form of hyper-personalized advertising. It works in concert with several other components to programmatically insert a user's AI-generated likeness into video advertisements in a secure and scalable manner. Its primary function is to orchestrate the process of generating and delivering these unique ads to users who have explicitly opted-in to the feature.

The process is initiated when an advertiser provides a pre-masked video advertisement to the platform. The autocast ad player 244 is responsible for ingesting this ad and its associated metadata, which includes the specific markers for facial placement. The autocast ad player 244 then queries the user manager 202 to identify the pool of users who have enabled the “Personalized and Autocast Ads” feature in their profile settings.

For each opted-in user, the autocast ad player 244 initiates an offline, pre-processing task. It sends a request to the AI casting manager 242 to retrieve the user's specific AI profile from the AI profile database 262. Using this profile and the advertiser's pre-masked video as a template, the autocast ad player 244 generates a unique, non-destructive overlay file containing only the additive data of the user's face and/or voice. This personalized ad overlay is then stored and associated with the user's account, ready to be served.

When an ad opportunity arises for the user, the Interactive ad player 232 communicates with the autocast ad player 244. If a pre-generated personalized overlay exists for the user and the specific ad, the autocast ad player 244 provides it. The Integrated media player 234 then receives both the original ad creative and the user's personalized overlay, compositing them in real-time to deliver the final autocast ad to the user's screen. This architecture ensures a seamless, instantaneous experience for the user while maintaining strict, permission-based privacy controls over their AI likeness.

The dynamic tier manager 246 is a specialized B2B feature that enables SAAS provider partners to offer a usage-based subscription model. The dynamic tier manager 246 is architected to be deployed as a feature deeply integrated and hosted within The Platform's ecosystem and/or as a standalone, licensable software component that a SAAS provider can integrate directly into their own backend infrastructure. The present disclosure describes management of a quantifiable usage allowance for a subscription account. This total monthly allowance is defined and controlled by the SAAS provider according to the terms of the subscription tier; The platform acts as the system of record and enforcement for this provider-set value. This allowance can be measured by various metrics, such as total viewing time (streaming hours), data egress, or, in a gamified example, as a spendable in-app currency (e.g., “tickets” or “tokens”). The dynamic tier manager's 246 operation relies on the persistent storage of all relevant data within the dedicated dynamic tier database 266. The dynamic tier database 266 stores information for each subscription account, including the total usage allowance, the billing cycle dates, the individual allowance balances for each user on the account, the current tier status of each user (e.g., ‘ad-free’ or ‘ad-supported’), and a comprehensive transaction log of all debits and credits.

The present disclosure further describes an ability for a primary user to subdivide the subscription's total monthly allowance among the different users sharing the account. For example, if a family plan comes with a total allowance of 40 hours or 40 tickets, the primary user can allocate a 10-hour or 10-ticket balance to themselves and the same amount to each of the three other family members who are sharing the subscription. This creates individual allowance balances for each user under the umbrella of a single subscription. Consequently, one user's high consumption will only deplete their personal allowance and transition them to an ad-supported experience, without affecting the ad-free status of the other users on the same account.

In the platform-hosted example, the dynamic tier manager 246 comprehensively tracks usage, which is facilitated by the SAAS activity manager 214 acting as the central ingestion point for all consumption events. The SAAS activity manager 214 serves a dual purpose. First, it creates an activity record in the user SAAS log 254, making the content available for the user to rate as part of their personal enjoyment profile. Second, and simultaneously, it forwards the same activity data to the Dynamic tier manager 246. This forwarded data contains not only the content ID and consumption metric but also a user identifier.

The system addresses the challenge of identifying individual users who are sharing a single set of login credentials. When a user streams through the system, their identity is known and included in the activity data. However, when consumption occurs on the SAAS provider's native app, the provider's inbound API event includes device-identifying information. The Dynamic tier manager 246 uses this device identifier to perform a user attribution lookup by cross-referencing it with the device whitelists managed by the secure access listed trust manager 220. If the device is uniquely assigned to a single user, that user's ID is attached to the activity data. If a device is shared, the system defaults to using the primary user's ID.

Upon receiving the attributed activity data, the dynamic tier manager 246 processes the event by retrieving the provider-defined consumption cost for that content (e.g., the runtime in minutes, or a specific ticket price), deducts the consumed amount from the attributed user's allowance balance in the dynamic tier database 266, and, if that user's balance is depleted, sends a command to the SAAS provider to transition that specific user's account to the ad-supported state. To give the primary user ultimate control, they can enable a subscription-level setting such as “Native App Playback Defaults to Ad-Supported,” which causes any activity from the provider's native app to bypass the allowance deduction process entirely and default to an ad-supported stream.

To ensure data integrity, the dynamic tier manager 246 performs a periodic verification check with the SAAS provider, typically at the start of each billing cycle. This process involves an automated API call to the provider's server to confirm the current total allowance for the subscription tier before the replenishment process is executed. This ensures that any changes to the subscription terms made by the provider are accurately reflected in The platform's system.

The data stored by this dynamic tier manager 246 is then used to populate various UI elements. When a user accesses a SAAS portal 218, the portal queries the dynamic tier manager 246 to display the user's current individual allowance balance (e.g., “2 h 15 m remaining” or “12 Tickets left”). The portal also displays the specific consumption cost for each piece of content (e.g., “1 h 30 m” or “5 Tickets”). Furthermore, the social SAAS marketplace 224 interfaces with this dynamic tier manager 246 to accurately present the terms of these dynamic subscription tiers to potential subscribers.

In the standalone example, this entire suite of logic—including allowance subdivision, user attribution via internal device records, and allowance deduction—is deployed as a modular, white-label software component that a SAAS provider integrates directly into their own backend systems and databases, allowing it to operate independently of The platform's real-time infrastructure.

The recommendation generator 248 is a specialized component that manages the platform's social recommendation features. Its primary role is to handle the creation of rec lists from disparate sources, attach persistent conversation threads to individual recommendations, and process flexible, multi-faceted sharing rules. To perform these functions, it operates in direct concert with the recommendation list & conversation database 268, which serves as the authoritative, persistent data store for all feature-related information. This database is architected to hold a comprehensive set of data for each rec list, including its core metadata (e.g., title, sharing permissions), pointers to the universal content identifiers that constitute its contents, private and recipient-specific tags (e.g., “Backburner”), and the complete, threaded conversation history attached to each individual list item.

The recommendation generator 248 orchestrates a complex set of interactions to deliver the full functionality. It facilitates the two primary sharing models: a passive mode where a list is published to a user's profile with granular audience controls for others to “follow,” and an active mode where direct share requests are sent to specific users. For the active mode, it interfaces with the User contacts manager 204 to enforce the recipient's privacy settings before invoking the messenger 210 to dispatch the share request. The recommendation generator 248 may also support monetization by allowing a list's originator to restrict visibility to a custom group of paying subscribers.

Furthermore, the recommendation generator 248 may be responsible for generating several dynamic, context-aware user interface elements. It creates the access status indicator on each list item by cross-referencing a recipient's subscription data, which is managed by the user manager 202. This indicator provides benefits such as enabling a gifting workflow. A list creator can identify a service a recipient lacks, navigate to the social SAAS marketplace 224 to subscribe on their behalf, use the data manager 206 to securely transfer the credentials, and use the cost sharing manager 208 to designate the subscription as a gift. The recommendation generator 248 also intelligently leverages the platform's layered permissions; if a list creator is permitted to view a recipient's personal enjoyment profile, the recommendation generator 248 queries it to display the recipient's real-time consumption status, providing passive feedback. Finally, the recommendation generator 248 acts as a gatekeeper for the cross-platform manager 226 and SAAS calendar planner 228, filtering content based on the private “Backburner” tags stored in its database to ensure only desired recommendations are used for automated scheduling.

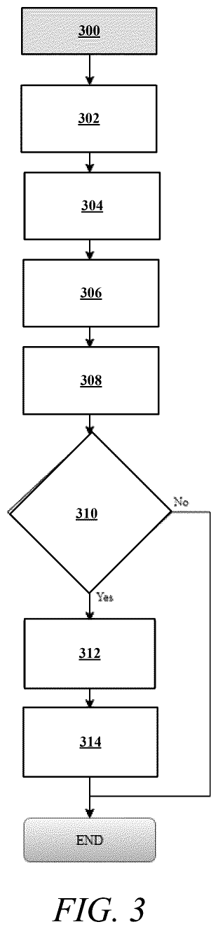

FIG. 3 depicts a flowchart of an example method 300 for logging a user's SAAS activity and optionally posting it to their social newsfeed (e.g. by utilizing the social SAAS manager 110). The process begins at step 302, when a user engages with content on a SAAS account that has been linked to the system. In step 304, this SAAS activity is communicated between the respective SAAS provider's server and the SAAS portal (e.g. within the social SAAS manager).

Following this communication, the SAAS activity is automatically saved to the user's personal SAAS log in step 306, creating a persistent record of their engagement. At a later time, in step 308, the user can view their personal SAAS log and may apply privacy settings to the entries.

From the log, the user is presented with a decision at step 310 to determine if they would like to post any of their SAAS log entries to their social newsfeed. If the user chooses not to post, the process for that activity concludes. If the user chooses to proceed, the method moves to step 312, where the post is enriched with a deep link to the content and may be supplemented with optional user input, such as comments, a rating, or other reactions. Finally, in step 314, this enriched SAAS activity is posted to the user's social newsfeed for their contacts to view.

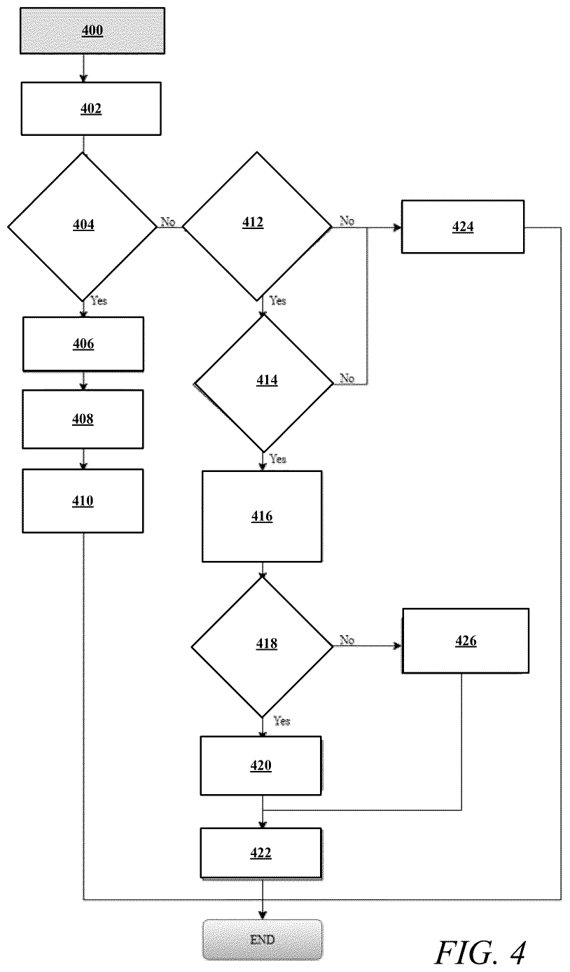

FIG. 4 depicts a flowchart of an example method 400 for the system to process and display either a user's own rating or a calculated personal enjoyment profile rating by utilizing the social SAAS manager 110. The process begins at step 402 when a user encounters a piece of SAAS content.

At step 404, a determination is made as to whether the user has previously rated this content. If the user has rated it, the process follows the “Yes” path to step 406, where the system displays the user's existing rating. The user may then be given an opportunity to adjust their rating in step 408. This rating is then used by the system to adjust user similarity scores in step 410, concluding this path.

If, at step 404, it is determined the user has not rated the content, the process follows the “No” path to determine if a personal enjoyment profile rating can be calculated. At step 412, a check is performed to see if the user has rated a minimum quantity of other content to establish a meaningful taste profile. If not, the system concludes at step 424 that there is insufficient data to provide an estimated personal enjoyment profile rating. If the user has met the threshold, a second check is performed at step 414 to determine if the content itself has received a minimum number of ratings from the network. If not, the process also concludes at step 424.

If both thresholds are met, the system proceeds to step 416 to calculate a personal enjoyment profile rating for the main user, based on the content ratings and user similarity scores from their network and contacts. After calculation, a determination is made at step 418 as to whether the user has previously consumed the content. If they have not, the calculated personal enjoyment profile rating is displayed to the user at step 426. If they have, the calculated personal enjoyment profile rating is displayed with a visually distinct user interface at step 420 to signify that the content has been viewed but awaits a rating. Steps 420 and 426 converge before step 422 where the user may decide to enter their rating. Step 426 flows into step 422 because the user may have consumed the content in a way that is not reflected by the Platform, so they need an option to enter their rating despite the Platform not having a record of the consumption.

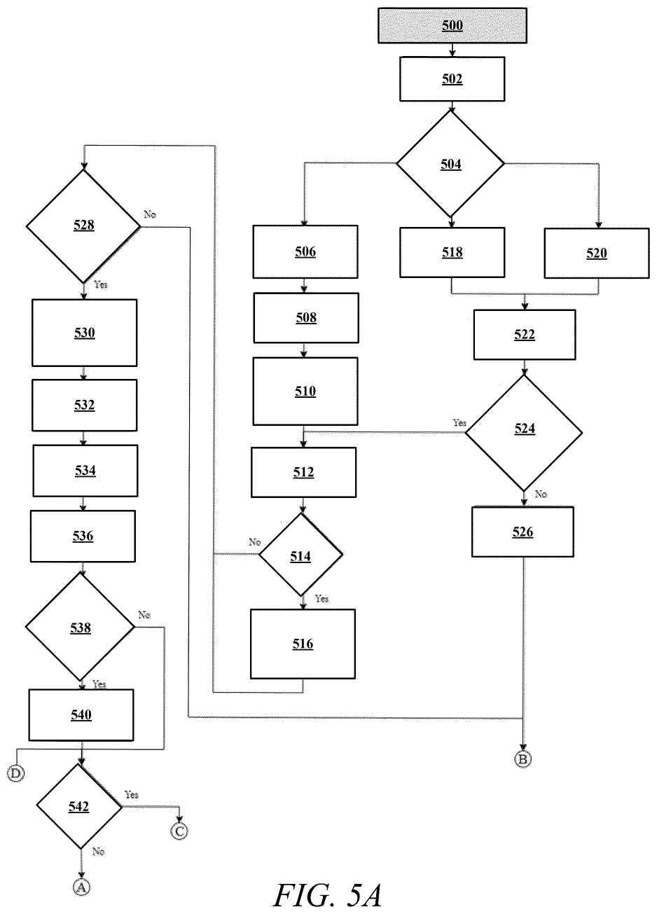

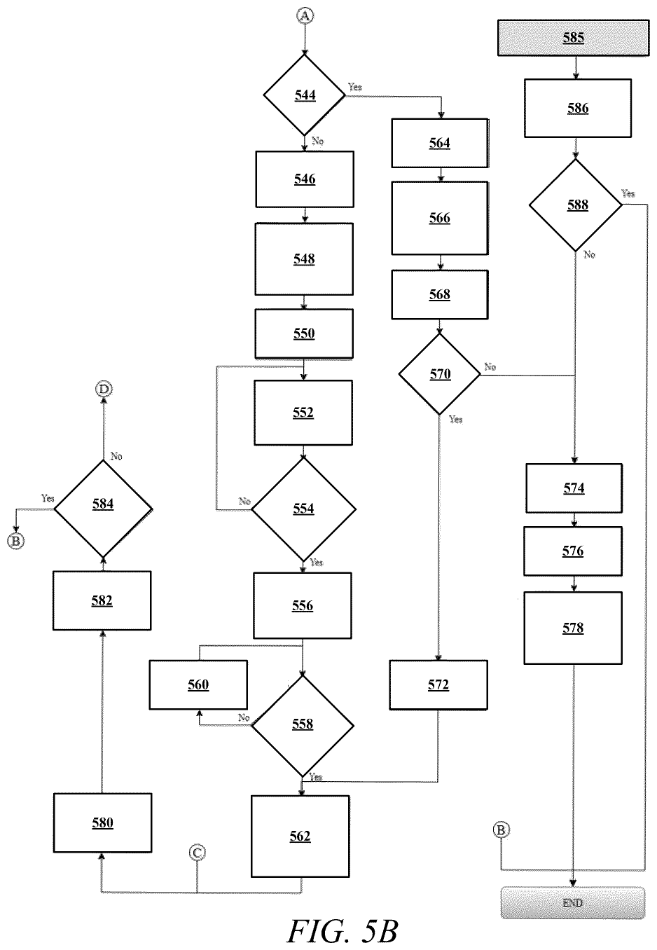

FIG. 5, including FIG. 5A and FIG. 5B, depicts a flowchart of an example method 500 for managing the complete lifecycle of a SAAS subscription sharing arrangement. This comprehensive method includes the initiation of the sharing agreement, user and device verification, integrated device management via the secure access listed trust, and a closed-loop system for automated financial settlement and enforcement. In some instances, the method is executed by the social SAAS manager 110, herein referred to as “the platform,” and utilizes various interconnected software components as described in the system architecture of FIG. 2 to provide a seamless, secure, and automated solution for collaborative subscription consumption. The process demonstrates a complete management cycle, functioning as an automated agent for the primary user by handling everything from granting access to programmatically revoking it in response to events such as non-payment, thereby mitigating financial risk and removing social friction from the management of shared digital assets.

The process begins at step 502 when a user initiates a SAAS subscription sharing and device management request within the platform. At the initial decision point 504, the platform determines how the sharing request was initiated. The system's architecture is designed for flexibility, accommodating various user scenarios by branching into one of several distinct initiation paths.

The first path, beginning at step 506, addresses a scenario where a user proactively seeks a partner for a new subscription. At step 506, a user posts a request indicating their desire to find a cost-sharing partner for a new SAAS subscription they wish to acquire. This request can be posted to either the dedicated social SAAS marketplace 224 or more broadly to their contacts via the newsfeed 222. At step 508, another user on the platform discovers and accepts this offer. In response, the platform initiates a security and trust-verification workflow, (e.g. in some instances, managed by the user contacts manager 204), to verify or, if necessary, establish a “high-trust contact status” between the two users. This verified high-trust status is a mandatory prerequisite for establishing any financial arrangements within the system. At step 510, with the partnership established, the users decide between themselves which party will act as the primary account holder. The designated user then formally records this status within the Platform's interface, and the Platform records this designation before facilitating the completion of the new subscription registration. This registration may be expedited using the single-click registration method detailed in FIG. 7. Subsequently, at step 512, the users establish the formal subscription sharing arrangement terms, including but not limited to the cost-split ratio and billing frequency. These terms are securely recorded and managed by the Cost sharing manager 208, and the process then proceeds to the arrangement finalization phase at decision point 514.

The second path, beginning at step 518, caters to a primary user who has an existing subscription with underutilized capacity. At step 518, the primary user posts their available device capacity-often referred to as “seats” or “slots”—for their contacts to see. This listing can be posted to either the Social SAAS marketplace 224 or the newsfeed 222. The process then proceeds to step 522.

The third path, beginning at step 520, involves a direct invitation from a primary user to a trusted contact. At step 520, the primary user sends a direct share request for an existing subscription to one of their established trusted contacts. This path also proceeds to step 522.

Both the marketplace 518 and direct invitation 520 paths converge at step 522, where a user on the Platform discovers this listing and sends a request to accept the offer, the platform invokes the User contacts manager 204 to verify the high-trust contact status between the users as a prerequisite for the arrangement. The process then moves to decision point 524 to determine if the primary user has device capacity remaining on their account. If there is no capacity, the process proceeds to step 526, where the platform notifies the primary user that there are no remaining slots available, and the process terminates. If device capacity is available, the process connects to step 512 where the users establish the terms of their arrangement to the arrangement finalization phase at decision point 514.

The paths originating from the proactive partner search 506 and the marketplace/direct invitation paths 518 and 520 converge at decision point 514. Here, a determination is made as to whether the arrangement is being designated as a gift from the primary user to the shared user. If yes, the process proceeds to step 516, where the sharing arrangement is formally designated as a “gift” within the platform's data records. This designation instructs the cost sharing manager 208 to bypass all subsequent payment setup and processing steps later in the flowchart. Both the “yes” and the “no” paths of 514 converge after step 516, then the path proceeds to 528.

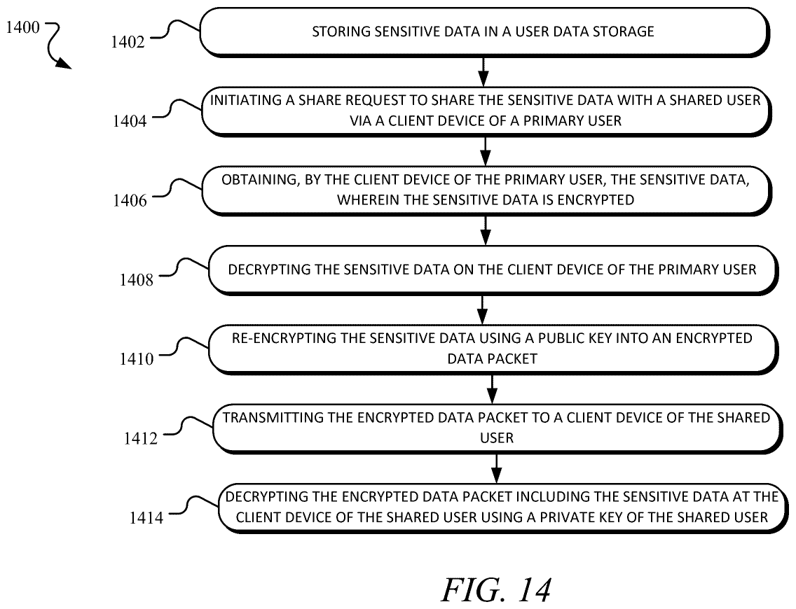

At decision point 528, a determination is made as to whether both the primary user and the intended shared user consent to the sharing arrangement terms and agree to the platform's overarching terms and conditions. This step, managed by the User contacts manager 204, ensures that all parties provide explicit, informed consent before any sensitive data is exchanged. If no, the process terminates. If yes, the method proceeds to a streamlined device and credential management workflow, beginning at step 530. At step 530, the primary user securely transmits the SAAS credentials to the shared user via the Data manager 206, which employs an end-to-end, zero-knowledge encryption protocol as detailed in FIG. 14.

Upon receiving the credentials, the shared user, at step 532, initiates their device whitelisting process via the secure access listed trust manager 220. At step 534, the shared user directs the secure access listed trust manager 220 to assign their newly whitelisted device to an available slot for the specific SAAS subscription. This action updates the user-defined access control list for that subscription. At step 536, the Platform transmits this updated device authorization list to the third-party SAAS provider's server via the SAAS Provider API Gateway 114. The partnered SAAS provider's authentication systems are configured to ingest this list and enforce it as the single source of truth for access, thereby blocking any login attempts from unauthorized devices.

At decision point 538, a determination is made as to whether the shared user wishes to add a device-specific Multifactor Authentication (MFA) method. This feature is an enhancement designed to reduce logistical friction in shared accounts by decoupling MFA prompts from the primary user's contact information. If the shared user chooses not to add a device-specific method, the process proceeds to decision point 542. If the shared user opts in, at step 540, they associate their own personal contact information (e.g., their mobile phone number or email address) specifically with their whitelitelisted device for that particular subscription. This ensures that any future MFA codes or authentication challenges for that device are sent directly to the shared user, eliminating the need to coordinate with the primary user. The process then proceeds to decision point 542.

At decision point 542, which also serves as the next step for the direct credential sharing path, a final determination is made as to whether the arrangement is designated as a gift. This redundant check ensures that all initiation paths are properly handled. If the arrangement is not a gift, the process proceeds via connector A to FIG. 5B to configure and manage the financial settlement of the cost-sharing agreement. If it is a gift, the process proceeds via connector C.

The method continues from connector A on FIG. 5B, entering the payment processing and monitoring phase. At decision point 544, the system determines if the payment for the sharing arrangement should be automated via the platform's integrated peer-to-peer (P2P) payment system, which is managed by the cost sharing manager 208. This decision point represents a key branching of functionality, allowing the platform to operate in one of two distinct financial management modes: a fully automated payment processing mode, or a manual “Ledger Mode.”

If automated P2P payment is not selected, the process enters the “Ledger Mode”, where the platform acts as a financial management conduit and an easy reference for users who prefer to handle transactions via external payment methods. In this mode, the Platform functions as an enablement tool, providing clarity, communication, and a system of record without directly handling the funds.

At step 546, the platform sets an internal flag in its database to define the nature of the external payment arrangement based on the user-defined terms, marking the arrangement as either “External Single” for a one-time transaction or “External Recurring” for an agreement that repeats at a set frequency. At step 548, to provide users with an exact reference of what is owed, the platform records a “Receivable” for the primary user and a corresponding “Payable” for the shared user in the user data storage 250. This serves as a shared, transparent internal ledger. At step 550, to further facilitate the external transaction, the Platform cross-references the peer-to-peer payment services each user has pre-selected in their profile to identify any compatible methods and suggests these common services to the users to streamline the transfer. At step 552, the messenger 210 is configured to periodically transmit payment reminders to the shared user as the due date approaches, based on the agreed-upon payment frequency.

The process then awaits confirmation of the external payment at decision point 554. The platform provides a means for the shared user to confirm the transaction by determining if they have marked the payment as sent via the platform's user interface. If not, the process loops back to step 552, continuing to send reminders. If the shared user marks the payment as sent, the process proceeds to step 556, where the platform updates its internal ledger to reflect the pending payment and sends a notification to the primary user via the messenger 210, prompting them to confirm receipt. At decision point 558, a determination is made as to whether the primary user has confirmed receipt of the funds via their user interface. If not, a confirmation notice is sent to both users at step 560 to facilitate communication. If the primary user confirms receipt, at step 562, the platform finalizes the transaction in its ledger, marks the receivable as “Paid,” and updates the permanent audit trail for the arrangement. The process then proceeds to step 580.

If, at decision point 544, automated P2P payment is selected, the process follows the automated payment and enforcement path. At step 564, the cost sharing manager 208 programmatically initiates an automated P2P payment based on the agreed-upon financial terms. At step 566, the platform constructs and sends a secure, authenticated transaction request to the designated third-party financial service provider 106. This transaction is authorized using a secure access token, a method which ensures the user's sensitive banking credentials are never stored on or transmitted through the Platform's servers. At step 568, the external financial service provider processes the P2P bank transfer.

At decision point 570, a determination is made as to whether the money transfer was successful. If the transfer was successful, the process proceeds to step 572, where the platform, via the messenger 210, notifies both the primary and shared user of the successful transaction. The process then proceeds to step 562 to update the internal ledger and audit trail, after which it also proceeds to step 580.

If the automated transfer at step 570 fails, the process moves to the non-payment action and resolution workflow. This workflow represents an automated enforcement mechanism that protects the primary user from financial loss. At step 574, the Platform immediately notifies both users of the payment failure, providing the specific reason returned by the financial service provider (e.g., insufficient funds, invalid account). At step 576, the failed transaction is recorded in the user data storage for auditing purposes. For a failed automated transaction, the process then proceeds directly to step 578, where the shared user's device is programmatically removed from the SAAS subscription.

Separately, the platform provides a manual reporting mechanism 585 that serves as a fail-safe, primarily for external payment arrangements. At step 586, a primary user can formally report a non-payment, which initiates a different workflow: the Platform notifies the shared user that a non-payment has been reported and programmatically initiates a predefined grace period to allow for resolution.

At decision point 588, a determination is made as to whether the payment issue has been resolved before the expiration of the grace period. Resolution can occur if the shared user adds a valid payment method and successfully completes the payment, or if the primary user manually clears the report. If the issue is resolved, the non-payment path is stopped and the arrangement can continue as before. However, if the grace period expires and the issue remains unresolved, the process merges with the automated payment failure workflow by proceeding to step 574. At this point, the Platform notifies both users of the payment failure, providing the specific reason. Subsequently, at step 576, the failure is formally recorded in the user data storage for auditing purposes. At step 578 the platform executes an automated enforcement action: the shared user's device is programmatically removed from the SAAS subscription's authorized list by the secure access listed trust manager 220, their access to the shared credentials via the data manager 206 is revoked, and the data sharing arrangement is formally terminated.

The final phase of the method is ongoing arrangement management. All paths for successfully established arrangements—including gifts via connector C and confirmed payments from step 562—converge at step 580, where the sharing arrangement is logged as active in the User Data Storage. The process then proceeds to step 582, where the Platform awaits the next billing cycle as defined in the arrangement terms. Upon the trigger of the next billing cycle, the process moves to decision point 584 to determine if the arrangement is marked as “External Recurring.” If the arrangement is external and recurring, the process follows the “Yes” path to connector B, and the platform's active management for that arrangement concludes. At this point, the users manage their recurring payments independently, and the platform serves as a passive reference for the agreed-upon terms. If the arrangement is not marked as “External Recurring,” the process follows the “No” path and loops via connector D back to step 552 to re-initiate the payment reminder and confirmation workflow for the new billing cycle.

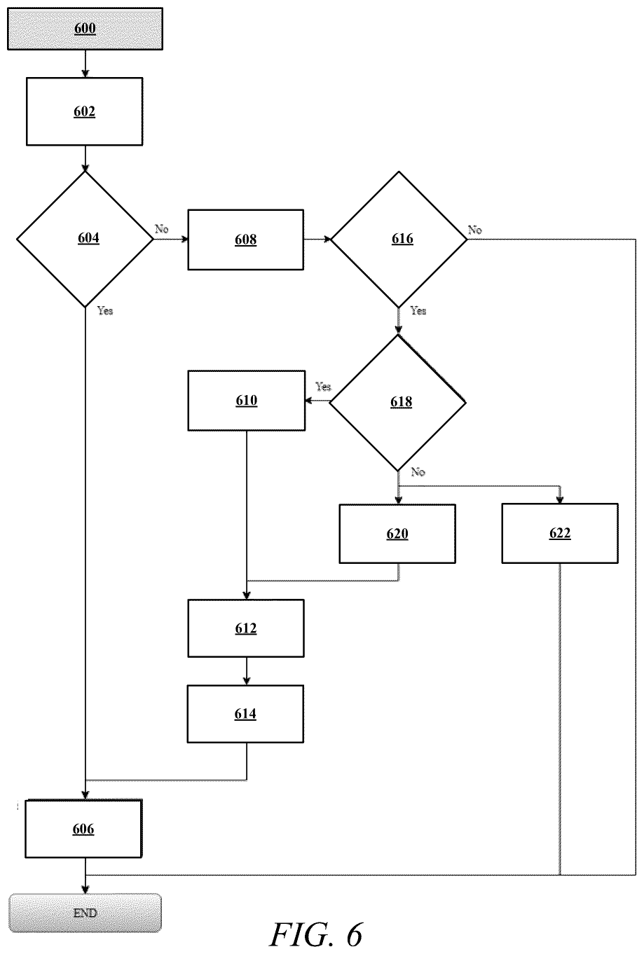

FIG. 6 depicts a flowchart of an example method 600 for SAAS access management and authentication utilizing the secure access listed trust. The process begins at step 602 when a shared user attempts to access SAAS content on a device linked to their account within the software.

At the primary decision point in step 604, a determination is made as to whether the device attempting access is on the pre-approved, authorized list for that specific SAAS subscription within the secure access listed trust manager 220. If the determination is yes, access is granted at step 606, and the shared user can engage with the SAAS content.

If the device is not on the authorized list, the process follows the “No” path to step 608, where the primary user of the subscription is notified of the unauthorized access attempt. The device then prompts the shared user at step 616 with a decision to request that the new device be added to the subscription. If the shared user declines, the process is canceled at step 622.

If the shared user agrees to add the device, a determination is made at step 618 as to whether there is an open device slot available for the subscription. If there is no slot available, the shared user is prompted to disable one of their currently authorized devices to free up a slot at step 620. Once a slot is made available, either initially or by the user's action, the shared user utilizes the empty slot for the new device at step 610. The new device is then formally added to the authorized list via the secure access listed trust manager 220 at step 612. In step 614, the updated authorized device list for the subscription is transmitted to the SAAS provider's server. Following this transmission, access is granted at step 606, and the shared user can engage with the content.

FIG. 7 depicts a flowchart of an example method 700 for a single-click SAAS registration and onboarding process, facilitated by the social SAAS manager 110. The process begins at step 702 after a user reviews the details of a new SAAS service they are interested in. At step 704, the user initiates the registration for the subscription.

In step 706, the software opens a secure registration window hosted by the SAAS provider. A determination is made at step 708 as to whether the user's profile contains the information needed to complete the provider's registration form. If the information is incomplete, the user is prompted to manually enter the missing data at step 724. Once this information is available, the software autofills the registration form with the user's personal data, payment method, and a securely generated password at step 710.

At step 712, the user reviews the pre-filled form and the provider's terms and conditions before clicking a final confirmation button. Upon confirmation, the new username and generated password are automatically saved in the user's integrated password manager at step 714. A determination is then made at step 716 as to whether the user also selected to link this new subscription with the software. If yes, the system completes an OAuth handshake to link the new subscription to a portal at step 718.

Finally, after the subscription is successfully created, a determination is made at step 720 as to whether the user would like to share access to the new subscription. If the user chooses to do so, the system initiates the SAAS Subscription Sharing Flow, as detailed in FIG. 5, at step 722. If the user declines to link or share, the process concludes.

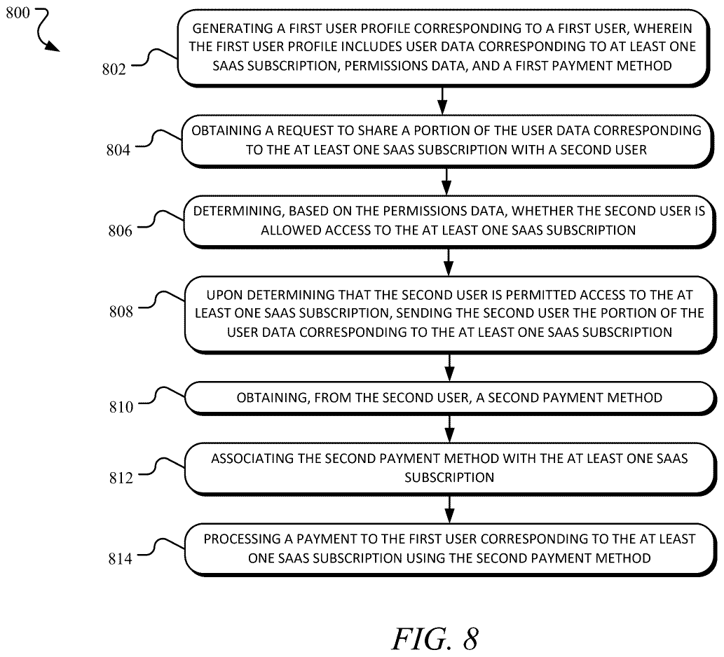

Referring to FIG. 8, an example method 800 of managing a SAAS subscription utilizing the social SAAS manager 110. The method 800 includes a step 802 of generating a first user profile corresponding to a first user, wherein the first user profile includes user data corresponding to at least one SAAS subscription, permissions data, and a first payment method. The method 800 further includes a step 804 of obtaining a request to share a portion of the user data corresponding to the at least one SAAS subscription with a second user. Obtaining the request may be initiated by the first user or by the second user. The method 800 further includes a step 806 of determining, based on the permissions data, whether the second user is allowed access to the at least one SAAS subscription. The method 800 further includes a step 808 of upon determining that the second user is permitted access to the at least one SAAS subscription, sending the second user the portion of the user data corresponding to the at least one SAAS subscription. The method 800 further includes a step 810 of obtaining, from the second user, a second payment method. The method 800 further includes a step 812 of associating the second payment method with the at least one SAAS subscription. The method 800 further includes a step 814 of processing a payment to the first user corresponding to the at least one SAAS subscription using the second payment method.

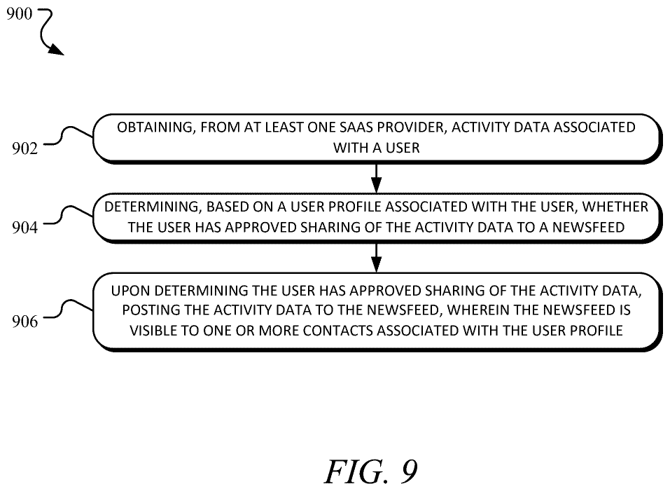

FIG. 9 depicts an example method 900 of managing a SAAS subscription utilizing the social SAAS manager 110. The method 900 includes a step 902 of retrieving, from at least one SAAS provider, activity data associated with a user. The method 900 further includes a step 904 of determining, based on a user profile associated with the user, whether the user has approved sharing of the activity data to a newsfeed. The method 900 further includes a step 906 of posting, upon determining the user has approved sharing of the activity data, the activity data to the newsfeed, wherein the newsfeed is visible to one or more contacts associated with the user profile.

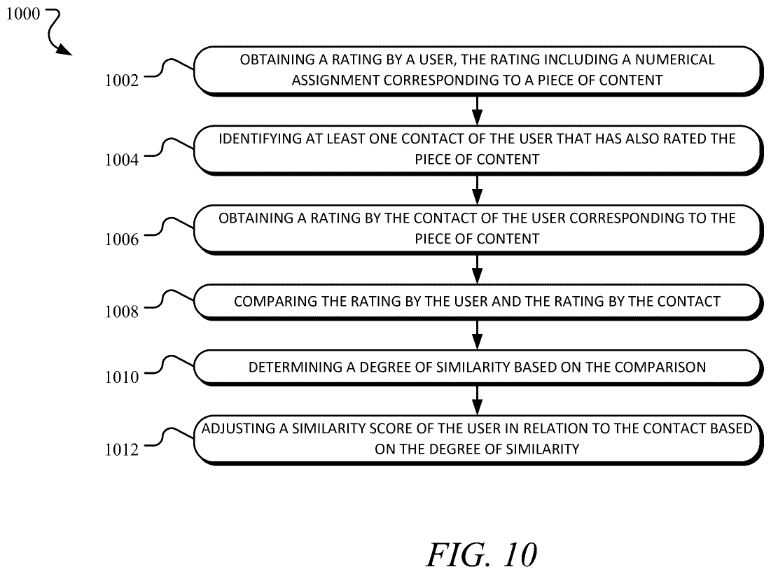

FIG. 10 depicts a method 1000 of managing a SAAS subscription utilizing the social SAAS manager 110. The method 1000 includes a step 1002 of retrieving a rating by a user, the rating including a numerical assignment corresponding to a piece of content. The method 1000 further includes a step 1004 of identifying at least one contact of the user that has also rated the piece of content. The method 1000 further includes a step 1006 of retrieving a rating by the contact of the user corresponding to the piece of content. The method 1000 further includes a step 1008 of comparing the rating by the user and the rating by the contact. The method 1000 further includes a step 1010 of determining a degree of similarity based on the comparison. The method 1000 further includes a step 1012 of adjusting a similarity score of the user in relation to the contact based on the degree of similarity.

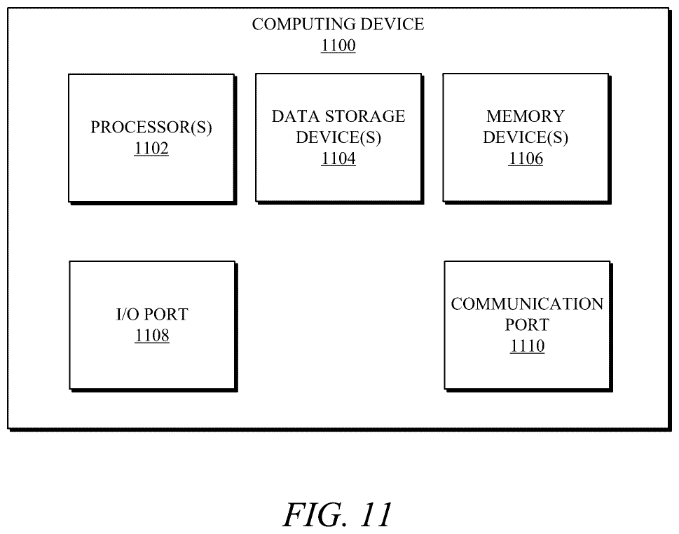

Referring to FIG. 11, a detailed description of an example computing device 1100 having one or more computing units that may implement various systems and methods discussed herein is provided. The computing device 1100 may be applicable to the client devices 102 and other computing or network devices. It will be appreciated that specific examples of these devices may be of differing possible specific computing architectures not all of which are specifically discussed herein but will be understood by those of ordinary skill in the art.

The computing device 1100 may be a computing system is capable of executing a computer program product to execute a computer process. Data and program files may be input to the computing device 1100, which reads the files and executes the programs therein. Some of the elements of the computing device 1100 are shown in FIG. 11, including one or more hardware processors 1102, one or more data storage devices 1104, one or more memory devices 1106, and/or one or more ports 1108-1110. Additionally, other elements that will be recognized by those skilled in the art may be included in the computing device 1100 but are not explicitly depicted in FIG. 11 or discussed further herein. Various elements of the computing device 1100 may communicate with one another by way of one or more communication buses, point-to-point communication paths, or other communication means not explicitly depicted in FIG. 11.

The processor 1102 may include, for example, a central processing unit (CPU), a microprocessor, a microcontroller, a digital signal processor (DSP), and/or one or more internal levels of cache. There may be one or more processors 1102, such that the processor 1102 includes a single central-processing unit, or a plurality of processing units capable of executing instructions and performing operations in parallel with each other, commonly referred to as a parallel processing environment.

The computing device 1100 may be a conventional computer, a distributed computer, or any other type of computer, such as one or more external computers made available via a cloud computing architecture. The presently described technology is optionally implemented in software stored on the data stored device(s) 1104, stored on the memory device(s) 1106, and/or communicated via one or more of the ports 1108-1110, thereby transforming the computing device 1100 in FIG. 11 to a special purpose machine for implementing the operations described herein. Examples of the computing device 1100 include personal computers, terminals, workstations, mobile phones, tablets, laptops, personal computers, multimedia consoles, gaming consoles, set top boxes, and the like.

The one or more data storage devices 1104 may include any non-volatile data storage device capable of storing data generated or employed within the computing device 1100, such as computer executable instructions for performing a computer process, which may include instructions of both application programs and an operating system (OS) that manages the various components of the computing device 1100. The data storage devices 1104 may include, without limitation, magnetic disk drives, optical disk drives, solid state drives (SSDs), flash drives, and the like. The data storage devices 1104 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1106 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1104 and/or the memory devices 1106, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or components utilized by or associated with such instructions. Machine-readable media may include a single medium or multiple media (e.g., a centralized or distributed database, and/or associated caches and servers) that store the one or more executable instructions or data structures.

In some examples, the computing device 1100 includes one or more ports, such as an input/output (I/O) port 1108 and a communication port 1110, for communicating with other computing, network, or vehicle devices. It will be appreciated that the ports 1108-1110 may be combined or separate and that more or fewer ports may be included in the computing device 1100.

The I/O port 1108 may be connected to an I/O device, or other device, by which information is input to or output from the computing device 1100. Such I/O devices may include, without limitation, one or more input devices, output devices, and/or environment transducer devices.

In one example, the input devices convert a human-generated signal, such as, human voice, physical movement, physical touch or pressure, and/or the like, into electrical signals as input data into the computing device 1100 via the I/O port 1108. Similarly, the output devices may convert electrical signals received from computing device 1100 via the I/O port 1108 into signals that may be sensed as output by a human, such as sound, light, and/or touch. The input device may be an alphanumeric input device, including alphanumeric and other keys for communicating information and/or command selections to the processor 1102 via the I/O port 1108. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some examples, the input device and the output device may be the same device, for example, in the case of a touchscreen.

The environment transducer devices convert one form of energy or signal into another for input into or output from the computing device 1100 via the I/O port 1108. For example, an electrical signal generated within the computing device 1100 may be converted to another type of signal, and/or vice-versa. In one example, the environment transducer devices sense characteristics or aspects of an environment local to or remote from the computing device 1100, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 1100, such as, physical movement of some object (e.g., a mechanical actuator), heating or cooling of a substance, adding a chemical substance, and/or the like.

In one example, a communication port 1110 is connected to a network by way of which the computing device 1100 may receive network data useful in executing the methods and systems set out herein as well as transmitting information and network configuration changes determined thereby. Stated differently, the communication port 1110 connects the computing device 1100 to one or more communication interface devices configured to transmit and/or receive information between the computing device 1100 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1110 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 1110 may communicate with an antenna or other link for electromagnetic signal transmission and/or reception.

The system set forth in FIG. 11 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

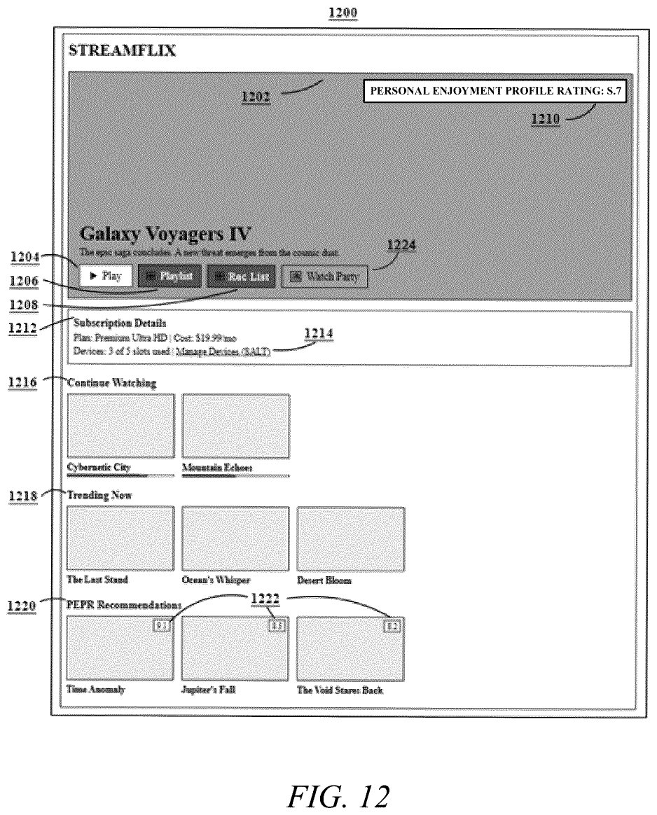

Referring now to FIG. 12, an example user interface 1200 for a SAAS portal is depicted. The user interface 1200 provide a centralized interface within the social SAAS manager application, allowing a user to browse, manage, and engage with content from a specific third-party SAAS provider to which they are subscribed.

The user interface 1200 may feature a prominent hero content section 1202, which showcases a featured movie, show, or other piece of media. This section 1202 includes interactive elements such as a play button 1204 to initiate direct playback, a playlist button 1206 to add the content to a user's cross-platform playlist, a rec list button 1208 to add the content to a user-created rec list, and a watch party button 1224 to initiate a synchronized, shared viewing session with other users. The hero content section 1202 may also display a personal enjoyment profile rating score 1210, which provides the user with a personalized, predictive rating indicating how likely they are to enjoy the content.

The interface 1200 may include a subscription details section 1212, which provides the user with at-a-glance information about their current subscription plan with the provider. The subscription details section 1212 may include a link 1214 to manage devices via the secure access listed trust manager 220, allowing the user to control which specific devices are authorized to access this subscription.

The interface 1200 may utilize one or more content carousels to organize and display media. For example, a “Continue Watching” carousel 1216 presents content that the user has previously started but not finished. A “Trending Now” carousel 1218 displays content that is currently popular on the SAAS provider's platform. A “Personal Enjoyment Profile Rating Recommendations” carousel 1220 displays content suggested to the user by the personal enjoyment profile generator 216. Each recommended item within this carousel may display its own thumbnail personal enjoyment profile rating score 1222, allowing the user to quickly gauge their potential interest in multiple pieces of new content.

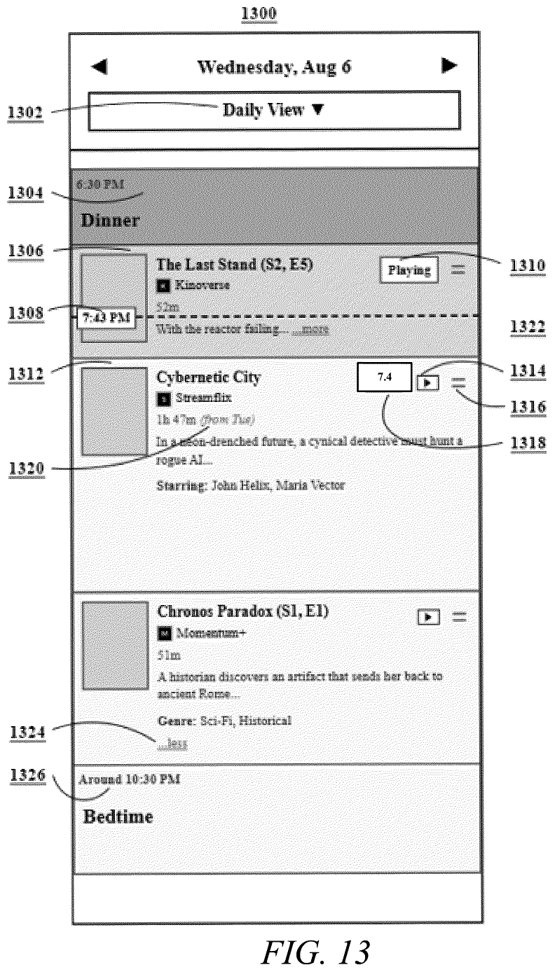

Referring now to FIG. 13, an exemplary user interface 1300 for the SAAS calendar planner 228 is depicted, shown in a daily view on a mobile device. The user interface 1300 may be accessible via any client device 102. This user interface 1300 provides the user with an intelligent and flexible timeline of their scheduled activities, seamlessly integrating personal events with planned SAAS content consumption. The user may select other timeframes, such as weekly or monthly, via a view selector button 1302.

The user interface 1300 displays a continuous, scrollable timeline of the user's day. The user interface 1300 may offer a visual distinction between events based on their temporal status, illustrated through a multi-tiered shading system. For example, events that have already occurred are shown as a past event card 1304 with the darkest shading. The specific content item that the user is currently engaged with is shown as a current event card 1306 with a medium shade. All subsequent scheduled items may be shown as future event cards 1312 with the lightest shading.

A current time indicator 1308, represented as a dashed line with a time label, moves down the timeline in real-time. The current time indicator 1308 may provide an at-a-glance view of the user's progress through their day. When the indicator intersects with a content item, as it does with the current event card 1306, the vertical position within the card visually represents the progress of consumption.

The user interface 1300 is designed to be fluid and adapt to the user's actions. Playback of scheduled content is not automatic; the user manually initiates a viewing session. The current event card 1306 displays a “Playing” indicator 1310 to show an active session. In contrast, future event cards 1312 feature a play button 1314, allowing the user to start playback from any point in their planned playlist. If a user initiates playback at a time different from the original schedule, the user interface dynamically adjusts the position and height of all affected event cards. One or more subsequent event times, including the calculated start time for the “Bedtime” event 1326, can be automatically recalculated and updated.

Content items are displayed as individual, interactive cards, demonstrating the Cross-platform Playlist functionality by seamlessly integrating content from various SAAS providers (e.g., Kinoverse, Streamflix, Momentum+) into a single, cohesive schedule. The height of each card is proportional to the content's runtime, providing a visual representation of its duration. Each card can be populated with metadata and may include a grabber icon 1316, indicating that the user can manually reschedule the item by dragging and dropping it to a different time or day. The content card may also include its personal enjoyment profile rating 1318 if both the content and the user have met the minimum rating thresholds to estimate a rating for the user. The system can also automatically reschedule unwatched content, as shown by the reschedule indicator 1320 on the “Cybernetic City” card.

The user interface 1300 also features an adaptive metadata display. For content cards with limited vertical space, a truncated description 1322 is shown, followed by a “ . . . more” button. For cards with more space or when expanded by the user, a full description 1324 is displayed, which may include further details such as “Starring” and “Genre,” along with a “ . . . less” button to collapse the view.

Referring now to FIG. 14, a flow diagram of an example method 1400 for secure data sharing between a primary user and a shared user is depicted. The method 1400 illustrates the end-to-end, zero-knowledge encryption process facilitated by the data manager 206. This process ensures that the platform's central servers never have access to unencrypted user data.

The method 1400 includes storing 1402, a sensitive data item, (e.g. a SAAS subscription password) in the primary user's personal user data storage 250. The data is stored in an encrypted state, having been encrypted with the primary user's public key (Primary_PK). The method 1400 further includes initiating 1404, a share request to a shared user via a client device 102 of the primary user. The method 1400 further includes obtaining 1406, by the client device of the primary user, the sensitive item, wherein the sensitive item is encrypted. The method 1400 further includes decrypting 1408, the data on the primary user's client device 102. This decryption is performed using the primary user's secret key (Primary_SK), which is securely stored on and only accessible by the primary user's device. At this stage, the data exists momentarily in its plaintext form, but only within the secure environment of the primary user's client application. The method 1400 further includes re-encrypting 1410 the sensitive data using a public key into an encrypted data packet. In some instances, the public key is the shared user's public key (Shared_PK). In some instances, the public key is retrieved from the user database 252. The method further includes transmitting 1412 the encrypted data packet to a client device of the shared user. The encrypted data packet is only decipherable by the shared user's private key. The encrypted data packet is transmitted from the primary user's client device over the network 112. The social SAAS server 108 acts as a secure conduit but cannot decrypt the information. Finally, the method 1400 includes decrypting 1414, the encrypted data packet including the sensitive data at the shared user's client device using a private key of the shared user. The private key may be the shared user's own unique private key (Shared_SK).

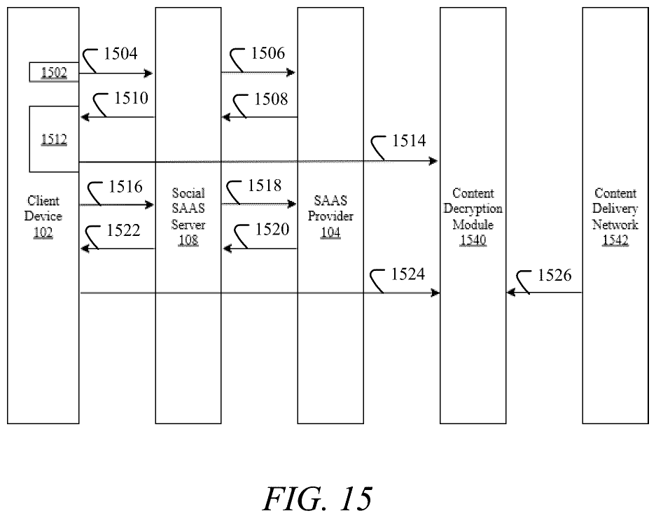

FIG. 15 illustrates an example method 1500 for securely playing Digital Rights Management (DRM) protected content, detailing the multi-step handshake process that enables an integrated universal media player on a client device 102 to render content from a third-party SAAS provider 104. This sequence ensures that the social SAAS manager 110 can facilitate a seamless viewing experience while maintaining a robust security posture where the platform itself never has access to unencrypted content or the final decryption keys. The process orchestrates communication between the client device 102, the social SAAS server 108, the SAAS provider 104, a local Content Decryption Module (CDM) 1540 of the client device 102, and a Content Delivery Network (CDN) 1542 of the client device.

The method 1500 is initiated when a user on a client device 102 requests to play a piece of content at step 1502. The client device 102 sends this request to the social SAAS server 108 at step 1504, which then acts as a secure broker. At step 1506, the social SAAS server 108 forwards an authenticated request to the SAAS Provider 104 to retrieve the playback metadata. The SAAS provider 104 returns this metadata, which includes important information such as the media manifest URL and the DRM license server URL, to the Social SAAS Server 108 at step 1508. This metadata is then securely relayed back to the client device 102 at step 1510, equipping the player with the initial information to begin the DRM process.

Upon receiving the metadata, the integrated media player on the client device 102 fetches and parses the media manifest at step 1512, identifying that the content is encrypted and extracting the DRM initialization data. Following this, at step 1514, the SAAS provider 104 interacts with the client's native CDM 1540 to generate an encrypted license request. This request is then sent from the client device 102 back to the social SAAS server 108 at step 1516. The social SAAS server 108 continues its role as an intermediary, forwarding this license request along with the user's authentication token to the SAAS provider's 104 DRM license server at step 1518.

In the final phase of the handshake, the SAAS provider's 104 license server validates the brokered request and returns an encrypted content license to the social SAAS server 108 at step 1520. The server, in turn, relays this encrypted license back to the client device 102 at step 1522. At step 1524, the client device 102 passes the license to the CDM 1540, which now possesses the keys to decrypt the media. With the secure handshake complete, the encrypted content begins streaming from the CDN 1542 to the CDM 1540 at step 1526. The CDM 1540 decrypts the content on-the-fly, frame by frame, just before it is rendered to the user's screen, enabling secure and authorized playback.

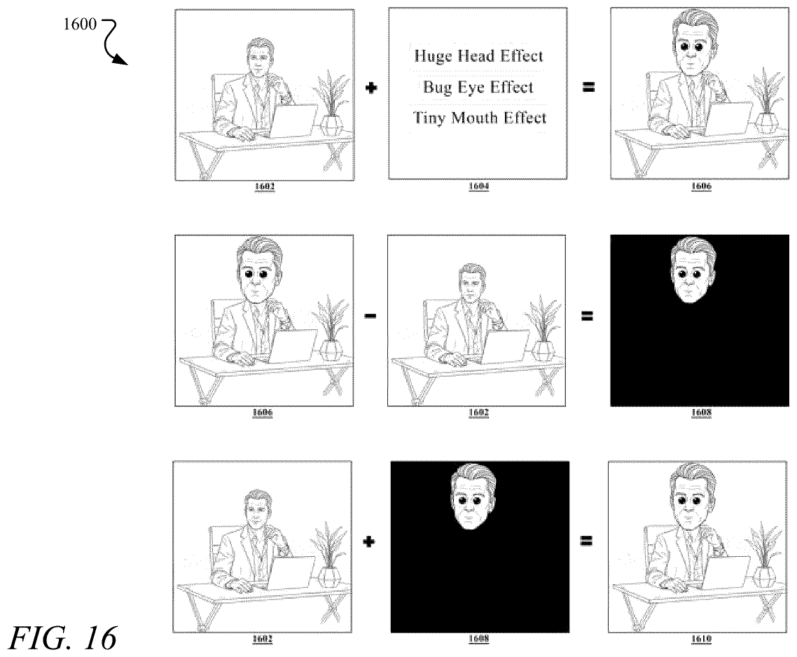

Referring now to FIG. 16, a flow diagram is depicted of an example method 1600 for generating and applying a non-destructive, streaming content overlay. In some instances, the method 1600 may be carried out by the integrated media player 234 and/or the integrated media editor 236. The method 1600 ensures that a creator's additive modifications are captured in a separate file, which is then composited with the original content by the end-user's integrated media player 234.

The method 1600 begins with an original content frame 1602, which represents a single, unaltered frame from the primary SAAS content that the creator is using as a reference. Within the integrated media editor 236, the creator applies one or more effects 1604, such as visual filters or distortions. The system renders these effects in combination with the original content frame to produce a modified frame 1606. The modified frame 1606 represents the final desired visual output as seen within the editing environment. It should be understood that while a visual modification is depicted, similar differential analysis techniques can be applied to audio tracks, such as isolating a new vocal performance from a mixed audio source.

The method includes a differential analysis of the modification and the original content. For example, the system programmatically “subtracts” the pixel data of the original content frame 1602 from the pixel data of the modified frame 1606. The result of this analysis is the isolated overlay file 1608. This distinct, lightweight file contains only the pixel data corresponding to the additive enhancements, rendered onto a transparent or black background, and contains none of the original copyrighted content.

In the final step, the integrated media player 234 receives two separate streams: the original content frame 1602 and the isolated overlay file 1608. The player composites these two streams in real-time, layering the overlay on top of the original content to produce the final composite frame 1610 on the user's display. To take advantage of current media compression codes that may lack native transparency support, this compositing may be achieved using a luma matte technique, where the overlay stream is composed of two video files: one stream defines color and a second grayscale stream defines opacity. However, as technology evolves, other video opacity and transparency techniques, such as a single stream with a true alpha channel, may be used. This overall method allows for significant creative enhancements without ever altering the original source material.

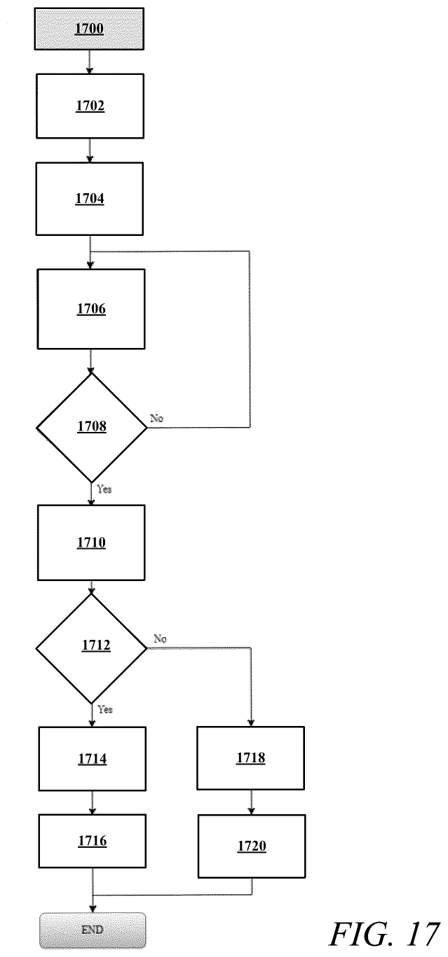

Referring now to FIG. 17, a flowchart depicts an example process flow 1700 for the contextual interest management process, which creates a seamless journey for a user from initial content discovery, whether through advertising, organic encounter, and/or physical-world scanning, to actionable execution based on real-world context.

The process begins at step 1702, where a user discovers content they are interested in. This can occur through interaction with an augmented advertisement containing an interface element (e.g. a “maybe” button), or by encountering content objects (e.g. recipes, products, media, etc.) within the platform's ecosystem or by scanning a machine-readable code (e.g. QR code, etc.) on a physical advertisement. The user signals their interest by engaging the interface element and/or the automatic execution of a deep link intent capture routine initiated by scanning a machine-readable code. At step 1704, the system may create a specific interest object within the user's profile in the universal interest database. The interest object may include an entity identifier and/or a contextual trigger definition. If the interaction originated from a paid advertisement, the system may apply a rule (e.g. an ad frequency suppression rule). This step may actively update the ad delivery engine to prevent or reduce subsequent impressions of the same advertisement to the user. This may signal a shift in the monetization model from Cost Per Mile (CPM) to Cost Per Action (CPA).

At step 1706, the contextual interest manager 230 maybe begin to actively and/or periodically monitor extrinsic data streams relevant to the stored interest object. This automated process may evaluate diverse and/or real-time variables, including, but not limited to, geospatial location data, temporal windows, pricing API's, inventory status feeds, and/or content catalog availability. A decision may be made at step 1708 to determine if the contextual trigger definition for an interest object has been satisfied. For example, the system may evaluate whether a release date has been reached, if the user has entered a defined geofence during operating hours, or if a price drop threshold has been met. If the trigger conditions are not met, the process may return to the monitoring step 1706.

If a contextual trigger is satisfied, the process may proceed to validation. At step 1710, the system may validate the entity's status against the user profile and/or external data sources. This may involve cross-referencing linked subscriptions, verifying restaurant operating hours, confirming product inventory, etc. A second decision may be made at step 1712 to determine if the entity is actionable and/or accessible by the user. If the user has the necessary subscription access, the venue is open, or the item is in stock, the process may follow the “yes” path. If there is an access gap (e.g. missing subscription, item out of stock, etc.) the process may follow the “No” path.

Following the “yes” path, at step 1714, the user may receive a notification informing them of the actionable opportunity (e.g. “you are near {restaurant} and they have a table available,” or “the movie you tracked is now available on your service”). Subsequently, at step 1716, the system may interact with the SAAS Calendar Planner to provisionally populate the content and/or event into a slot in the user's schedule. This may ensure a seamless transition from latent interest to active planning.

Following the “No” path, at step 1718, the system may generate a notification informing the user of the opportunity despite the current access gap (e.g. “exclusive on {service}” or “flash sale alert”). At step 1720, this notification is accompanied by a call to action to resolve the access gap. The system may present the user with a direct option/options to subscribe to the service via the Social SAAS Marketplace, initiate a purchase transaction, request the item as a gift from a high-trust contact, etc. This may create a frictionless opportunity to convert latent interest into a transaction. The process concludes at step 1722.

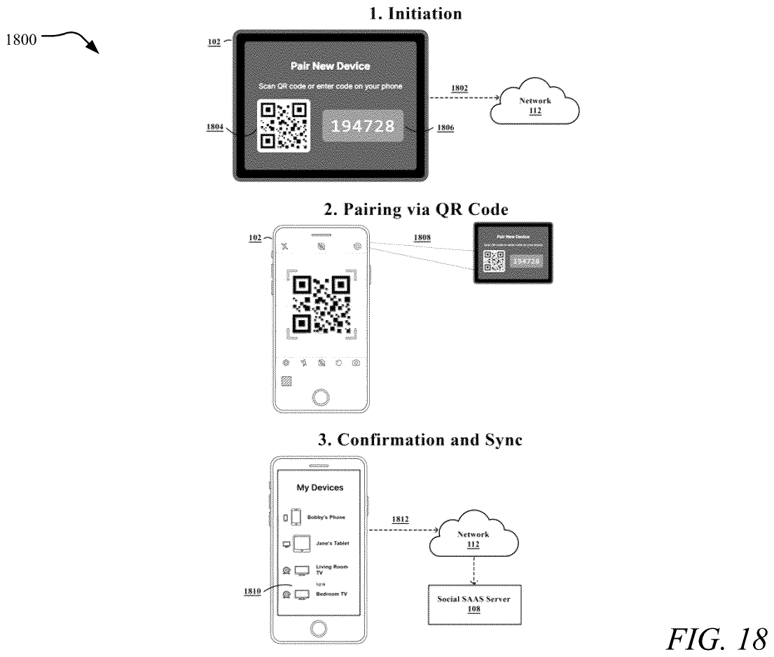

Referring now to FIG. 18, a diagram depicts an example process 1800 for pairing a TV companion application with a primary management application on a mobile device (e.g. user device 102). This process 1800 securely adds a TV as a whitelisted device to the user's centralized account. To initiate the process, a user launches the companion application on a Smart TV (e.g. client device 102). The application then initiates two concurrent actions: it starts a broadcast discovery service 1802 (e.g., via mDNS or SSDP) on the local network 112 to allow other devices to detect its presence, and it displays a pairing interface containing a unique, time-sensitive QR Code 1804 and a corresponding numeric code 1806.

Then the user opens the primary management application on their mobile device (e.g. client device 102) and selects an “Add Device” option. For mobile devices, the primary method involves activating the device's camera to scan the QR code 1804. This QR code securely encodes the TV's essential local network information, including its IP address and a temporary, time-sensitive authentication token. Upon scanning, the mobile device uses this information to establish a direct, Secure Local Connection 1808 with the TV companion app, which is an encrypted TCP/IP socket further secured via a protocol such as TLS/SSL.

Alternatively, for users on a computer or those who prefer not to use a camera, the numeric code 1806 can be manually entered into the primary management application. This code serves as the same authentication token and is transmitted over an encrypted channel—either directly over the local network if the TV was discovered, or relayed via a secure API call to the social SAAS server 108—to complete the authentication.

Upon successful authentication via either method, the TV's unique device identifier is transmitted to the primary management application. The UI on the primary device updates to show a newly added device 1810 in the user's list of managed devices. This information is then synced 1812 with the central social SAAS server 108, which updates the user's master account to officially register the TV as a trusted device. Once registered, the TV becomes available within the secure access listed trust menu for assignment to specific SAAS subscriptions.

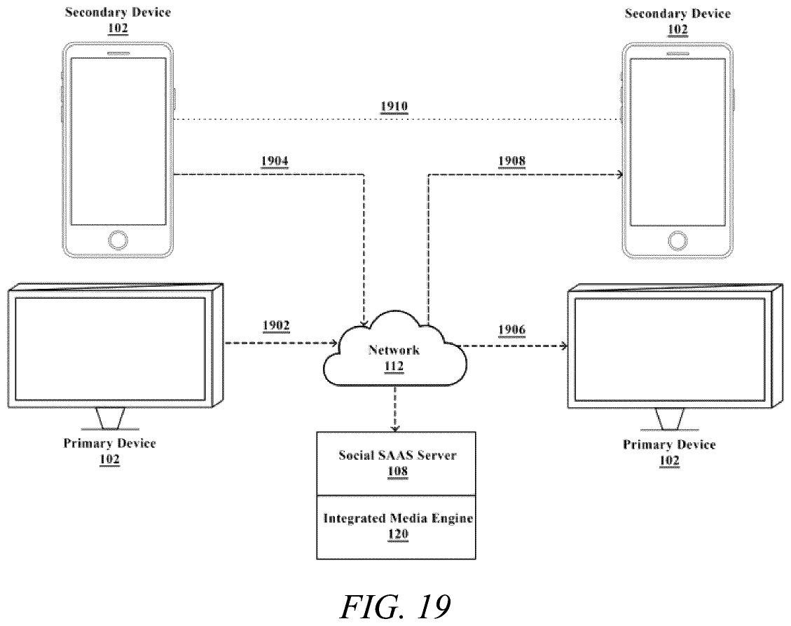

Referring now to FIG. 19, an example system architecture diagram illustrates an example of the video call watch party feature. This diagram depicts how multiple users in different physical locations can participate in a synchronized, shared media experience by leveraging a distributed architecture that coordinates playback on primary viewing devices with a real-time video conference on secondary devices.

In this example, the social SAAS server 108 is in communication with the Integrated Media Engine 120. The social SAAS server 108 may manage the watch party session, authenticate participants, and/or act as the authoritative source for the playback state of the primary SAAS content. The diagram shows two participants: User 1 (Host) and User 2 (Participant), each with a primary device 102 (e.g., a smart TV) for SAAS content playback and a secondary device 102 (e.g., a mobile phone) for the video conference.

The host's primary device 102 sends playback commands 1902 to the server 108, which relays them 1906 to participants. Simultaneously, secondary devices 102 exchange video/audio streams, either directly via a P2P connection 1910 or relayed through the server 1904, 1908.

The system is architected with a flexible, hybrid communication model that prioritizes peer-to-peer (P2P) connections for the video conferencing component to minimize server load and data egress costs, unless a server-centric model is absolutely necessary. For small watch parties, the integrated media engine 120 acts as a signaling server to broker the initial P2P connection between the secondary devices, using protocols like WebRTC. Once established, the P2P Video/Audio Stream 1910 is transmitted directly between the client devices.

To maintain the efficiency of the P2P model even in larger parties, the system employs dynamic adaptation of video streams. The system allows all participants to communicate via audio or text, while limiting the number of simultaneous video streams to what a standard device can process. This limit is determined by the processing capabilities of the client device's hardware decoder. The selection of which participants are “on camera” can be managed in different ways. For example, it could happen automatically through an active-speaker algorithm that prioritizes the video feed of the person currently talking. Alternately, it could be a manual decision by the host. The host can be given controls to choose which participants are featured on video, a decision that could be based on personal preference, the participant's network connection quality, or even as part of a monetized creator-fan interaction (e.g., via a crowdsourced membership structure).

Only in scenarios where P2P is not viable—such as for very large-scale events or due to restrictive network firewalls—does the system fall back to a server-centric model where the Integrated Media Engine 120 functions as a Multipoint Conferencing Unit (MCU) or Selective Forwarding Unit (SFU). In this case, the server acts as an intermediary. Each secondary device sends its video stream to the server as an uplink transmission 1904, and the server then distributes this stream to all other participants as a downlink transmission 1908.

Regardless of the video conferencing method, the social SAAS server 108 always remains the central authority for media synchronization. The host's primary device sends playback commands & sync pulse 1902 over a persistent, low-latency connection (e.g., a WebSocket) to the server. The Integrated Media Engine 120 immediately relays these playback commands 1906 to all participant primary devices to ensure frame-perfect, synchronized playback of the SAAS content.

In one example, the video streams of participants are rendered as thumbnail overlays on each user's primary viewing device. To create a more natural and engaging social experience in this configuration, the system can apply an optional gaze correction filter to the video streams, adjusting the pupils of a user's eyes to make it appear they are looking directly at the camera on their secondary device, rather than at the primary screen.

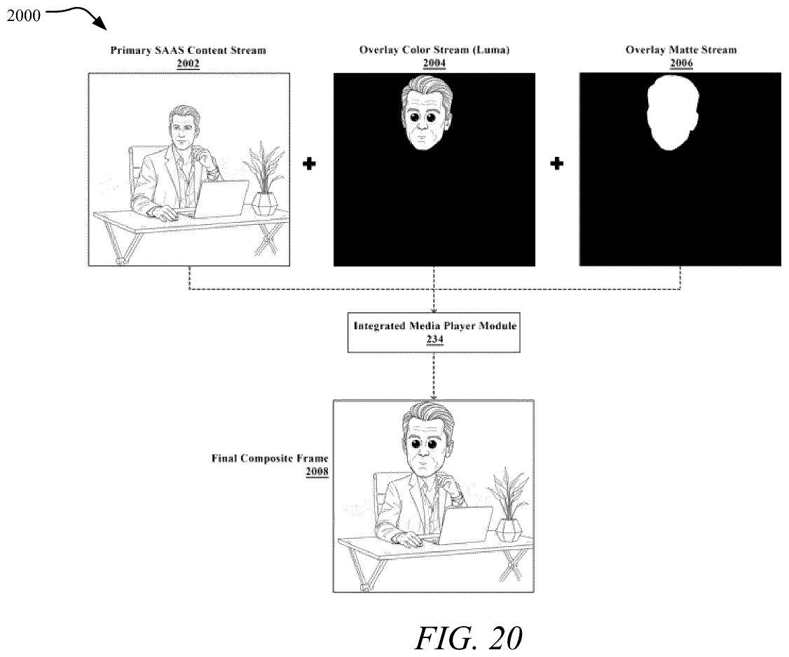

Referring now to FIG. 20, a diagram illustrates an example real-time compositing process 2000 performed by the integrated media player 234 to render a final, layered viewing experience for the user. This process enables the non-destructive overlay of a companion stream onto primary SAAS content by combining multiple, separate video streams on the client device. In some instances, the process leverages a luma matte technique, which is highly efficient for streaming as it works with standard video codecs that may not support a true alpha (transparency) channel.

In the present example, the integrated media player 234 receives three distinct, synchronized streams as inputs: the primary SAAS content stream 2002, which is the original, unaltered, and DRM-protected media from the third-party SAAS provider; the overlay color stream (Luma) 2004, which contains the color information of the creator's additive content rendered against a black background; and the overlay matte stream 2006, a corresponding grayscale video track that defines the transparency of the overlay, where white areas represent full opacity and black areas represent complete transparency. The integrated media player 234 (in come examples, operating on the user's client device 102) is architected to decode and composite these multiple streams simultaneously. It uses the grayscale information from the overlay matte stream 2006 as a mask to determine which parts of the overlay color stream 2004 should be rendered on top of the primary SAAS content stream 2002. The result of this real-time compositing is the final composite frame 2008, which is the single, layered image ultimately displayed on the user's screen.

This method ensures that the original source material remains unaltered, and the overlay exists as a distinct, additive enhancement that the user can enable or disable, thereby constituting a new creative work. While the luma matte technique is one example, it is contemplated that as video codec technology evolves, this compositing could be achieved with a single overlay stream containing an integrated alpha channel.

It should be understood that the process depicted in FIG. 20, which exemplifies the application of a facial distortion filter, is only one example of the multitude of ways the companion stream can be utilized. The same fundamental compositing technique can be applied to render various other types of overlays. In other examples, a companion stream may consist of a creator's video commentary displayed in a small thumbnail in the corner of the screen, which a user can select from a marketplace of available commentary tracks. In another example, the overlay streams could be the real-time video feeds of participants in a video call watch party, allowing users to see their friends' reactions layered directly onto the primary content. This compositing method is also fundamental to the personalized AI casting feature, where the overlay streams contain a user's AI-generated likeness and synthesized voice, which are layered over the original actor's performance. In all such cases, the core process of combining a primary stream with one or more additive overlay streams to create a final composite frame remains the same.

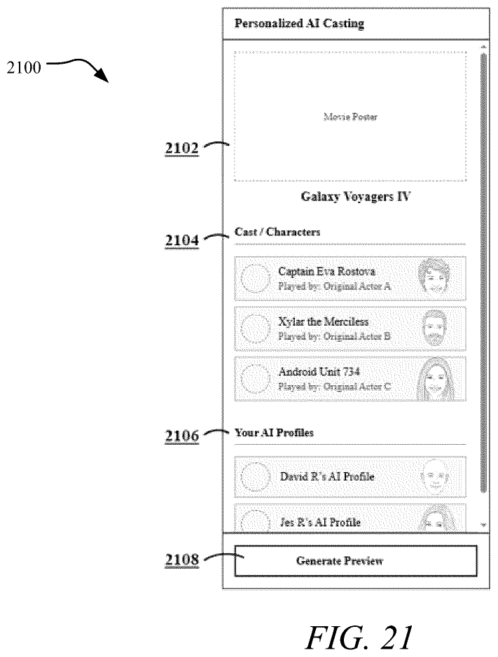

Referring now to FIG. 21, an example user interface 2100 for personalized AI casting is depicted, illustrating the user workflow for recasting a role in a piece of SAAS content. The interface 2100 may be managed by the AI casting manager 242 and is designed to provide a simple and intuitive process for creating a hyper-personalized viewing experience.

The interface 2100 includes a main content area 2102 displaying information about the selected SAAS content, In the present example the main content area 2102 may display information relating to “Galaxy Voyagers IV,” which may include a poster image and title. Below this, a cast list 2104 is presented, showing the characters in the film and the original actors who portrayed them. Each entry in the cast list serves as a target for the recasting action.

A separate section displays the user's available AI profiles 2106. These profiles may have been previously created and stored in the AI profile database 262. The AI profiles 2106 represent the AI-generated likenesses of the user and any contacts who have granted them permission. Each profile is displayed as a distinct, interactive element.

In some examples, a user initiates a recasting action from the user interface 2100 by selecting an AI profile from the available list and dragging it onto a specific character in the cast list 2104. This drag-and-drop motion signifies the user's intent to replace the original actor's performance with the selected AI-generated likeness for that specific role.

Upon completion of the desired casting assignments, the user can select the “Generate Preview” button 2108. This action instructs the AI casting manager 242 to begin processing the request. This generates an AI casting sample for a short portion of the selected media, allowing the user to review the quality of the rendered overlay and decide if they are satisfied with the result. After viewing the preview, the user is presented with a subsequent option to proceed with recasting the entire piece of media, which may, if applicable, initiate a payment for the service.

Furthermore, once the full-length recast overlay has been generated, it becomes a new, distinct media asset. The user who created it, as well as any other user they grant explicit access to, can import this overlay file into the integrated media editor 236 for further modification. This allows for post-generation adjustments to perfect the final product. For example, a user could manually adjust the positioning of a facial mask in a specific scene where the automated tracking was imperfect, or correct an audio synchronization issue. This also allows a user to fix errors that may have originated from the source metadata, such as a scene where the chosen actor was present but was mistakenly omitted from the pre-generated mask data, resulting in a gap in the overlay. This transforms the AI-generated overlay from a static output into a fully editable piece of user-owned media.

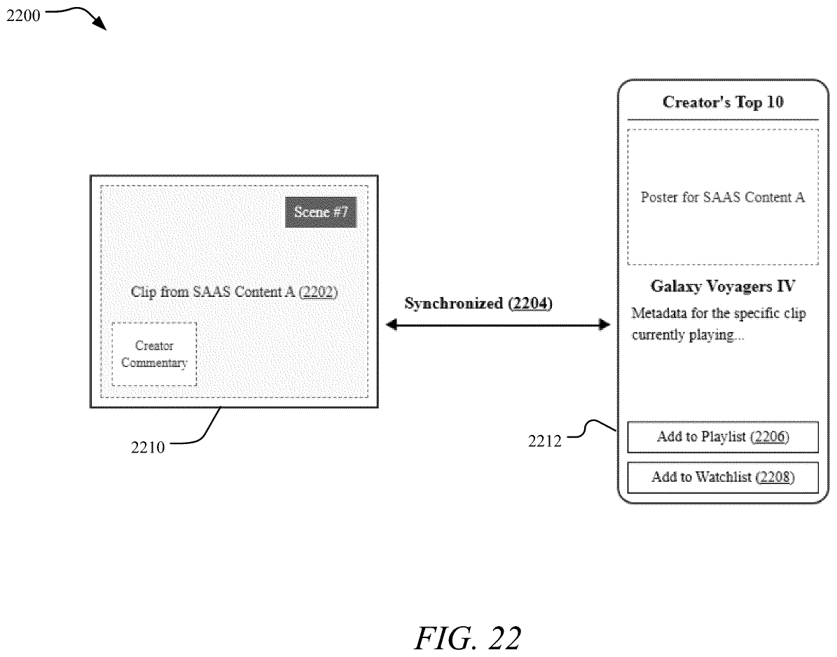

Referring now to FIG. 22, a diagram illustrates an example “medley” stream dual-screen user experience 2200. This feature leverages a synchronized connection 2204 between a primary device 2210 and a secondary device 2212. Each of the primary device 2210 and the secondary device 2212 may be any client device, for example, client device 102 in FIG. 1. In one example, the primary device 2210 is a viewing device and the secondary device 2212 is an interactive device. The medley stream dual-screen user experience 2200 transforms a passive viewing session into an active and frictionless engine for content discovery and curation.

The primary device 2210 (e.g. a smart television) is shown displaying a clip from a piece of SAAS content 2202. This is not the full content, but a specific segment programmatically selected as part of a creator's curated “medley” Companion Stream, such as a “Top 10 Funniest Scenes” list. A screen of the primary device 2210 may also display the creator's own overlay, such as a commentary video or a scene number indicator.

Simultaneously, the secondary device 2212 (e.g. a mobile phone) functions as an interactive hub. A user interface, managed by the primary management application, dynamically updates to display a rich metadata card corresponding to the specific SAAS content clip 2202 currently playing on the primary device 2210. This card can include the content's poster, title, and description, but is also capable of displaying other dynamic features. For example, the card may display a personal enjoyment profile rating, providing the user with a personalized prediction of their enjoyment. The appearance of the personal enjoyment profile rating score can be state-aware; for instance, it may be displayed in one color if the user has not seen the content, and a different color if the user has seen the content but has not yet rated it. If the user has both seen and rated the content, the card would instead display the user's own rating, providing immediate personal context.

The user interface displayed on the secondary device 2212 includes one or more interactive buttons. A user who is intrigued by the clip playing on the primary screen can, without interrupting playback, select an “Add to Playlist” button 2206 or an “Add to Watchlist” button 2208. Selecting one of these buttons sends a command and the relevant content metadata directly to the appropriate component, such as the cross-platform manager 226. This allows the user to seamlessly capture their interest in the full piece of content for future viewing. This entire dual-screen experience is orchestrated by timestamped commands embedded within the companion stream's data track, which are interpreted in real-time by the social SAAS manager applications running on both devices.

The present disclosure introduces a system for dynamic subscription tier management which provides a framework designed to offer a flexible, usage-based alternative to the rigid, binary subscription models prevalent in the SAAS industry. In some instances, this system is architected to be as a premium feature deeply integrated within the Platform's ecosystem. In another example, the system is deployed as a standalone, licensable software that a SAAS provider can integrate directly into their own technical infrastructure. The system addresses the need for a middle ground between costly, unlimited ad-free plans and entirely ad-supported experiences by introducing a quantifiable usage allowance for each subscription account for a given billing period. This total allowance amount is determined and controlled by the SAAS provider based on the terms of their subscription tier; the platform or the integrated software simply acts as the technology to enforce these provider-defined business rules. This allowance can be measured by various metrics, including but not limited to, total viewing time, data egress, or a combination thereof. In one example, the system implements a gamified layer to reframe the consumption limit as a manageable resource, where the usage allowance is represented as a form of in-app currency, such as “tokens” or “tickets”.

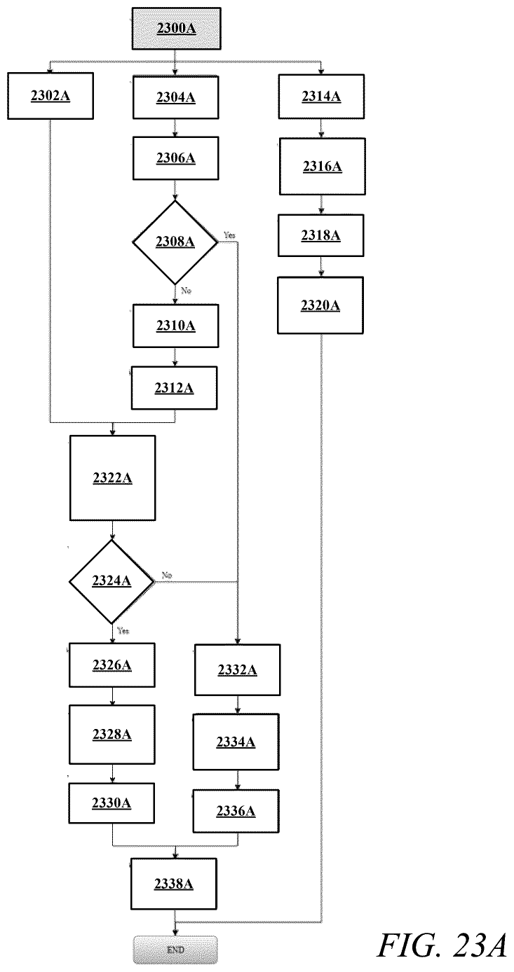

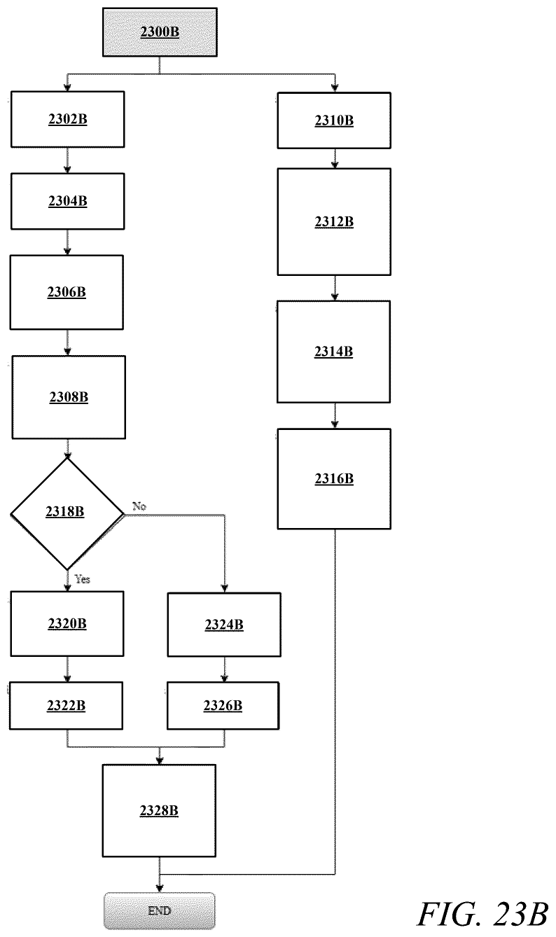

Referring now to FIG. 23A, a flowchart of an example method 2300A for platform-hosted dynamic subscription tier management is depicted. In this example, a server (e.g. social SAAS server 108) acts as the central logic and data management hub for enforcing the provider-defined business rules. The process features two distinct initiation paths that converge for allowance processing.

The first path begins at step 2302A when a user selects a piece of content in the platform. The second path begins at step 2304A when a user selects a piece of content on a SAAS provider's native application or website. At step 2306A, the provider's server sends an inbound API event with details of the selected content to the Platform's server, establishing the Platform as the intermediary for managing the consumption event.

At step 2308A, a determination is made as to whether a subscription-level setting, such as “Native App Playback Defaults to Ad-Supported,” is enabled. This setting provides the primary user of a shared account with ultimate control over how the shared allowance is consumed. If this setting is enabled, the process follows the “Yes” path, bypassing the allowance deduction logic and proceeding directly to step 2332A, where the system sets or confirms the specific user's status as “Ad-Supported” in the database.

If the default setting is not enabled, the process proceeds to step 2310A, where the platform performs user attribution. This step is an important component for managing shared subscriptions, as the provider's system may only recognize a single account, while the Platform must attribute the consumption to a specific individual user sharing that account. This attribution is achieved through a direct dependency on the data provided by the secure access listed trust manager 220. The inbound event from the provider contains a device identifier, which the platform cross-references against the secure access listed trust manager 220 records. The secure access listed trust manager 220 maintains a user-defined whitelist that maps specific devices to specific users for each subscription. By performing this lookup, the Platform can accurately identify the individual user who is initiating the stream.

At step 2312A, the attributed user ID is attached to the activity event for processing. At step 2322A, the dynamic tier manager 246 retrieves, from the dynamic tier database 266, the provider-defined allowance cost for the selected content (e.g., number of tickets) and the specific user's current individual allowance balance.

A decision is made at step 2324A to determine if the specific user has a sufficient allowance balance to cover the cost of the content. If the user has sufficient allowance, the process follows the “Yes” path. At step 2326A, the allowance cost is deducted from the specific user's balance in the platform's database. At step 2328A, the platform sends an outbound API call to the streaming provider's server, instructing it to configure the stream for “Ad-Free” status. Ad-free playback then begins for the user at step 2330A.

If, at step 2324A, the user's allowance is insufficient, the process follows the “No” path. At step 2332A, the system sets or confirms the specific user's status as “Ad-Supported” in the database. At step 2334A, the Platform sends an outbound API call to the streaming provider's server, instructing it to configure the stream for “Ad-Supported” status. Ad-supported playback then begins for the user at step 2336A.

Regardless of the playback mode, at step 2338A, the SAAS activity manager 214 logs the consumption event. This log serves a dual purpose: it makes the event available for the user to rate as part of their personal enjoyment profile and provides a historical record of consumption.

The flowchart also depicts a parallel process for the automated replenishment of the allowance. At the start of a new billing cycle, shown at step 2314A, the platform initiates a verification and replenishment sequence. At step 2316A, the platform sends an API call to the provider's server to verify the current total account allowance for the subscription tier, ensuring the platform's records are synchronized with the provider's terms. At step 2318A, the Platform replenishes the total account allowance in its dynamic tier database 266. Finally, at step 2320A, this total allowance is distributed among the individual users sharing the account based on the allocation settings previously configured by the primary account owner.

Referring now to FIG. 23B, a flowchart of an example method 2300B for provider-integrated dynamic subscription tier management is depicted. This example represents a distinct commercial application, wherein the core logic is offered as a licensable software that a SAAS provider can integrate directly into their own backend infrastructure, allowing it to operate independently of the social platform. This model significantly expands the addressable market for the present disclosure beyond partners of the social platform, providing a valuable tool for any SAAS provider wishing to offer more flexible subscription tiers.

The process begins at step 2302B when a user selects content on the provider's native application or website. In a key distinction from the platform-hosted model, at step 2304B, the provider's own backend server initiates the dynamic tier management logic internally, without making an external API call to the platform.

At step 2306B, the provider's backend performs user attribution via its own internal device ID records against its own user records. At step 2308B, the provider's backend retrieves the content's allowance cost and the specific user's current allowance balance from its own internal database, not the platform's.

An internal determination is made at step 2318B within the provider's system as to whether the user has sufficient allowance. If the allowance is sufficient, the process follows the “Yes” path. The cost is deducted from the user's balance in the provider's own database at step 2320B, and ad-free playback begins at step 2322B.

If the allowance is insufficient, the process follows the “No” path. The user's status is set or confirmed as “Ad-Supported” within the provider's own database at step 2324B, and ad-supported playback begins at step 2326B.

At step 2328B, the provider's backend logs the consumption event in its own internal activity database for its own analytics and record-keeping purposes.

The billing cycle replenishment process is also handled entirely internally by the provider's systems. At the start of a new billing cycle, shown at step 2310B, the provider's backend performs an internal check against its own subscription management system to confirm the current total allowance for the user's tier at step 2312B. At step 2314B, it replenishes the total account allowance in its own database. Finally, at step 2316B, it distributes this total allowance among the individual users sharing the account based on the account owner's settings, which are also stored in its own database.

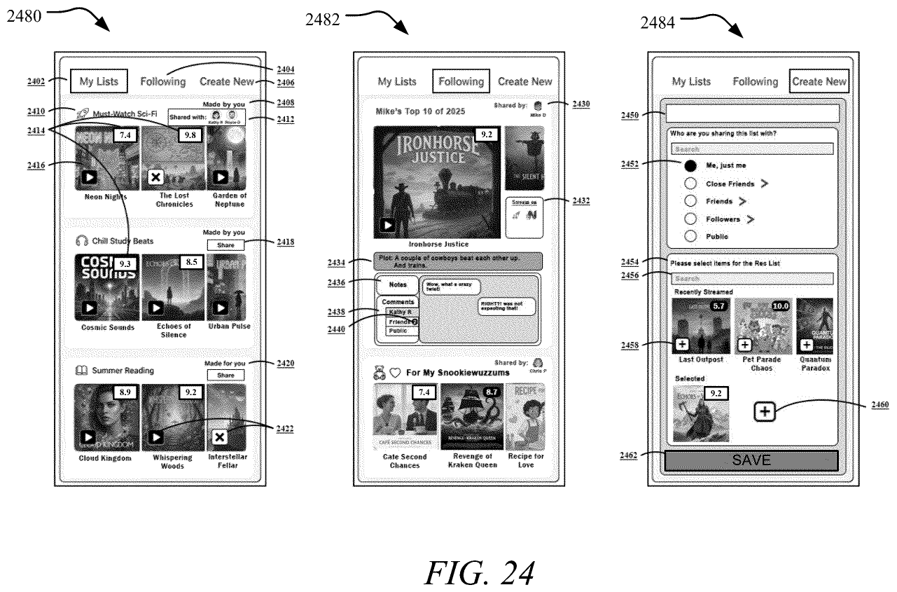

Referring now to FIG. 24, exemplary user interfaces 2480, 2482, 2424 for creating and managing recommendation lists (“rec lists”) are depicted. This feature provides a user-curated, shareable collection of content items designed for sharing themed recommendations and, for facilitating persistent, private conversations attached to specific pieces of content. The user interfaces 2480, 2482, 2484 represent the “rec room,” the dedicated central hub for users to interact with all the Rec Lists they have created or are following.

The interface includes several panels that facilitate the management and creation of these lists. The list overview panel on the left displays the user's collection of Rec Lists. This panel includes a navigation bar with tabs that allow the user to view “My Lists” 2402, lists they are “Following” 2404, or to “Create New” 2406. Each list is represented by an interactive card, with titles 2410 for the collections such as “Must-Watch Sci-Fi”, “Chill Study Beats”, and “Summer Reading”. Each list also contains information 2408 about who made the Rec List, such as, the user themselves, a friend of the user, or the Platform. These cards provide a preview of the content items 2416 contained within the list and may include a “Shared with” indicator 2412 that displays the audience with whom the list is shared.

Each user interface element is associated with a content item that is configured to dynamically alter its visual appearance to convey a plurality of distinct states related to a user's interaction with said content item. This provides a user with at-a-glance status information, enhancing the usability and intelligence of the interface.

In one example, as depicted by element 2414, this dynamic indicator can represent at least three distinct states of user engagement. A first state, indicating that the content has been neither streamed nor rated by the user, may be represented by a first visual style, this could be a white background with black text displaying a calculated personal enjoyment profile rating score. A second state, indicating that the content has been streamed by the user but has not yet been rated, may be represented by a second, distinct visual style. For example, this could be a black background with white text, still displaying the personal enjoyment profile rating score as a prompt for the user to add their own rating. A third state, indicating that the content has been both streamed and rated by the user, may be represented by a third visual style. For example, this could be a black background with a white number-only display, representing the user's own rating for the content.

Additionally, another dynamic indicator is depicted by element 2422, this icon changes display from a “play” button to an “X” based on whether the user viewing the Rec List is able to engage with the content item using the subscription accounts they've registered on the Platform. A “play” icon symbolizes that the content item is available on one or more of the subscriptions to which they have access. An “X” indicates that the user does not have access to that content item on any of their current subscriptions registered in the Platform. Clicking that content item will bring up a more detailed display with information including, but not limited to, genre, cast, plot, as well as which SAAS services have access to that content item as part of their subscription service.

It should be understood that other visual representations, including, but not limited to, changes in color, iconography, textual labels, overlays, or animated effects, may be employed to represent these or other user-interaction states without departing from the scope of the present disclosure. The present disclosure describes the use of a single, dynamic UI element to convey multiple, distinct states of user engagement with a piece of content, providing an efficient and intuitive visual language for the user.

The center panel provides a detailed view of a single, selected Rec List, in this example “Mike's Top 10 of 2025.” This view prominently displays the list's originator 2430. Each content item within the list features a play button, indicating the user can stream it, and an overlay 2432 that confirms which of the user's registered streaming services provides access to that specific content. This user interface provides an expanded view for a content item, revealed after the user has tapped on it, showing additional details such as the content's plot summary 2434. It also presents the content item notes 2436, which are personal annotations made by the user, accessible only to them and strictly private from other followers or contacts.

The dynamic content comments section 2438 facilitates persistent, context-specific conversational threads. Within this section, a user can initiate private conversations with selected friends or custom friend groups from their contacts, directly linked to this specific content item. This allows for focused discussions, such as chatting with a friend who originally recommended the content, or priming a specific audience group after sharing a Rec List that includes this item. These content comments 2438 may also display the quantity of unread comments 2440 within the user's narrower, personalized contacts network, providing an immediate indication of active discussions relevant to the user. This architecture directly addresses the problem of social ephemerality by transforming fleeting suggestions into lasting social objects with durable and easily retrievable associated context and conversations.

The panel on the right depicts the user interface for creating or editing a rec list. This interface includes a field for the list title 2450 and a set of granular sharing controls 2452, which allow the user to select a specific audience with exemplary options including “Me, just me,” “Close Friends,” “Friends,” “Followers,” and “Public.” Below these settings is the content selection area 2454, offering several methods for populating the list. A user can either search for content 2456 or, as a key feature of convenience, select from a list of their most recently streamed items 2458. This design choice recognizes that users are most likely to recommend content while it is fresh in their minds, providing an efficient workflow for immediate recommendations.

For more comprehensive browsing of their viewing history, the user can tap the “plus” button 2460. This action navigates the user to their personal enjoyment profile overview. By default, the personal enjoyment profile overview presents a chronological listing of the user's entire viewing history, allowing for easy selection of any previously watched content. The user can also apply additional sorting and organizational methods within the personal enjoyment profile to quickly find specific items from their past to add to the rec list. After populating the list and configuring its settings, the user finalizes the process by selecting the “save” button 2462.

The recommendation list (which may be generated by recommendation generator 248) is deeply integrated into the platform's broader ecosystem, leveraging and interacting with numerous other components to create a seamless experience. Content items for inclusion in a rec list can be sourced from various locations within the platform, including from a user's personal enjoyment profile, directly from any of the third-party SAAS portals, or from the results of a platform-wide content search.

The feature leverages the platform's layered permission model to provide contextual information. For instance, if a list creator has been granted permission to view a recipient's personal enjoyment profile, the system can automatically query that data to display the recipient's real-time consumption status for each recommended item, providing the creator with passive feedback on their suggestions. The sharing of lists is facilitated by the user contacts manager 208 and messenger 210, which enforce the privacy rules set by both the sender and the recipient.

Furthermore, the system provides recipients with granular control over their own content consumption pipeline. A recipient of a rec list can apply private tags, such as “Backburner,” to individual recommendations. This private tag programmatically flags the content to be ignored by the automated cross-platform manager 226 and/or SAAS calendar planner 228. This sophisticated interaction between the social recommendation features and the platform's core scheduling and playback automation ensures that a user's automated playlists are not populated with deprioritized suggestions, giving them ultimate control over their viewing schedule without creating social friction.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined in blocks differently in various implementations of the disclosure or described with different terminology. These and other variations, modifications, additions, and improvements may fall within the scope of the disclosure as defined in the claims that follow.

What is claimed is:

1. A system for managing shared access to a program, the system comprising:
a server comprising one or more processors and a memory storing:
a data manager storing a credential for the program associated with a first user, receiving a request to share the program with a second user, and transmitting the credential to a client device of the second user, wherein the credential is encrypted; and
an access manager associating an access mechanism of the second user with the program and initiating an access transaction from the second user to the first user according to an access-sharing agreement for the program.

2. The system of claim 1, wherein transmitting the credential further includes a client device of the first user decrypting the credential using a private key of the first user, and re-encrypting the credential using a public key of the second user prior to transmission.

3. The system of claim 1, further comprising a user contacts manager assigning a trust status to a connection between the first user and the second user, the data manager transmitting the credential if the second user has a high-trust status.

4. The system of claim 1, wherein the access manager initiates the access transaction by sending an authenticated request with a secure access token to a data aggregation service provider.

5. A system comprising:
at least one processor and at least one memory;
a user manager storing a master list of authenticated client devices associated with a user; and
a program manager retrieving, from a provider of a program, a rule including a number of allowable devices for a program, presenting the master list of authenticated client devices to the user, receiving a selection of one or more authenticated client devices from the master list of authenticated client devices to create a whitelist, wherein the selection does not violate the rule, and transmitting the whitelist to the provider in a data format configured to be ingested by an authentication module of the provider to enforce the whitelist.

6. The system of claim 5, the system further comprising:
an access manager associating an access mechanism of at least one of the one or more authenticated client devices and initiating an access transaction from a user of at least one of the one or more authenticated client devices to the user according to an access agreement for the program.

7. The system of claim 6, wherein the access manager initiates the access transaction by sending an authenticated request with a secure access token to a data aggregation service provider.

8. The system of claim 5, wherein the program manager provides access to the program to at least one of the one or more authenticated client devices by utilizing an Application Programming Interface (API).

9. The system of claim 5, wherein the program manager utilizes a multifactor authentication to register a device of at least one of the one or more authenticated client devices with the program.

10. A method comprising:
generating a first user profile corresponding to a first user, wherein the first user profile includes user data corresponding to at least one program and permissions data;
obtaining a request to share a portion of the user data corresponding to the at least one program with a second user;
determining, based on the permissions data, whether the second user is allowed access to the at least one program; and
upon determining that the second user is permitted access to the at least one program, sending the second user the portion of the user data corresponding to the at least one program.

11. The method of claim 10, wherein the portion of the user data includes at least one of a login credential corresponding to the at least one program.

12. The method of claim 10 further comprising:
revoking the access to the at least one program based on an update to the permissions data.

13. The method of claim 10 further comprising:
obtaining, from the second user, a second access mechanism;
associating the second access mechanism with the at least one program; and
processing an access transaction to the first user corresponding to the at least one program using the second access mechanism.

14. The method of claim 10, wherein the user data corresponding to the at least one program includes a plurality of seats corresponding to a number of slots allocated to the at least one program.

15. The method of claim 10 further comprising:
providing access to the second user to the at least one program by utilizing an Application Programming Interface (API).

16. The method of claim 10 further comprising:
utilizing a multifactor authentication to register a device of the second user with the at least one program.

17. The method of claim 10 further comprising:
obtaining, from at least one program, activity data associated with at least one of the first user or the second user;
determining, based on a user profile associated with the at least one of the first user or the second user, whether the at least one of the first user or the second user has approved sharing of the activity data to a newsfeed; and
upon determining the at least one of the first user or the second user has approved sharing of the activity data, posting the activity data to the newsfeed, wherein the newsfeed is visible to one or more contacts associated with the user profile.

18. The method of claim 10 further comprising:
obtaining a rating by at least one of the first user or the second user, the rating including a numerical assignment corresponding to a piece of content;
identifying at least one contact of at least one of the first user or the second user that has also rated the piece of content;
obtaining a rating by the at least one contact of the at least one of the first user or the second user corresponding to the piece of content;
comparing the rating by the at least one of the first user or the second user and the rating by the at least one contact;
determining a degree of similarity based on the comparison; and
adjusting a similarity score of the at least one of the first user or the second user in relation to the at least one contact based on the degree of similarity.

19. The method of claim 18, the method further comprising:
in response to the degree of similarity exceeding a predetermined threshold, increasing the similarity score of the at least one of the first user or the second user in relation to the at least one contact.

20. The method of claim 18, the method further comprising:
in response to the degree of similarity being lower than a predetermined threshold, decreasing the similarity score of the at least one of the first user or the second user in relation to the at least one contact.
